(19) United States
(12) Patent Application Publication
(10) Pub. No.: US 2015/0081965 A1
(43) Pub. Date: Mar. 19, 2015

(54) DATA MANAGEMENT SYSTEM AND DATA MANAGEMENT METHOD

(71) Applicants: Takashi Nagao, Yokohama (JP); Nobuhiro Maki, Yokohama (JP); Taiki Miyaji, Yokohama (JP); Masayasu Asano, Yokohama (JP)

(72) Inventors: Takashi Nagao, Yokohama (JP); Nobuhiro Maki, Yokohama (JP); Taiki Miyaji, Yokohama (JP); Masayasu Asano, Yokohama (JP)

(73) Assignee: HITACHI, LTD., Tokyo (JP)

(21) Appl. No.: 13/580,432

(22) PCT Filed: Apr. 27, 2012
(86) PCT No.: PCT/JP2012/061433

§ 371 Date: Aug. 22, 2012

(51) Int. Cl. G06F 3/06

(52) U.S. Cl. CPC G06F 3/061; G06F 3/0689; G06F 3/0665
USPC 711/114

(57) ABSTRACT

A storage system assigns a real area from a pool to a virtual area in a virtual volume, and stores data into the real area. The pool comprises a plurality of real areas based on a plurality of types of storage devices with different characteristics, and the plurality of real areas are managed as a plurality of tiers depending on the characteristics of the storage devices. Moreover, the storage system moves the data from one tier to another tier in the pool, for each real area.

### TECHNICAL FIELD

The present invention relates to management of data in a pool based on a plurality of storage devices with different IO (input/output) performances.

### BACKGROUND ART

Popularization of information systems in recent years has increased types and numbers of services provided by the information systems. Moreover, users of the information systems have increased, and amounts of information handled by individual services have also increased. As a result, amounts of information handled by the information systems have explosively increased, while investments in the information system are not rapidly increased. This causes a problem in that new introduction of storage apparatuses cannot secure a storage capacity capable of storing all the increasing information.

In response to this, Patent Literature 1 discloses a technique as follows. That is, a storage apparatus including a plurality of types of storage devices with different hardware costs assigns a fragment of a storage area, which is referred to as “page,” from any of the storage devices to write target data, in response to a data write request from a host computer. Then, the storage apparatus moves and reassigns this page to a storage device with an appropriate input/output performance, depending on a frequency of access to the page from the host computer.

According to this technique disclosed in Patent Literature 1, a storage apparatus provided with high-capacity storage devices with low hardware costs can provide a high-capacity storage area to the host computer while suppressing increase in the hardware costs relative to conventional storage apparatuses. Generally, the storage devices with low hardware costs, however, indicate low input/output performances. Hence, throughput (an amount of processing that can be executed per unit time) of the storage apparatus still decreases with mere provision of the storage devices with low hardware costs. Accordingly, in the technique described in Patent Literature 1, the storage apparatus assigns a page with a low frequency of access from the host computer, to the storage device with the low input/output performance, to thereby suppress the decrease in the throughput of the storage apparatus.

Here, in a storage apparatus, storage areas of a plurality of storage devices with a plurality of different characteristics (such as input/output performances and reliability) are sectioned into tiers of the storage areas, which are referred to as “storage tiers,” according to the characteristics. A technique of assigning any of a plurality of the storage tiers to a page that is assigned to data used in an information system is referred to as “storage tier control.”

Moreover, the explosive increase in the amounts of information handled by the information systems also causes vast amounts of processing expected for the information systems. As a result, this causes a problem in that the information systems cannot complete the processing within times expected by persons using the information systems (hereinafter referred to as “users”).

In response to this, Patent Literature 2 discloses a technique as follows. That is, a host computer identifies a page assigned to data used by an important application program (hereinafter simply referred to as “application”), based on page assignment information included in a storage apparatus provided with storage tiers. Then, the host computer instructs the storage apparatus to assign this page to a storage tier indicating a high input/output performance, and the storage apparatus performs storage tier control according to the instruction from the host computer. According to this technique disclosed in Patent Literature 2, since the storage tier indicating the high input/output performance is assigned to the page assigned to the data used by the important application, the processing for at least applications with high importance levels can be completed within the times expected by the users.

### CITATION LIST

### Patent Literature

### [Patent Literature 1]

US Patent Application Publication No. 2005/0055603

### [Patent Literature 2]

US Patent Application Publication No. 2011/0289287

### SUMMARY OF INVENTION

### Technical Problem

In the storage apparatus provided with the storage tiers, there is a situation where a plurality of pieces of data used by applications with different importance levels exist in a page. In such a situation, if the storage tier control disclosed in Patent Literature 2 is performed, the data used by the application with the high importance level may be assigned to a storage tier indicating a low input/output performance. For example, it is assumed that a page in which the data used by the application with the high importance level exists. Here, if an application with a low importance level newly writes data to a free space of this page, the host computer determines that this page is not an important page, based on the newly written data and the importance level of the application that has written the data. Then, the host computer instructs the storage apparatus to assign this page to the storage tier indicating the low input/output performance. As a result, the storage apparatus assigns this page to the storage tier indicating the low input/output performance, even though the data used by the application with the high importance level exists in the page.

### Solution to Problem

A storage system assigns a real area from a pool to a virtual area in a virtual volume, and stores data into the real area. The pool comprises a plurality of real areas based on a plurality of types of storage devices with different characteristics, and the plurality of real areas are managed as a plurality of tiers depending on the characteristics of the storage devices. Moreover, the storage system moves the data from one tier to another tier in the pool, for each real area. If a predetermined trigger for which a change of a real area storing a certain piece of data should be considered is detected, the data management system identifies a performance requirement of the real area for each of one or more pieces of data including the certain piece of data within a first real area in which the certain piece of data is stored; identifies a tier satisfying a highest performance requirement in the identified performance requirements, in the plurality of tiers; and determines the identified tier as a tier of a storage destination of the above one or more pieces of data.

### BRIEF DESCRIPTION OF DRAWINGS

FIG. 1 is a hardware configuration diagram of a computer system according to a first embodiment.

FIG. 2 is a configuration diagram of a management computer according to the first embodiment.

FIG. 3 is a configuration diagram of a host computer according to the first embodiment.

FIG. 4 is a configuration diagram of a storage apparatus according to the first embodiment.

FIG. 5 is a conceptual diagram describing a summary of processes in the computer system according to the first embodiment.

FIG. 6 is a conceptual diagram describing a summary of processes in the host computer and the storage apparatus according to the first embodiment.

FIG. 7A is a first conceptual diagram describing a summary of storage tier control according to the first embodiment.

FIG. 7B is a second conceptual diagram describing the summary of the storage tier control according to the first embodiment.

FIG. 8 is a diagram showing an example of a host computer management table according to the first embodiment.

FIG. 9 is a diagram showing an example of a user configuration information-centralized management table according to the first embodiment.

FIG. 10 is a diagram showing an example of a job information-centralized management table according to the first embodiment.

FIG. 11 is a diagram showing an example of a data configuration-centralized management table according to the first embodiment.

FIG. 12 is a diagram showing an example of a page configuration-centralized management table according to the first embodiment.

FIG. 13 is a diagram showing an example of a tier usage status-centralized management table according to the first embodiment.

FIG. 14 is a diagram showing an example of a control target page-centralized management table according to the first embodiment.

FIG. 15 is a diagram showing an example of a user configuration information management table according to the first embodiment.

FIG. 16 is a diagram showing an example of a job information management table according to the first embodiment.

FIG. 17 is a diagram showing an example of a data configuration management table according to the first embodiment.

FIG. 18 is a diagram showing an example of a page configuration management table according to the first embodiment.

FIG. 19 is a diagram showing an example of a tier usage status management table according to the first embodiment.

FIG. 20 is a diagram showing an example of a control target page management table according to the first embodiment.

FIG. 21 is a diagram showing an example of storage basic information according to the first embodiment.

FIG. 22 is a diagram showing an example of a logical volume management table according to the first embodiment.

FIG. 23 is a diagram showing an example of a page-in-pool management table according to the first embodiment.

FIG. 24 is a diagram showing content of a real volume management table according to the first embodiment.

FIG. 25 is a diagram showing an IO request according to the first embodiment.

FIG. 26 is a flowchart of an input/output process according to the first embodiment.

FIG. 27 is a flowchart of a page assignment process according to the first embodiment.

FIG. 28 is a flowchart of a storage tier control process according to the first embodiment.

FIG. 29 is a flowchart of the storage tier control process based on the IO request according to the first embodiment.

FIG. 30 is a conceptual diagram of an application and jobs according to the first embodiment.

FIG. 31 is a flowchart of a preparation process in a preparation phase in the host computer according to the first embodiment.

FIG. 32 is a diagram showing an example of an input screen of the host computer according to the first embodiment.

FIG. 33 is a flowchart of the storage tier control process based on a priority level of the job according to the first embodiment.

FIG. 34 is a flowchart of a page ranking process according to the first embodiment.

FIG. 35A is a first diagram describing the page ranking process according to the first embodiment.

FIG. 35B is a second diagram describing the page ranking process according to the first embodiment.

FIG. 36 is a configuration diagram of the management computer according to a second embodiment.

FIG. 37 is a configuration diagram of the host computer according to the second embodiment.

FIG. 38 is a configuration diagram of the storage apparatus according to the second embodiment.

FIG. 39 is a diagram showing an example of a performance requirement-centralized management table according to the second embodiment.

FIG. 40 is a diagram showing an example of a performance requirement management table according to the second embodiment.

FIG. 41 is a diagram showing an example of a host performance requirement management table according to the second embodiment.

FIG. 42 is a flowchart of a transmission process in the preparation phase in the host computer according to the second embodiment.

FIG. 43 is a configuration diagram of the management computer according to a third embodiment.

FIG. 44 is a configuration diagram of the host computer according to the third embodiment.

FIG. 45 is a configuration diagram of the storage apparatus according to the third embodiment.

### DESCRIPTION OF EMBODIMENTS

Embodiments will be described with reference to the drawings. It should be noted that the embodiments to be described below do not limit the invention according to the claims, and moreover, all various elements and combinations thereof described in the embodiments are not necessarily essential for solutions in the invention.

It should be noted that, in the following description, while representation of “aaa table” may describe various pieces of information, such various pieces of information may be represented in a data structure other than the table. “aaa table” can be referred to as “aaa information” to show independence from the data structure. Furthermore, an information element including a value in each column in the table is referred to as “entry,” and an entry in “aaa table” is referred to as “aaa table entry,” for explanatory purposes.

Moreover, in the following description, while a process may be described with “program” as a subject. The subject of the process may be the processor because the program is executed by a processor (for example, a CPU (Central Processing Unit)) included in a controller, and thereby performs a defined process while using storage resources (for example, a memory) and/or a communication interface device (for example, a communication port), as appropriate. The process described with the program as the subject may be a process performed by the processor or a computer (for example, such as a management computer, a host computer or a storage apparatus) including the processor. Moreover, the controller may be the processor itself, or may include a hardware circuit that partly or entirely performs the process to be performed by the controller. The program may be installed into each controller from a program source. The program source, for example, may be a program distribution server or a storage medium.

### (1) First Embodiment

### (1-1) Hardware Configuration of Computer System

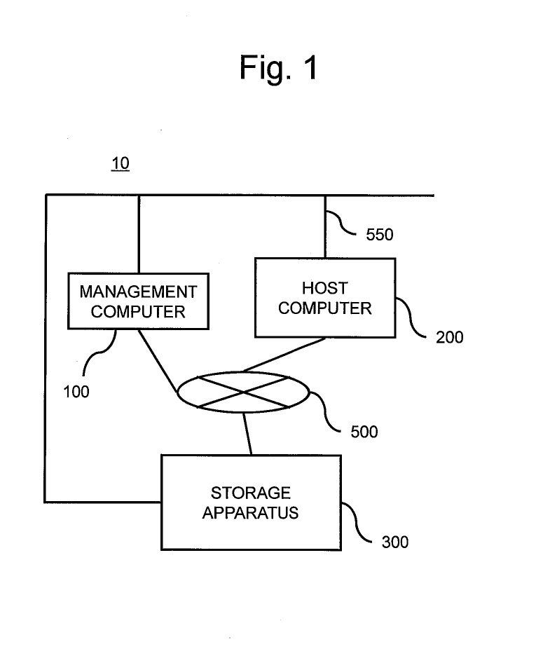

FIG. 1 is a hardware configuration diagram of a computer system according to a first embodiment.

A computer system 10 includes a management computer 100, a host computer 200, and a storage apparatus 300. The management computer 100 and the host computer 200 may be the same computer. A number of each of the management computer 100 and the host computer 200 may be one, or a number of at least one of them may be plural. Here, the management computer 100 or the host computer 200 is an example of a management system as described in the claims.

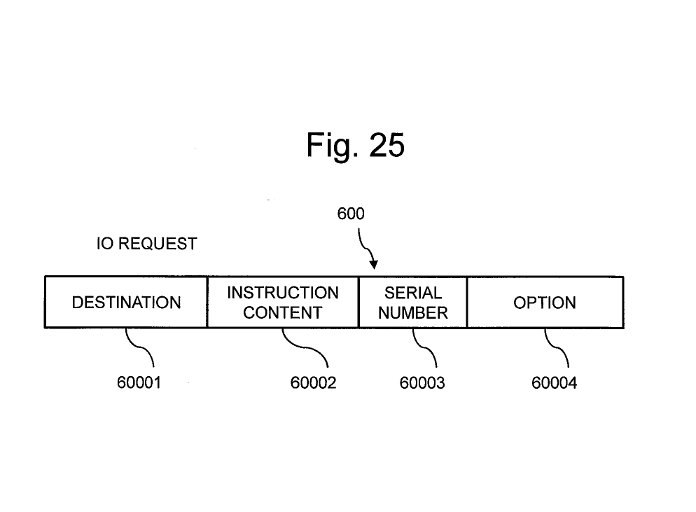

The management computer 100, the host computer 200, and the storage apparatus 300 are coupled to one another via a communication network (for example, an SAN (Storage Area Network)) 500 for IO processes. The host computer 200 transmits various data, for example, an IO request 600 (see FIG. 25) for issuing an instruction for data access (data input/output) or storage tier control, to the storage apparatus 300 via the communication network 500. The storage apparatus 300 transmits a response to the received IO request 600, to the host computer 200 via the communication network 500.

The management computer 100 is coupled to the host computer 200 and the storage apparatus 300 via a communication network (for example, a LAN (Local Area Network)) 550 for apparatus management. The management computer 100 transmits various data, for example, data for which the instruction for the storage tier control is issued, to the host computer 200 or the storage apparatus 300 via the communication network 550. It should be noted that the communication network 500 and the communication network 550 may be a single communication network.

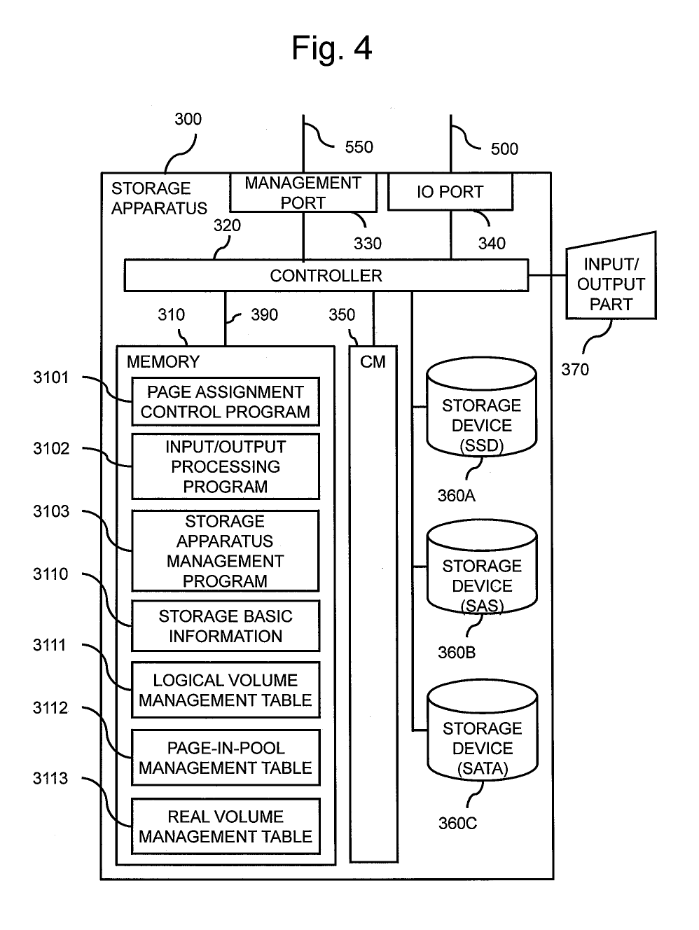

FIG. 4 is a configuration diagram of the storage apparatus according to the first embodiment.

The storage apparatus 300 includes a memory 310, a controller 320, a management port 330, an IO port 340, a cache memory (CM) 350, storage devices 360 (360A, 360B, 360C), an input/output part 370, and an internal network 390. The controller 320 is coupled to the memory 310, the management port 330, the IO port 340, the cache memory 350, the storage devices 360, and the input/output part 370, via the internal network 390.

The memory 310 stores programs to be executed by the controller 320, information required by the controller 320, and the like. Specifically, the memory 310 stores a page assignment control program 3101, an input/output processing program 3102, a storage apparatus management program 3103, storage basic information 3110, a logical volume management table 3111, a page-in-pool management table 3112, and a real volume management table 3113.

The page assignment control program 3101 is a program for performing the storage tier control. The input/output processing program 3102 is a program for processing the IO request 600 received via the IO port 340. The IO request 600 includes, for example, the data access instruction, the storage tier control instruction or the like. The IO request 600 will be described in detail later. The storage apparatus management program 3103 is a program for accepting inputs from a user through the input/output part 370, and configuring the storage apparatus 300.

The storage basic information 3110 is information on an identifier of the storage apparatus 300 in the communication network 550. The logical volume management table 3111 stores information for managing logical volumes. The page-in-pool management table 3112 stores information for managing pages. The real volume management table 3113 stores information for managing real volumes. The logical volume management table 3111, the page-in-pool management table 3112, and the real volume management table 3113 will be described in detail later.

The controller 320 executes the programs stored in the memory 310, and thereby performs various processes. For example, the controller 320 processes the IO request 600 received via the IO port 340, and thereby performs the data access to a specified logical volume. The management port 330 is an interface for coupling to the management computer 100 and the host computer 200 via the communication network 550. The IO port 340 is an interface for coupling to the management computer 100 and the host computer 200 via the communication network 500. The cache memory 350 temporarily stores data to be written to the storage devices 360 and data to be read from the storage devices 360.

The storage device 360 includes a storage medium, and stores data for which a write request has been issued by the host computer 200. It should be noted that the storage apparatus 300 includes one or more storage devices 360. The storage devices 360 include, for example, a storage device (SSD (Solid State Disk)) 360A, a storage device (SAS (Serial Attached SCSI)) 360B, a storage device (SATA (Serial ATA)) 360C and the like.

The input/output part 370 includes an input part (for example, such as a keyboard, a switch, a pointing device and/or a microphone) that accepts the inputs from the user, and an output part (for example, such as a display apparatus and/or a speaker) that displays various pieces of information to the user.

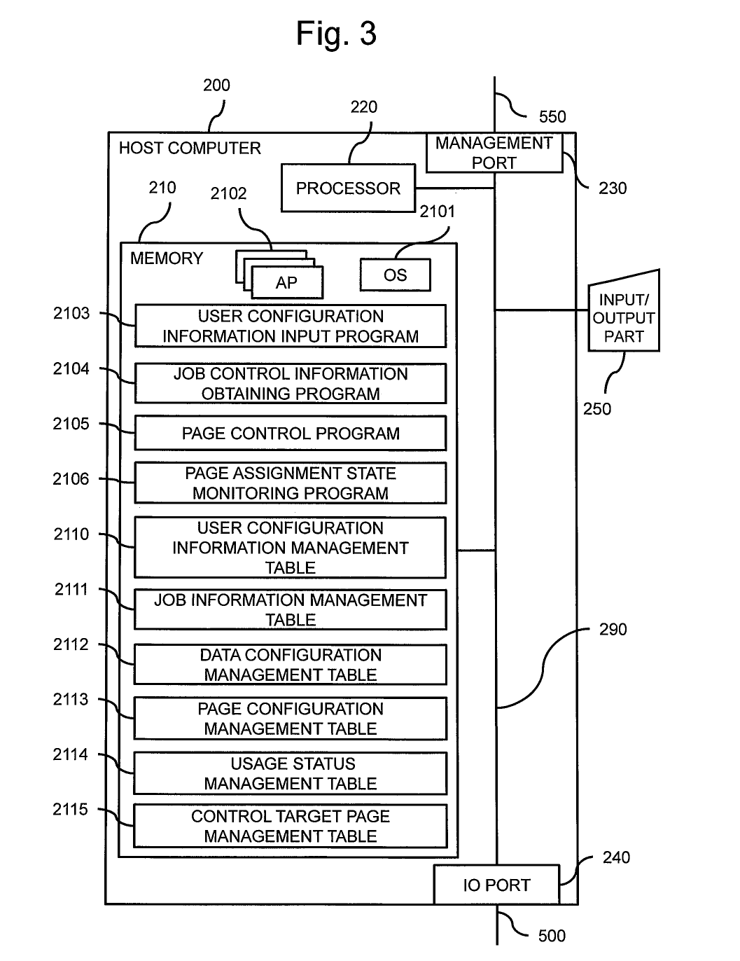

FIG. 3 is a configuration diagram of the host computer according to the first embodiment.

The host computer 200 includes a memory 210, a processor 220, a management port 230, an IO port 240, an input/output part 250, and an internal network 290. The memory 210, the processor 220, the management port 230, the IO port 240, and the input/output part 250 are coupled to one another via the internal network 290.

The memory 210 stores programs to be executed by the processor 220, information required by the processor 220, and the like. Specifically, the memory 210 stores an Operating System (OS) 2101, one or more application programs (AP) 2102, a user configuration information input program 2103, a job control information obtaining program 2104, a page control program 2105, a page assignment state monitoring program 2106, a user configuration information management table 2110, a job information management table 2111, a data configuration management table 2112, a page configuration management table 2113, a tier usage status management table 2114, and a control target page management table 2115.

The OS 2101 is a program for controlling all the processes in the host computer 200. The APs 2102 are programs that define various processes to be executed by the processor 220 of the host computer 200. For example, the processor 220 of the host computer 200 executes the processes based on the definition in the APs 2102, and provides a database function or a mail server function. The user configuration information input program 2103 is a program for accepting inputs of information from the user via the input/output part 250. The job control information obtaining program 2104 is a program for obtaining information regarding jobs included in the OS 2101. The jobs will be described in detail later. The page control program 2105 is a program for performing the storage tier control for data accessed by the APs 2102. The page assignment state monitoring program 2106 is a program for monitoring a state of the storage tier control for the data accessed by the APs 2102.

The user configuration information management table 2110 stores various pieces of information inputted by the user. The user input information accepted by the user configuration information input program 2103 is stored in the user configuration information management table 2110. The job information management table 2111 stores information for managing the jobs. The data configuration management table 2112 stores information regarding data stored in the storage apparatus 300. The page configuration management table 2113 stores information for providing correspondence between the pages and the data. The tier usage status management table 2114 stores information regarding usage statuses of storage tiers in the storage apparatus 300. The control target page management table 2115 stores information regarding control target pages in the storage tier control. The user configuration information management table 2110, the job information management table 2111, the data configuration management table 2112, the page configuration management table 2113, the tier usage status management table 2114 and the control target page management table 2115, will be described in detail later.

The processor 220 executes the programs stored in the memory 210, and thereby performs various processes. For example, the processor 220 transmits the IO request 600 to the storage apparatus 300, and thereby performs the storage tier control executed by the storage apparatus 300, or accesses data in the logical volumes managed by the storage apparatus 300. The management port 230 is an interface for coupling to the management computer 100 and the storage apparatus 300 via the communication network 550. The IO port 240 is an interface for coupling to the management computer 100 and the storage apparatus 300 via the communication network 500. The input/output part 250 includes an input part (for example, such as a keyboard, a switch, a pointing device and/or a microphone) that accepts the inputs from the user, and an output part (for example, such as a display apparatus and/or a speaker) that displays various pieces of information to the user.

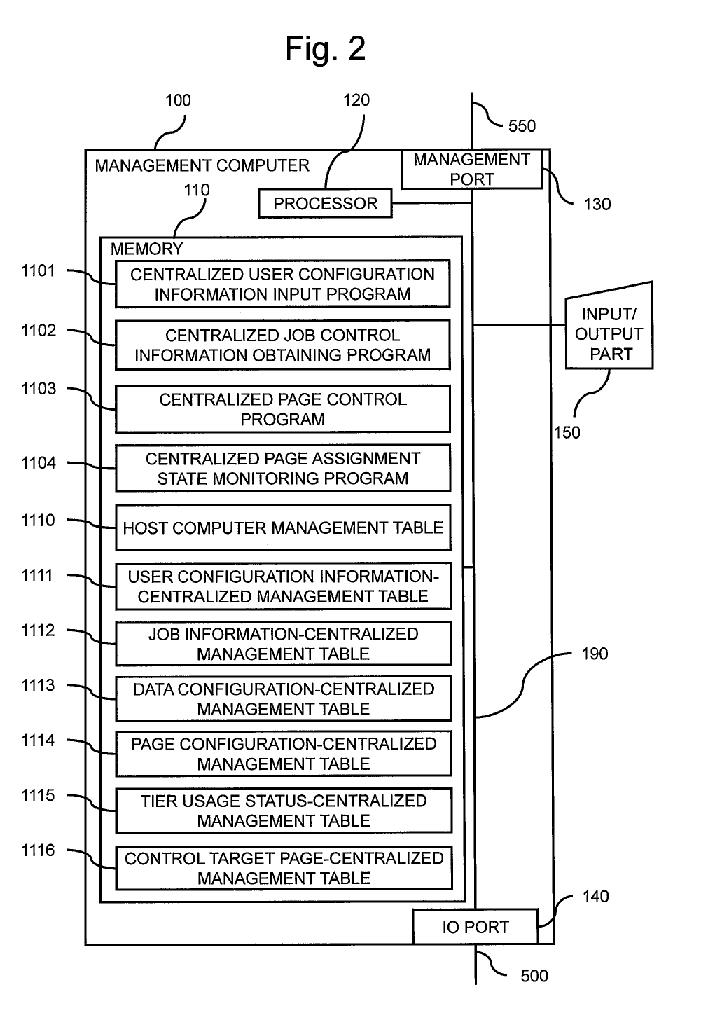

FIG. 2 is a configuration diagram of the management computer according to the first embodiment.

The management computer 100 includes a memory 110, a processor 120, a management port 130, an IO port 140, an input/output part 150, and an internal network 190. The memory 110, the processor 120, the management port 130, the IO port 140, and the input/output part 150 are coupled to one another via the internal network 190.

The memory 110 stores programs to be executed by the processor 120, information required by the processor 120, and the like. Specifically, the memory 110 stores a centralized user configuration information input program 1101, a centralized job control information obtaining program 1102, a centralized page control program 1103, a centralized page assignment state monitoring program 1104, a host computer management table 1110, a user configuration information-centralized management table 1111, a job information-centralized management table 1112, a data configuration-centralized management table 1113, a page configuration-centralized management table 1114, a tier usage status-centralized management table 1115, and a control target page-centralized management table 1116. It should be noted that the memory 110 may store an OS, and APs.

The centralized user configuration information input program 1101 is a program for accepting inputs of information from the user via the input/output part 150. The centralized job control information obtaining program 1102 is a program for obtaining the information regarding the jobs included in the OS 2101 memorized in the memory 210 of one or more host computers 200. The centralized page control program 1103 is a program for performing the storage tier control for the data accessed by the APs 2102 memorized in the memory 210 of the one or more host computers 200. The centralized page assignment state monitoring program 1104 is a program for monitoring the state of the storage tier control for the data accessed by the APs 2102 stored in the memory 210 of the one or more host computers 200.

The host computer management table 1110 stores information regarding the one or more host computers 200 regarded as management targets by the management computer 100. The user configuration information-centralized management table 1111 stores various pieces of information inputted by the user. The user input information accepted by the centralized user configuration information input program 1101 is stored in the user configuration information-centralized management table 1111. The job information-centralized management table 1112 stores the information for managing the jobs. The data configuration-centralized management table 1113 stores the information regarding the data stored in the storage apparatus 300. The page configuration-centralized management table 1114 stores the information for providing the correspondence between the pages and the data. The tier usage status-centralized management table 1115 stores the information regarding the usage statuses of the storage tiers. The control target page-centralized management table 1116 stores the information regarding the control target pages in the storage tier control.

The processor 120 executes the programs stored in the memory 110, and thereby performs various processes. For example, the processor 120 instructs the host computer 200 to perform the storage tier control, and thereby controls the storage tier control executed by the storage apparatus 300, via the host computer 200. The management port 130 is an interface for coupling to the host computer 200 and the storage apparatus 300 via the communication network 550. The IO port 140 is an interface for coupling to the host computer 200 and the storage apparatus 300 via the communication network 500. The input/output part 150 comprises an input part (for example, such as a keyboard, a switch, a pointing device and/or a microphone) that accepts the inputs from the user, and an output part (for example, such as a display apparatus and/or a speaker) that displays various pieces of information to the user.

### (1-2) Summary of Processes in Computer System

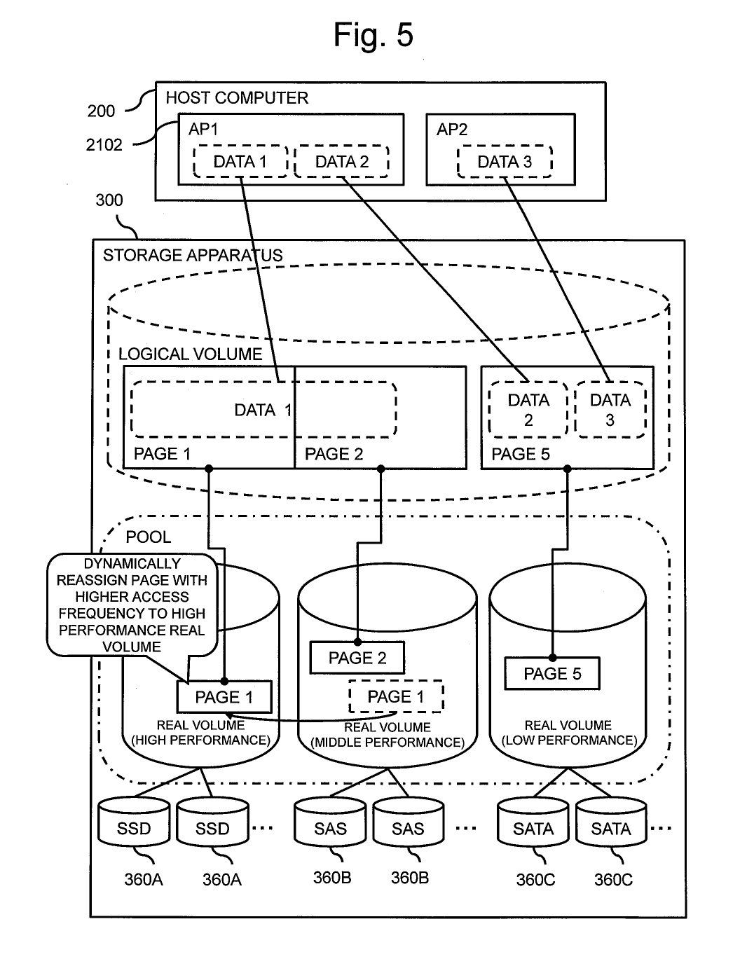

FIG. 5 is a conceptual diagram describing a summary of the processes in the computer system according to the first embodiment.

Here, in the following description, the processes will be described simply with the storage apparatus 300 as a subject, which indicates that the controller 320 of the storage apparatus 300 is executing these processes. Similarly, if the processes are described simply with the host computer 200 as the subject, it indicates that the processor 220 of the host computer 200 is executing the processes. If the processes are described with the management computer 100 as the subject, it indicates that the processor 120 of the management computer 100 is executing the processes.

A relationship among the real volumes, a pool, and the logical volume, which is a premise of the present embodiment, is will be described first.

The real volumes are logical storage areas that are created from storage areas (real storage areas) of one or more storage devices 360 (360A, 360B, 360C) by the storage apparatus 300. In FIG. 5, for example, a real volume comprising the storage area of the storage device 360 with a high performance (hereinafter, “real volume (high performance)”) comprises the storage areas of a plurality of the storage devices 360A.

In the present embodiment, the storage apparatus 300 includes a plurality of the storage devices 360 with different characteristics, and can include a plurality of the real volumes with different characteristics, due to a difference in the storage devices that provide the storage areas. “Different characteristics” means, for example, a difference in memory elements such as a semiconductor drive (for example, an SSD) and a magnetic drive (for example, an HDD: Hard Disk Drive), a difference in interfaces such as an FC, an SAS, and an SATA, or a difference in methods of forming the storage area from the storage device (for example, RAID levels). The different characteristics lead to different times required for the data access and different recoverabilities from hardware faults. It should be noted that the RAID is an abbreviation for Redundat Array of Inexpensive Disks. Moreover, the RAID level is classification of reliability or the performance of the real volume. The RAID levels are classified according to data recording methods. Specifically, the RAID levels are classified according to a difference among dividing/replicating data written by the host computer 200 and thereby storing fragments of the data so as to be distributed and duplicated into the plurality of storage devices 360; generating data such as parity required for restoring the data and storing the generated data simultaneously with the data of the host computer 200; and the like.

The pool is a set of the real volumes for, when data is written into the logical volume by the host computer 200, providing the storage areas for storing this data. The storage apparatus 300 manages the logical volume and the real volumes that provide the storage areas to the logical volume, for each pool. One or more real volumes with the different characteristics are managed in the pool. For example, in FIG. 5, three real volumes (high performance, middle performance, and low performance) are managed in the same pool.

The logical volume is a virtual volume (virtual logical volume) provided to the host computer 200 by the storage apparatus 300. The host computer 200 requests the data access to the storage apparatus 300, through an IO request specifying this logical volume and an address indicating the storage area on the logical volume. The storage apparatus 300 stores only data of an updated storage area in the storage areas of the logical volume, into the real volume registered in the pool. In FIG. 5, for example, Data 1, Data 2, and Data 3 are stored in three areas of the logical volume, respectively, according to the IO request from the host computer 200. Each piece of the data is stored in a page assigned to each area of the logical volume by the storage apparatus 300. A fragment of the storage area of the real volume is assigned to the page. It should be noted that a one-to-one relationship does not necessarily exist between data that is a unit managed by the user of the host computer 200 (for example, a file or a data set), and the page to be assigned to the data. Specifically, a single piece of data may be stored in a plurality of pages, and a plurality of pieces of data may be stored in a single page. For example, like Data 1 of FIG. 5, if the size of a storage area required for storing the data (referred to as “data size”) is larger than the size of a storage area of the page (referred to as “page size”), the storage apparatus 300 assigns the plurality of pages (Page 1 and Page 2 in an example of the same drawing) to this data, in order to secure the storage area capable of storing this data. In contrast, like Data 2, if the data size is smaller than the page size, it means that an unused storage area exists in the page that memorizes the data. Thus, when data (Data 3) is written into the unused storage area of this page according to the IO request 600 from the host computer 200, the storage apparatus 300 does not newly assign a page, and stores the data into this page. This leads to existence of the plurality of pieces of data (Data 2 and Data 3) in the single page (Page 5).

Page move and the storage tier control in the storage apparatus 300 will be described next.

The page move refers to moving the data on the page between the real volumes within the pool, in the logical volume. Moreover, the storage tier control refers to controlling the real volumes storing the data, which is performed by the storage apparatus 300 performing the page move between the real volumes with the different characteristics, for the purpose of providing the data with a logical volume with an appropriate performance, depending on an access frequency and a performance requirement for this data.

Here, with reference to FIG. 5, an example of the storage tier control will be described. It is assumed that the storage apparatus 300 manages a difference in the times required for the data access by the host computer 200, as characteristic information (the high performance, the middle performance, or the low performance in FIG. 5). Here, if it is judged that, in the storage areas storing Data 1 from the host computer 200, the access frequency for the storage area assigned to Page 1 has increased in comparison with the past, the storage apparatus 300 performs the page move for Page 1 from the real volume (middle performance) to the real volume (high performance).

The storage apparatus 300 can perform such page move to thereby provide the logical volume with the appropriate performance, depending on the frequency of accessing the data by the host computer 200. It should be noted that the storage apparatus 300 periodically or non-periodically executes this storage tier control. For example, the storage apparatus 300 executes the storage tier control every hour, or executes the storage tier control triggered by an instruction from the user via the input/output part 370, or executes the storage tier control triggered by the instruction from the host computer 200.

As described above, in the storage tier control, the page move is performed between the real volumes with the different characteristics in the pool. In the present embodiment, the real volumes are managed to be sectioned into a plurality of tiers, depending on their characteristics. It should be noted that, in the present embodiment, unless otherwise noted, the tiers of the real volumes will be described as three tiers (the high performance, the middle performance and the low performance). The tiers of the real volumes, however, are not limited to the three tiers.

A concept of the application, which is launched on the host computer 200, and the jobs will be described next.

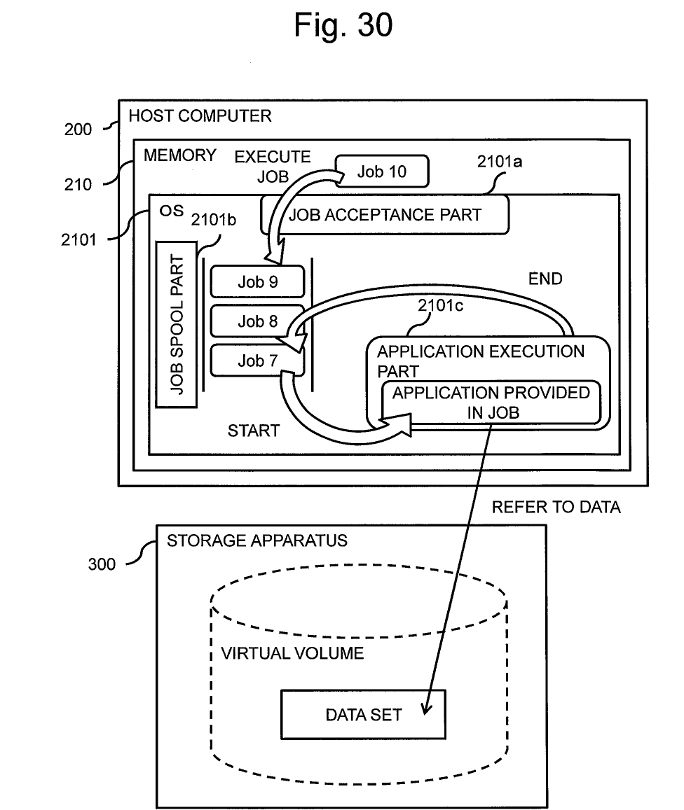

FIG. 30 is a conceptual diagram of the application and the jobs according to the first embodiment.

In the host computer 200, one or more applications can be simultaneously executed. If an application is executed, a name of the application to be executed, a name of a data set used by the application, and the like are provided in a job, and the job is submitted. Specifically, the job can also provide a job name, a job class that is a class of the job, a person using the job, and the like, in addition to the application name and the data set name. If the user issues an instruction to submit the job, the host computer 200 starts the job according to an instruction from the OS 2101. Here, the data set is a logical unit managed particularly by a mainframe OS, and is data used by applications mainly operating on the host computer 200. For example, a file corresponds to the data set, in an open system.

As shown in FIG. 30, the OS 2101 includes a job acceptance part 2101a, a job spool part 2101b, and an application execution part 2101c, in order to process the job in the host computer 200. For example, if the user issues an instruction to submit a job, the job acceptance part 2101a within the OS 2101 (actually, the processor 220 that executes the job acceptance part 2101a) accepts the job, and instructs the host computer 200 to perform a process for obtaining various pieces of information provided in the job. The host computer 200 obtains the information provided in the job, and then executes a process in the job spool part 2101b for the job. The job spool part 2101b suspends the execution of the job until the application execution part 2101c is enabled to process the job.

When the application execution part 2101c is enabled to process a new job, the host computer 200 switches the process for the job, from the job spool part 2101b to the process in the application execution part 2101c. The application execution part 2101c executes the application provided in the job. Once the application is executed, data for an application program provided in the job is referred to. When the process by the application execution part 2101c ends (that is, the process of the application provided in the job is completed), the host computer 200 executes a job end process to end the job.

Generally, when executing a job, the OS 2101 gives a priority level to the job. The priority level of the job is used as a reference value for judging to which application the host computer 200 preferentially assigns computer resources (for example, the processor 210 and the memory 220) of the host computer 200, if such resources, which are requested by the applications, cannot be assigned to all the applications. It should be noted that, in the present embodiment, the priority level of the job is used as a reference value representing an importance level of the application. In the present embodiment, the reference value representing the importance level of the application, however, is not limited to the priority level of the job.

A summary of the storage tier control based on the importance level of the application in the present embodiment will be described next.

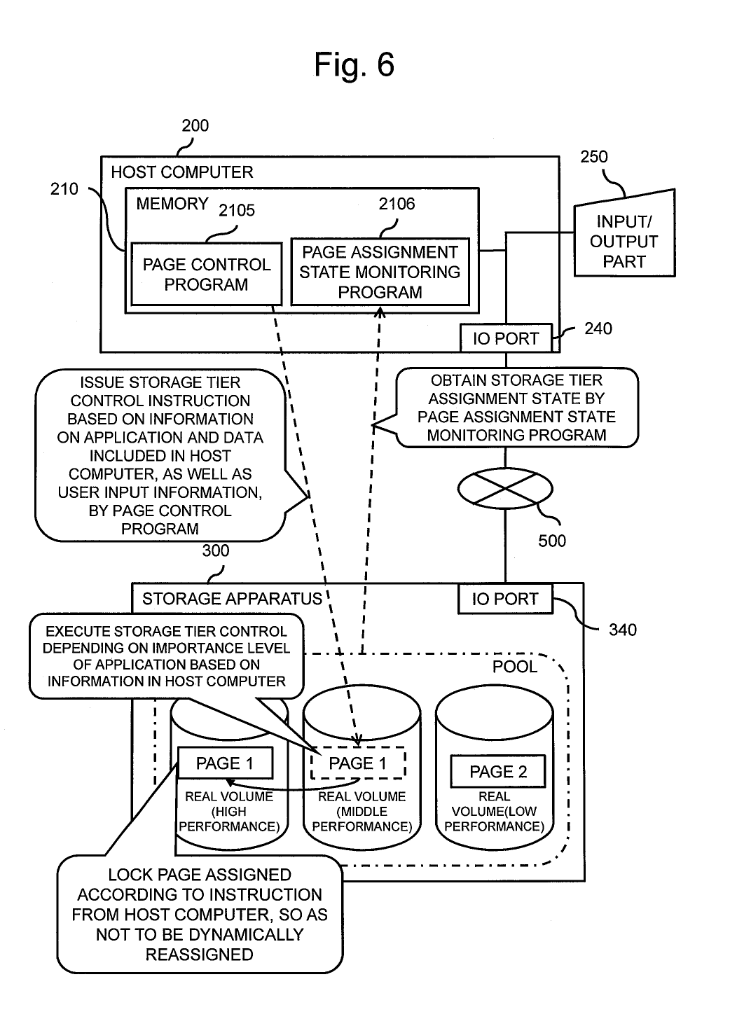

FIG. 6 is a conceptual diagram describing a summary of the processes in the host computer and the storage apparatus according to the first embodiment.

As shown in FIG. 6, based on the page control program 2105, the host computer 200 transmits information required for the storage tier control, such as the importance level of the application (for example, the priority level of the job) and the performance requirement (for example, a data access response time), or transmits the storage tier control instruction based on the information, to the storage apparatus 300.

The storage apparatus 300 performs the storage tier control depending on the importance level of the application, based on the page assignment control program 3101, according to the information or the storage tier control instruction received from the host computer 200. Furthermore, the storage apparatus 300 stores the control target page in this storage tier control depending on the importance level of the application, so that this page does not become a control target in the storage tier control depending on the access frequency. Such a process is hereinafter referred to as “page lock,” in which the storage apparatus 300 stores a thing that the page is the control target page in the storage tier control depending on the importance level of the application, so that the page does not become the control target in the storage tier control depending on the access frequency. It should be noted that when executing the storage tier control depending on the access frequency, the storage apparatus 300 excludes the page-locked page from the control target pages in the storage tier control depending on the access frequency. Thereby, the page-locked page can be prevented from being moved by the storage tier control depending on the access frequency.

Meanwhile, in order to obtain information required for the storage tier control instruction, or to display data access characteristic information to the user via the input/output part 250, the host computer 200 transmits the IO request 600 for obtaining information regarding storage tier assignment, to the storage apparatus 300, based on the page assignment state monitoring program 2106. The storage apparatus 300, which has received this IO request 600, returns information on the storage area of the page assigned to the logical volume and the characteristic information on the real volume of this page, to the host computer 200, based on the input/output processing program 3102.

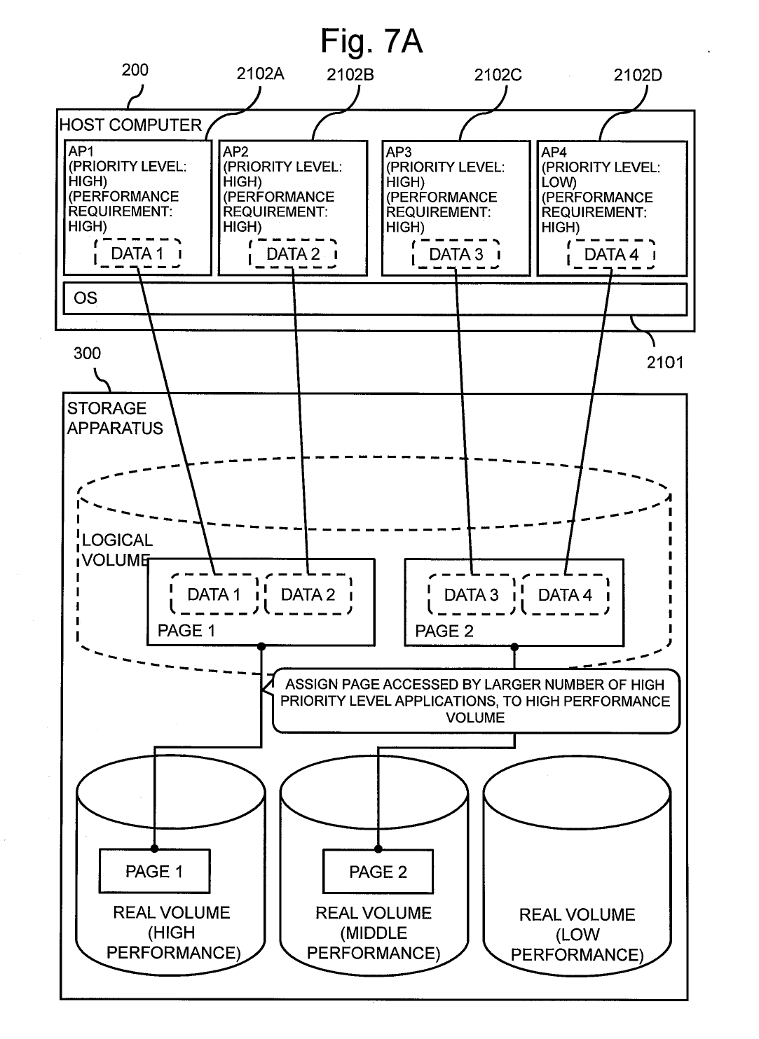

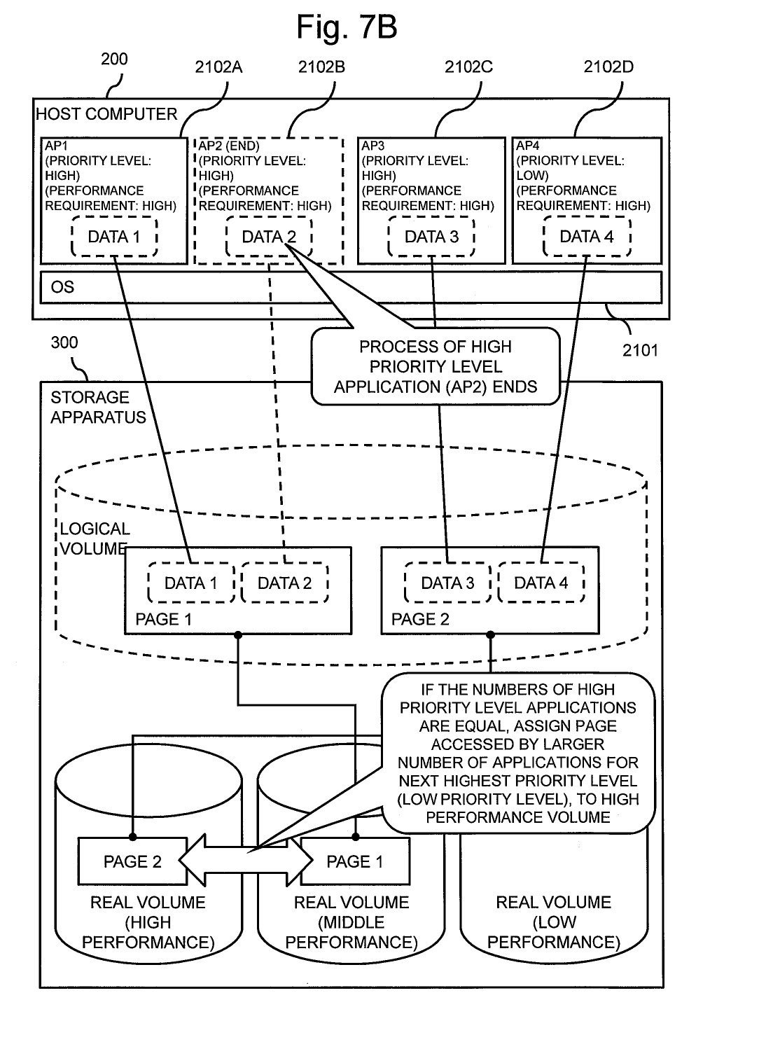

FIG. 7A is a first conceptual diagram describing a summary of the storage tier control according to the first embodiment. FIG. 7B is a second conceptual diagram describing the summary of the storage tier control according to the first embodiment. FIGS. 7A and 7B are conceptual diagrams showing how the pages are assigned to the data accessed by the APs 2102 of the host computer 200, within the storage apparatus 300.

Here, as shown in FIGS. 7A and 7B, it is assumed that four APs 2102 (AP1, AP2, AP3, and AP4) exist in the host computer 200, and that the storage apparatus 300 has stored data (Data 1, Data 2, Data 3, and Data 4) accessed by the APs 2102 of the host computer 200. Moreover, it is assumed that Page 1 has stored Data 1 and Data 2, and Page 2 has stored Data 3 and Data 4. Furthermore, the user is assumed to expect that, for all the APs 2102, the data accessed by the APs 2102 (for example, the data accessed by AP1 is Data 1) is stored into the high performance real volume. Moreover, it is assumed that only a single page can be assigned from each real volume.

FIG. 7A represents a page assignment state in the case where the processor 220 of the host computer 200 is executing the four APs 2102 (AP1, AP2, AP3, and AP4). While Data 1, Data 2, Data 3, and Data 4 are expected to be stored in the storage area of the high performance real volume, the number of pages that can be assigned from the high performance real volume is one. Thus, only the data stored in either Page 1 or Page 2 can be stored in the storage area of the high performance real volume. Here, Page 1 is accessed by two high priority level applications (AP1 and AP2). In contrast, Page 2 is accessed by one high priority level application (AP3) and one low priority level application (AP4). Thus, Page 1, which is accessed by relatively many high priority level applications, is judged to be a page with a priority rank higher than Page 2. Then, based on the priority rank, Page 1 is assigned to the high performance real volume (in detail, the storage area of the high performance real volume is assigned to Page 1), and Page 2 is assigned to the middle performance real volume that is one tier lower than the high performance real volume.

FIG. 7B represents a page assignment state after the process of AP2 being executed in FIG. 7A has ended. After the process of AP2 ends, Page 1 is accessed by one high priority level application (AP1). In contrast, Page 2 is accessed by one high priority level application (AP3) and one low priority level application (AP4). As a result, the number of the high priority level applications accessing the page is the same in Page 1 and Page 2. However, the number of the low priority level applications accessing the page is zero in Page 1, whereas the number is one in Page 2. Thus, Page 2 is judged to be a page with the priority rank higher than page 1, Page 2 is assigned to the high performance real volume, and Page 1 is assigned to the middle performance real volume.

In this way, in the storage tier control based on the importance level of the application in the present embodiment, the priority rank of the page is determined based on the priority levels of a plurality of the applications accessing the data stored in this page. Then, the storage areas are assigned from the real volume satisfying the performance requirements expected for the pages, to the pages in descending order of the priority rank. Such a process can be executed to thereby appropriately prevent assignment of a storage tier indicating a low input/output performance, to data used by an application with a high importance level, in the case where a plurality of pieces of data used by applications with different importance levels exist in a page.

It should be noted that while the process of the storage tier control realized by the computer system 10 is basically executed by the host computer 200 and the storage apparatus 300, the user may use the management computer 100 to manage a plurality of the host computers 200 and a plurality of the storage apparatuses 300 in a centralized manner, if necessary. Specifically, the management computer 100 instructs the plurality of host computers 200 to perform the storage tier control. Each host computer 200 instructs the storage apparatus 300 to perform the storage tier control, according to the instruction from the management computer 100. Thereby, if the plurality of host computers 200 exists, the input/output parts operated by the user can be aggregated into the input/output part 150 of the management computer 100 to save the user the trouble of individually operating the input/output part 250 of each host computer 200. It should be noted that the management computer 100 may directly transmit the storage tier control instruction to the storage apparatus 300.

### (1-3) Content of Various Tables

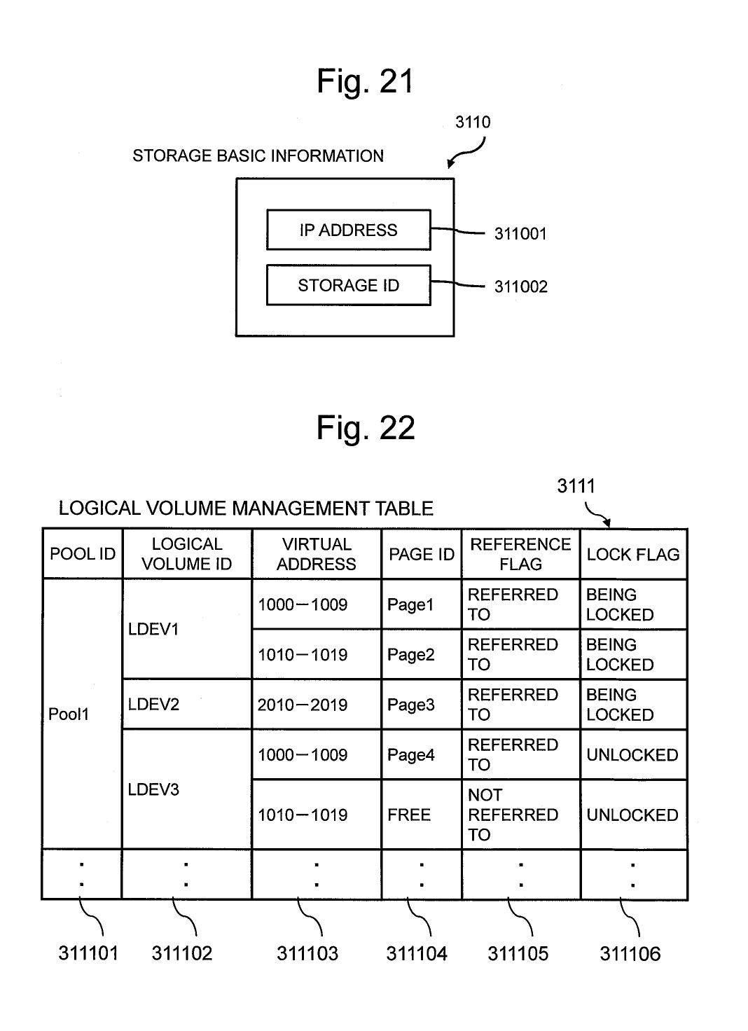

FIG. 21 is a diagram showing an example of the storage basic information according to the first embodiment.

The storage basic information 3110 is a table that manages information on the storage apparatus 300, and includes an IP address 311001 and a storage ID 311002. The IP address 311001 is an IP address given to the storage apparatus 300. The storage ID 311002 is an identifier that uniquely identifies the storage apparatus 300 indicated by the IP address.

FIG. 22 is a diagram showing an example of the logical volume management table according to the first embodiment.

The logical volume management table 3111 is a table that manages the logical volumes. Fields of a pool ID 311101, a logical volume ID 311102, a virtual address 311103, a page ID 311104, a reference flag 311105, and a lock flag 311106 are included in each entry of the logical volume management table 3111.

An identifier for uniquely identifying each pool, in which the storage apparatus 300 manages the storage areas of one or more real volumes as a group, is stored in the pool ID 311101. An identifier (logical volume ID) for uniquely identifying each logical volume given by the storage apparatus 300 is stored in the logical volume ID 311102. An address (virtual address) indicating a storage area to which a corresponding page has been assigned, in the logical volume identified by a corresponding logical volume ID, is stored in the virtual address 311103. The address is, for example, a first cylinder and the number of headers, as well as a last cylinder and the number of headers. The address may be an LBA (Logical Block Address) if the communication network 500 is SCSI (Small Computer System Interface). It should be noted that the size of a range of the address stored in the virtual address 311103 is the same as the page size. An identifier for uniquely identifying a page to which a storage area indicated by a corresponding virtual address has been assigned is stored in the page ID 311104. It should be noted that if there is no page to which the storage area indicated by the virtual address has been assigned, “free” is stored in the page ID 311104. A flag (reference flag), which indicates that there has been write or read-in reference to the storage area indicated by the virtual address, is stored in the reference flag 311105. A flag (lock flag), which indicates that the storage area indicated by the virtual address 311103 is under page lock control, is stored in the lock flag 311106.

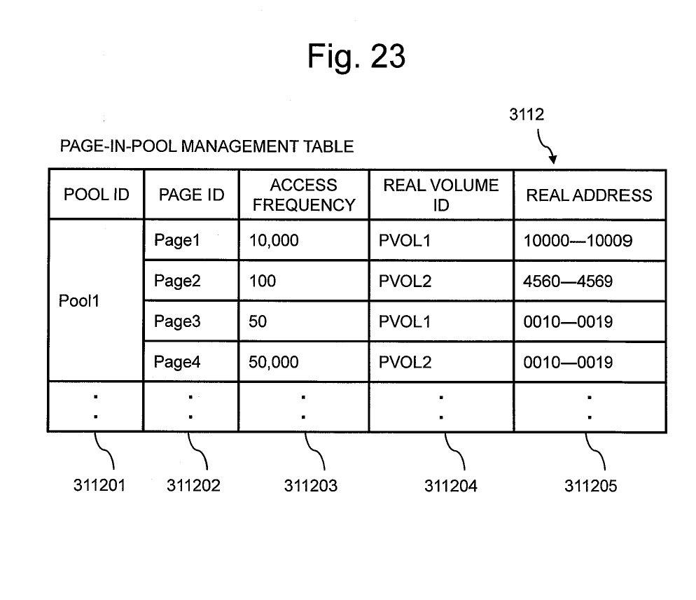

FIG. 23 is a diagram showing an example of the page-in-pool management table according to the first embodiment.

The page-in-pool management table 3112 is a table that manages the pages assigned to the logical volume in the pool. Fields of a pool ID 311201, a page ID 311202, an access frequency 311203, a real volume ID 311204, and a real address 311205 are included in each entry of the page-in-pool management table 3112.

An identifier (pool ID) for uniquely identifying a pool in which a real volume indicated by a corresponding real volume ID has been registered is stored in the pool ID 311201. An identifier (page ID) for uniquely identifying a page, which has been assigned by the storage apparatus 300 to a logical volume in a pool identified by a corresponding pool ID, is stored in the page ID 311202. Information on how many times this page has been referred to after being assigned (access frequency) is stored in the access frequency 311203. An identifier (real volume ID) for uniquely identifying a real volume to which a page identified by a corresponding page ID has been assigned is stored in the real volume ID 311204. An address indicating the storage area of the real volume identified by the real volume ID is stored in the real address 311205.

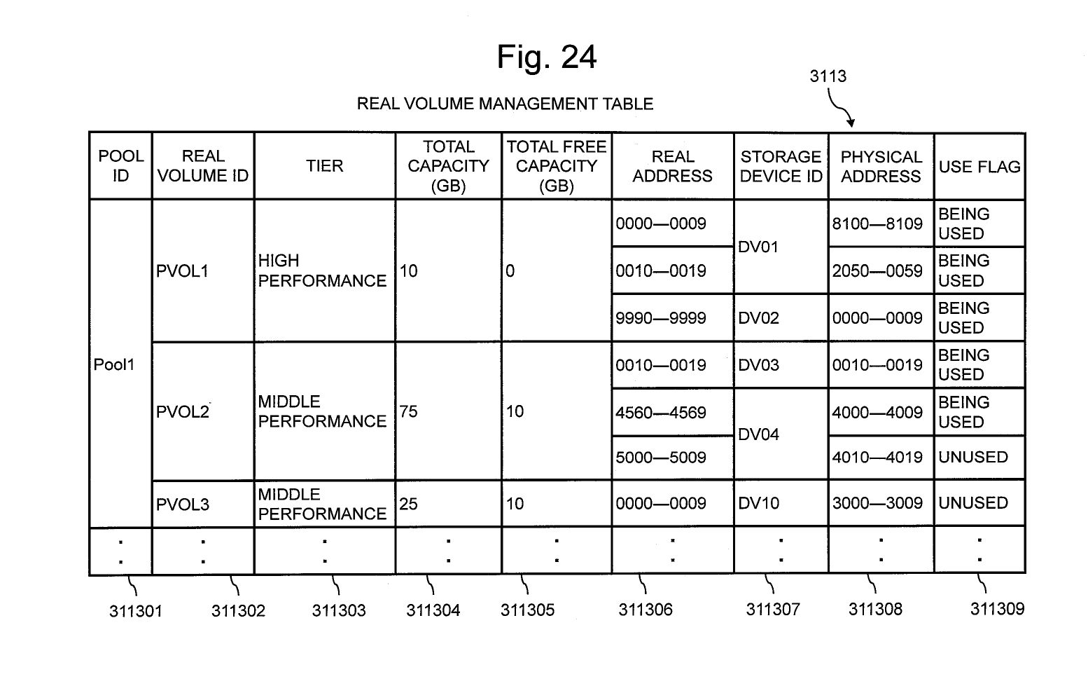

FIG. 24 is a diagram showing content of the real volume management table according to the first embodiment.

The real volume management table 3113 is a table that manages the real volumes registered in the pool. Fields of a pool ID 311301, a real volume ID 311302, a tier 311303, a total capacity 311304, a total free capacity 311305, a real address 311306, a storage device ID 311307, a physical address 311308, and a use flag 311309 are included in each entry of the real volume management table 3113.

An identifier (pool ID) for uniquely identifying each pool managed by the storage apparatus 300 is stored in the pool ID 311301. An identifier (real volume ID) for uniquely identifying each real volume managed by the storage apparatus 300 is stored in the real volume ID 311302. Characteristic information regarding an input/output performance of the real volume indicated by the real volume ID is stored in the tier 311303. The size of the storage area included in the real volume indicated by the real volume ID is stored in the total capacity 311304. The size of an unused storage area, in the storage area included in the real volume indicated by the real volume ID, is stored in the total free capacity 311305. An address (real address) indicating the storage area of the real volume indicated by the real volume ID is stored in the real address 311306. It should be noted that the size of the storage area indicated by the real address is the same as the page size. An identifier (storage device ID) for uniquely identifying the storage device 360 comprising the storage area indicated by the real address is stored in the storage device ID 311307. An address indicating the storage area of the storage device 360 comprising the storage area indicated by the real address is stored in the physical address 311308. A flag (use flag), which indicates that the storage area indicated by the real address is used for page assignment, is configured in the use flag 311309.

FIG. 25 is a diagram showing the IO request according to the first embodiment.

0084

The IO request 600 is issued by the management computer 100 or the host computer 200. The IO request 600 comprises fields of a destination 60001, instruction content 60002, a serial number 60003, and an option 60004.

Information regarding a destination of this IO request 600, for example, information including the identifier of the storage apparatus 300 of a transmission destination of this IO request 600, the logical volume ID in this storage apparatus 300, and the address of the storage area (for example, the virtual area or the real area) of the logical volume indicated by this logical volume ID, is stored in the destination 60001. Content of a process indicated by this TO request 600 (instruction content) is stored in the instruction content 60002. For example, the instruction content is the storage tier control instruction or the data access instruction. The storage tier control instruction includes, for example, page lock start, page unlock, page move to a specified tier, obtaining a tier usage status, or obtaining a pool state. Moreover, the data access instruction includes, for example, data write or data read-in. An order of issuing this IO request 600 (serial number) is stored in the serial number 60003. The serial number is determined by the management computer 100 or the host computer 200 that has issued this IO request 600. Content of data for which a write request is issued through this IO request 600, the tier of a page move destination and the like are stored in the option 60004.

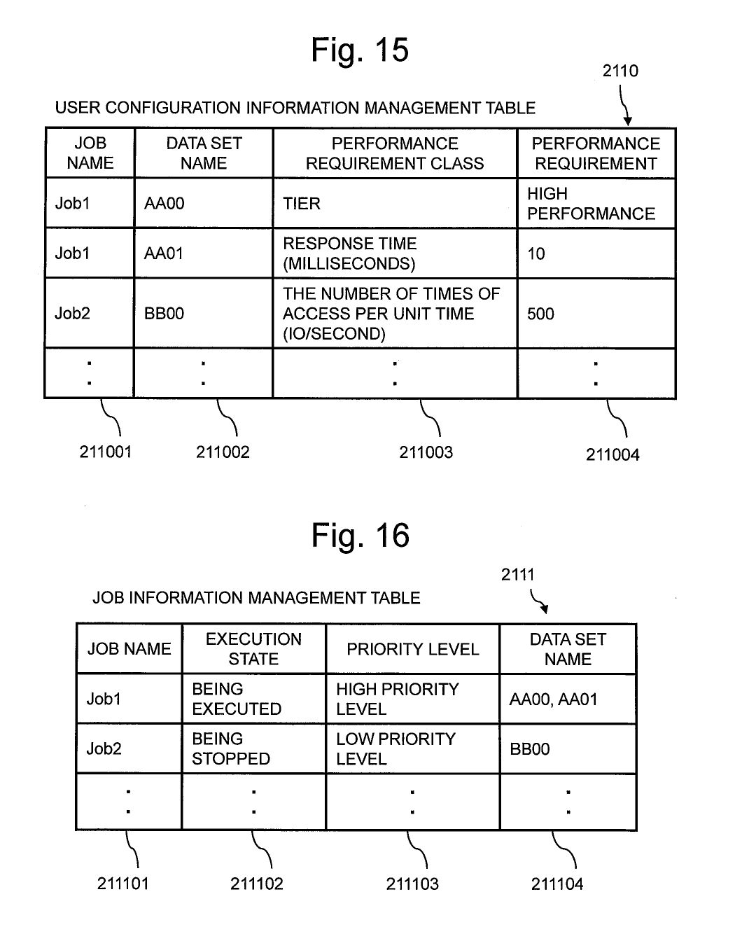

FIG. 15 is a diagram showing an example of the user configuration information management table according to the first embodiment.

The user configuration information management table 2110 is information that has been previously configured for control target data by the user of the host computer 200. Fields of a job name 211001, a data set name 211002, a performance requirement class 211003, and a performance requirement 211004 are included in each entry of the user configuration information management table 2110.

A name of a job (job name) used by the OS 2101 operating on the host computer 200 when the OS 2101 executes an application is stored in the job name 211001. A name of a data set (data set name) used by the application launched in the job with the job name is stored in the data set name 211002. A class of a performance requirement (performance requirement class) for data that is uniquely identified by a corresponding data set name is stored in the performance requirement class 211003. The performance requirement class includes, for example, the tier of the pool in which the data should be stored, the data access response time (for example, in milliseconds), the number of times of access per unit time (for example, IOPS (IO Per Second) and the like. Content of the performance requirement class is stored in the performance requirement 211004. For example, if the performance requirement class is the data access response time, a value within 10 milliseconds or the like is stored in the performance requirement 211004.

FIG. 16 is a diagram showing an example of the job information management table according to the first embodiment.

The job information management table 2111 is a table that manages the jobs to be executed by the OS 2101 operating on the host computer 200. Fields of a job name 211101, an execution state 211102, a priority level 211103, and a data set name 211104 are included in each entry of the job information management table 2111.

The name of the job (job name) used by the OS 2101 operating on the host computer 200 when the OS 2101 executes the application is stored in the job name 211101. Information on whether or not a job with a corresponding job name is being executed by the OS 2101 is stored in the execution state 211102. The priority level of the job with the job name when the job is executed by the OS 2101 is stored in the priority level 211103. The name of the data set used by the application launched in the job with the corresponding job name is stored in the data set name 211104.

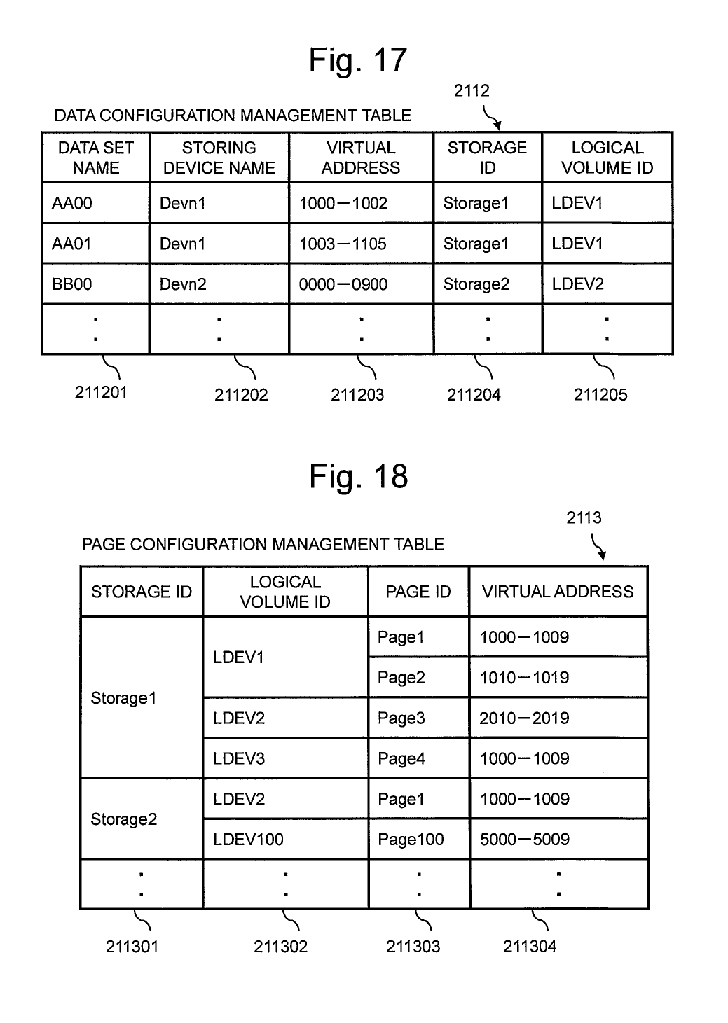

FIG. 17 is a diagram showing an example of the data configuration management table according to the first embodiment.

The data configuration management table 2112 is a table that manages the storage areas of the logical volumes in which the data sets have been stored. Fields of a data set name 211201, a storing device name 211202, a virtual address 211203, a storage ID 211204, and a logical volume ID 211205 are included in each entry of the data configuration management table 2112.

A name of a data set (data set name) managed by the OS 2101 is stored in the data set name 211201. An identifier (for example, a device number) for uniquely identifying a logical volume in which the data set with the data set name is stored, by the OS 2101 on the host computer 200, is stored in the storing device name 211202. An address indicating a storage area of a logical volume in which a data set with a corresponding data set name is stored is stored in the virtual address 211203. An identifier (storage ID) for uniquely identifying the storage apparatus 300 managed by the host computer 200 is stored in the storage ID 211204. An identifier for uniquely identifying the logical volume given by the storage apparatus 300 identified by the storage ID is stored in the logical volume ID 211205.

FIG. 18 is a diagram showing an example of the page configuration management table according to the first embodiment.

The page configuration management table 2113 is a table that manages correspondence between the storage area (virtual address) of the logical volume and the page. Fields of a storage ID 211301, a logical volume ID 211302, a page ID 211303, and a virtual address 211304 are included in each entry of the page configuration management table 2113.

The identifier (storage ID) for uniquely identifying the storage apparatus 300 managed by the host computer 200 is stored in the storage ID 211301. An identifier (logical volume ID) for uniquely identifying a logical volume given by a storage apparatus 300 identified by a corresponding storage ID is stored in the logical volume ID 211302. An identifier (page ID) for uniquely identifying a page, which has been assigned by the storage apparatus 300 to a logical volume identified by the corresponding storage ID and a corresponding logical volume ID, is stored in the page ID 211303. The address (virtual address) of the storage area on the logical volume assigned to the page identified by the page ID is stored in the virtual address 211304.

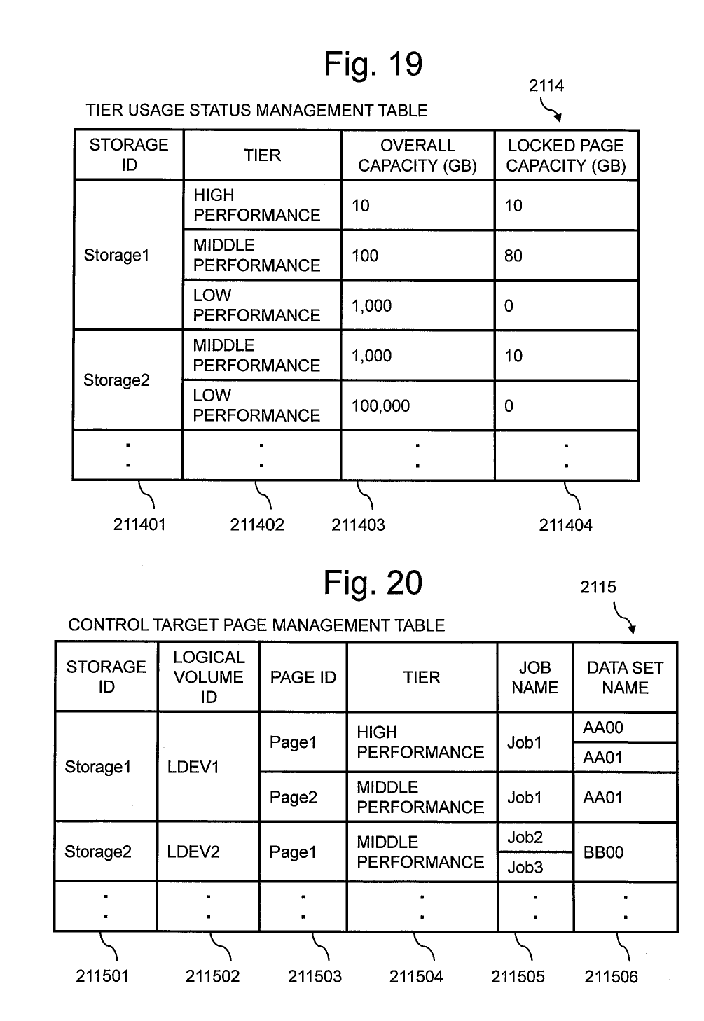

FIG. 19 is a diagram showing an example of the tier usage status management table according to the first embodiment.

The tier usage status management table 2114 is a table that manages the usage statuses of the storage tiers. Fields of a storage ID 211401, a tier 211402, an overall capacity 211403, and a locked page capacity 211404 are included in each entry of the tier usage status management table 2114.

The identifier (storage ID) for uniquely identifying the storage apparatus 300 managed by the host computer 200 is stored in the storage ID 211401. An identifier for uniquely identifying the tier of the real volume managed by the storage apparatus 300 indicated by the corresponding storage ID is stored in the tier 211402. A total value of total capacities of the one or more real volumes corresponding to the tier is stored in the overall capacity 211403. A total capacity of pages being page-locked, in the pages assigned from the one or more real volumes corresponding to the tier, is stored in the locked page capacity 211404.

FIG. 20 is a diagram showing an example of the control target page management table according to the first embodiment.

The control target page management table 2115 is a table that manages the control target pages in the storage tier control depending on the importance level of the application. Fields of a storage ID 211501, a logical volume ID 211502, a page ID 211503, a tier 211504, a job name 211505, and a data set name 211506 are included in each entry of the control target page management table 2115.

The identifier (storage ID) for uniquely identifying the storage apparatus 300 managed by the host computer 200 is stored in the storage ID 211501. The identifier (logical volume ID) for uniquely identifying the logical volume given by the storage apparatus 300 identified by the corresponding storage ID is stored in the logical volume ID 211502. The identifier (page ID) for uniquely identifying the page, which has been assigned by the storage apparatus 300 to the logical volume identified by the corresponding storage ID and the corresponding logical volume ID, is stored in the page ID 211503. Information indicating a storage tier to which this page has been assigned is stored in the tier 211504. A name of a job (job name) that accesses this page is stored in the job name 211505. A name of a data set (data set name) specified by this job when this job accesses this page is stored in the data set name 211506.

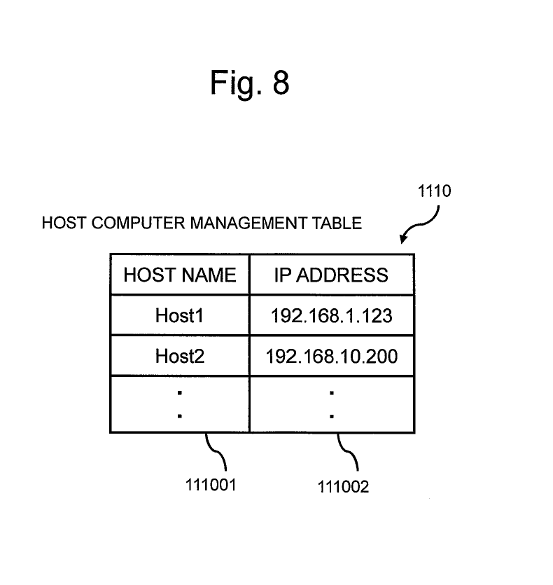

FIG. 8 is a diagram showing an example of the host computer management table according to the first embodiment.

The host computer management table 1110 is information on the host computer 200 managed by the management computer 100. Fields of a host name 111001 and an IP address 111002 are included in each entry of the host computer management table 1110.

A name of the host computer 200 is stored in the host name 111001. An IP address given to the host computer 200 is stored in the IP address 111002.

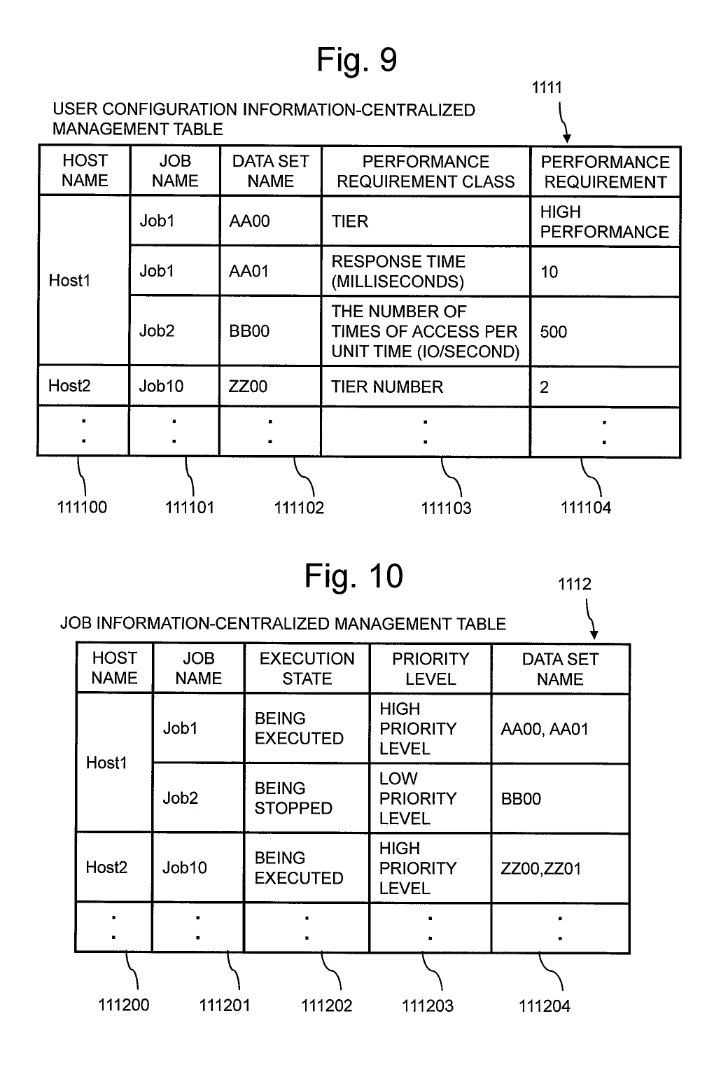

FIG. 9 is a diagram showing an example of the user configuration information-centralized management table according to the first embodiment.

The user configuration information-centralized management table 1111 is information regarding the storage tier control target data that has been previously configured by the user for one or more host computers 200 regarded as the control targets by the management computer 100. Fields of a host name 111100, a job name 111101, a data set name 111102, a performance requirement class 111103, and a performance requirement 111104 are included in each entry of the user configuration information-centralized management table 1111.

The name of the host computer 200 regarded as the management target by the management computer 100 is stored in the host name 111100. The name of the job (job name) used by the OS 2101 operating on the host computer 200 when the OS 2101 executes the application is stored in the job name 111101. The name of the data set (data set name) used by the application launched in the job with the corresponding job name is stored in the data set name 111102. The class of the performance requirement for the data that is uniquely identified by the corresponding data set name is stored in the performance requirement class 111103. Content of a corresponding performance requirement class is stored in the performance requirement 111104.

FIG. 10 is a diagram showing an example of the job information-centralized management table according to the first embodiment.

The job information-centralized management table 1112 is a table that manages the jobs to be executed by the OS 2101 operating on the host computer 200. Fields of a host name 111200, a job name 111201, an execution state 111202, a priority level 111203, and a data set name 111204 are included in each entry of the job information-centralized management table 1112.

The name of the host computer 200 (host name) regarded as the management target by the management computer 100 is stored in the host name 111200. The name of the job (job name) used by the OS 2101 operating on the host computer 200 when the OS 2101 executes the application is stored in the job name 111201. The information indicating whether or not the job with the corresponding job name is being executed by the OS 2101 is stored in the execution state 111202. The priority level of the job with the corresponding job name when the job is executed by the OS 2101 is stored in the priority level 111203. The name of the data set used by the application launched in the job with the corresponding job name is stored in the data set name 111204.

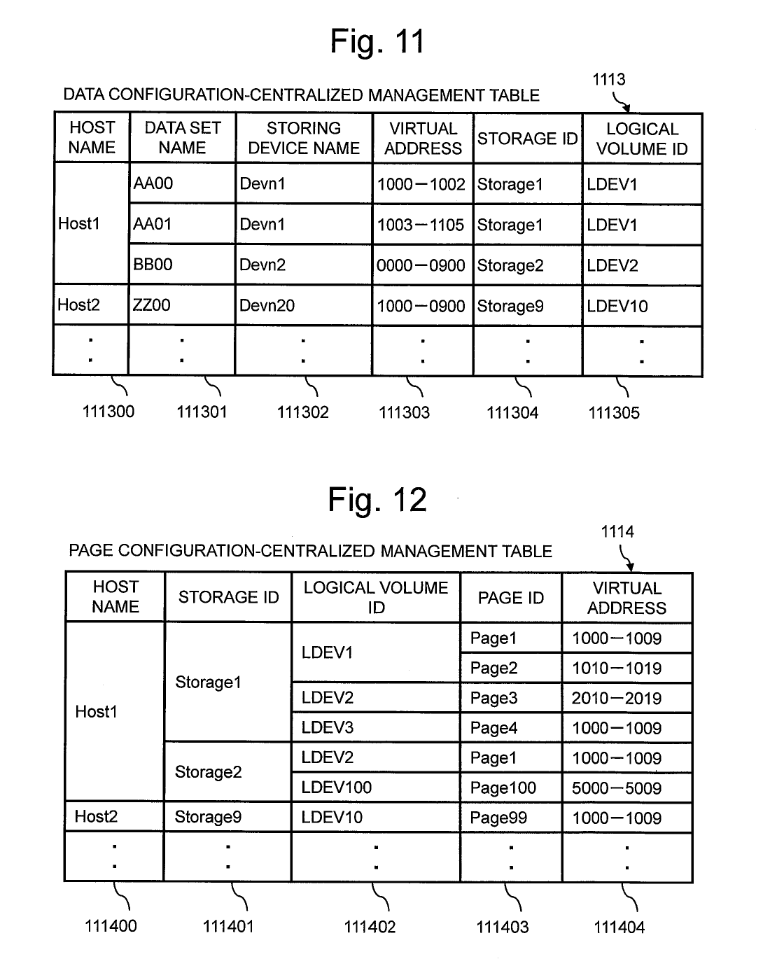

FIG. 11 is a diagram showing an example of the data configuration-centralized management table according to the first embodiment.

The data configuration-centralized management table 1113 is a table that manages the storage areas of the logical volumes in which the data sets have been stored. Fields of a host name 111300, a data set name 111301, a storing device name 111302, a virtual address 111303, a storage ID 111304, and a logical volume ID 111305 are included in each entry of the data configuration-centralized management table 1113.

The name of the host computer 200 (host name) regarded as the management target by the management computer 100 is stored in the host name 111300. The name of the data set (data set name) managed by the OS 2101 is stored in the data set name 111301. The identifier (for example, the device number) for uniquely identifying the logical volume in which the data set with the corresponding data set name is stored, by the OS 2101 on the host computer 200, is stored in the storing device name 111302. The address (virtual address) indicating the storage area of the logical volume in which the data set with the corresponding data set name is stored is stored in the virtual address 111303. The identifier (storage ID) for uniquely identifying the storage apparatus 300 managed by the host computer 200 is stored in the storage ID 111304. The identifier (logical volume ID) for uniquely identifying the logical volume given by the storage apparatus 300 identified by the corresponding storage ID is stored in the logical volume ID 111305.

FIG. 12 is a diagram showing an example of the page configuration-centralized management table according to the first embodiment.

The page configuration-centralized management table 1114 is a table that manages the correspondence between the storage area (virtual address) of the logical volume and the page. Fields of a host name 111400, a storage ID 111401, a logical volume ID 111402, a page ID 111403, and a virtual address 111404 are included in each entry of the page configuration-centralized management table 1114.

The name of the host computer 200 (host name) regarded as the management target by the management computer 100 is stored in the host name 111400. The identifier (storage ID) for uniquely identifying the storage apparatus 300 managed by the host computer 200 is stored in the storage ID 111401. The identifier (logical volume ID) for uniquely identifying the logical volume given by the storage apparatus 300 identified by the corresponding storage ID is stored in the logical volume ID 111402. The identifier (page ID) for uniquely identifying the page, which has been assigned by the storage apparatus 300 to the logical volume identified by the corresponding storage ID and the corresponding logical volume ID, is stored in the page ID 111403. The address (virtual address) of the storage area on the logical volume assigned to the page identified by the corresponding page ID is stored in the virtual address 111404.

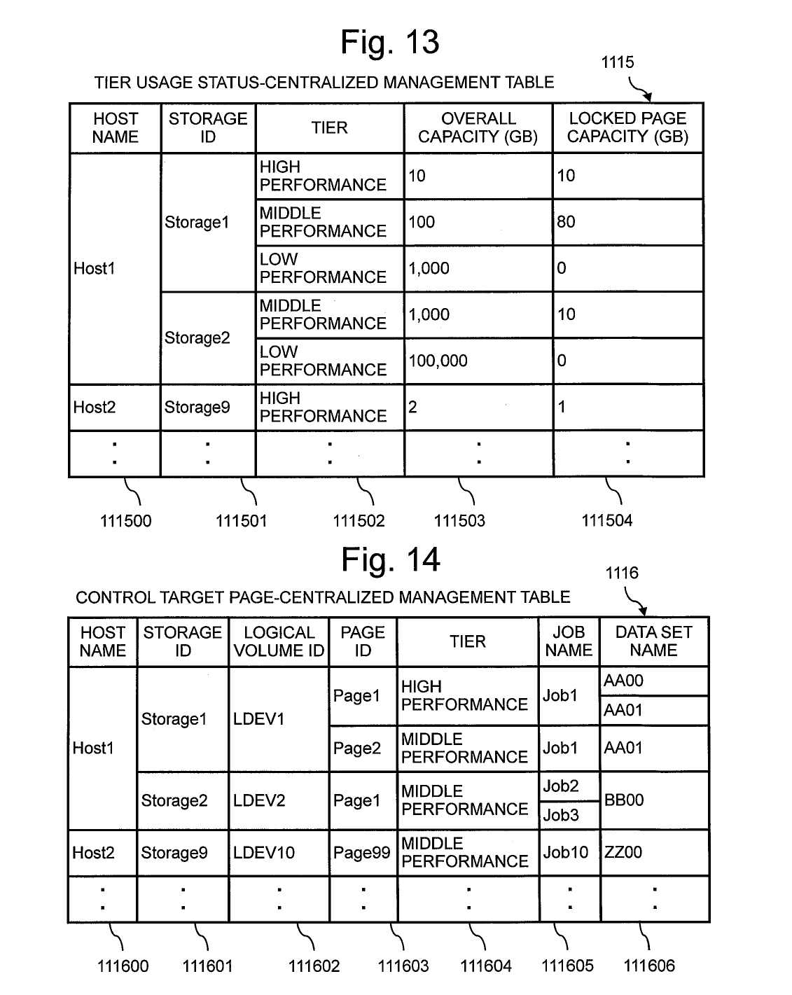

FIG. 13 is a diagram showing an example of the tier usage status-centralized management table according to the first embodiment.

The tier usage status-centralized management table 1115 is a table that manages the usage statuses of the storage tiers. Fields of a host name 111500, a storage ID 111501, a tier 111502, an overall capacity 111503, and a locked page capacity 111504 are included in each entry of the tier usage status-centralized management table 1115.

The name of the host computer 200 (host name) regarded as the management target by the management computer 100 is stored in the host name 111500. The identifier (storage ID) for uniquely identifying the storage apparatus 300 managed by the host computer 200 is stored in the storage ID 111501. An identifier for uniquely identifying each storage tier is stored in the tier 111502. The total value of the total capacities of the one or more real volumes in the corresponding tier is stored in the overall capacity 111503. The total capacity of the pages being page-locked, in the pages assigned from the one or more real volumes in the corresponding tier, is stored in the locked page capacity 111504.

FIG. 14 is a diagram showing an example of the control target page-centralized management table according to the first embodiment.

The control target page-centralized management table 1116 is a table that manages the control target pages in the storage tier control depending on the importance level of the application. Fields of a host name 111600, a storage ID 111601, a logical volume ID 111602, a page ID 111603, a tier 111604, a job name 111605, and a data set name 111606 are included in each entry of the control target page-centralized management table 1116.

The name of the host computer 200 (host name) regarded as the management target by the management computer 100 is stored in the host name 111600. The identifier (storage ID) for uniquely identifying the storage apparatus 300 managed by the host computer 200 is stored in the storage ID 111601. The identifier (logical volume ID) for uniquely identifying the logical volume given by the storage apparatus 300 identified by the corresponding storage ID is stored in the logical volume ID 111602. The identifier (page ID) for uniquely identifying the page, which has been assigned by the storage apparatus 300 to the logical volume identified by the corresponding storage ID and the corresponding logical volume, is stored in the page ID 111603. Information indicating the tier of the real volume to which this page has been assigned is stored in the tier 111604. The name of the job (job name) that accesses this page is stored in the job name 111605. The name of the data set (data set name) specified by this job when this job accesses this page is stored in the data set name 111606.

### (1-4) Detailed Operations of Each Apparatus

### (1-4-1) Example in the Case where Application is Assumed to Always Access the Same Single Piece of Data

### Example A1

In Example A1, operations of each apparatus in a case of a one-to-one correspondence relationship between an application of the host computer 200 and data accessed by this application will be described. Here, in Example A1, a case of a one-to-one relationship between the job and the data set accessed by the job is assumed where the job is assumed to always access the same data set.

The operations of the storage apparatus 300 will be described first.

The storage apparatus 300 obtains information regarding configuration of the storage apparatus 300 from the user, and creates the storage basic information 3110, the logical volume management table 3111, and the real volume management table 3113, based on the storage apparatus management program 3103. Specifically, the storage apparatus 300 obtains the IP address and the storage ID from the user's input (for example, the user's input to the input/output part 370), and stores the obtained IP address into the IP address 311001. Next, in order to create the real volume, the pool ID, the real volume ID, the storage device ID, and the physical address are obtained from the user's input. Furthermore, the storage apparatus 300 adds a new entry to the real volume management table 3113, and stores the obtained information into the pool ID 311301, the real volume ID 311302, the storage device ID 311307, and the physical address 311308 of this entry. Furthermore, the storage apparatus 300 obtains performance information and capacity information from the storage device 360 indicated by the storage device ID stored in the storage device ID 311307, and stores the obtained information into the tier 311303 and the total capacity 311304 of this entry. Furthermore, the storage apparatus 300 initializes the total free capacity 311305 to be “0”, and initializes the use flag 311309 to be “unused,” in this entry. The storage apparatus 300 repeats this operation the same number of times as the number of the user's inputs, and creates the real volume management table 3113. Furthermore, in order to create the logical volume, the storage apparatus 300 obtains the pool ID, the real volume ID, and the virtual address from the user's input. Furthermore, the storage apparatus 300 adds a new entry to the logical volume management table 3111, and stores the obtained information into the pool ID 311101, the real volume ID 311102, and the virtual address 311103 of this entry. Furthermore, the storage apparatus 300 initializes the page ID to be “free,” initializes the reference flag 311105 to be “not referred to,” and initializes the lock flag 311106 to be “unlocked,” in this entry. This operation is repeated the same number of times as the number of the user's inputs, and the logical volume management table 3111 is created.

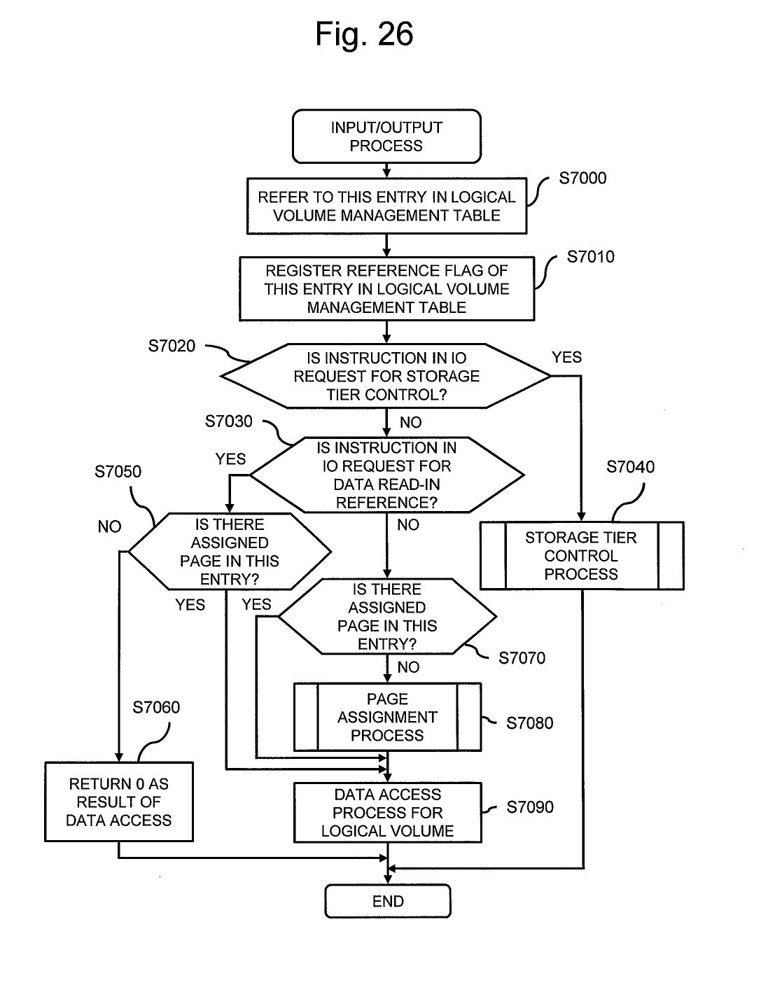

FIG. 26 is a flowchart of an input/output process according to the first embodiment.

When receiving the IO request 600 from the host computer 200, based on the input/output processing program 3102, the storage apparatus 300 obtains the logical volume ID and the virtual address included in the destination 60001 of this IO request 600, and obtains an entry matching the obtained logical volume ID and the obtained virtual address (referred to as “this logical volume entry” in the description of this process), from the logical volume management table 3111 (S7000).

Next, the storage apparatus 300 registers the reference flag indicating that there has been the reference, into the reference flag 311105 of this logical volume entry (S7010), and determines whether or not the instruction content stored in the instruction content 60002 of this IO request 600 is the storage tier control instruction (S7020).

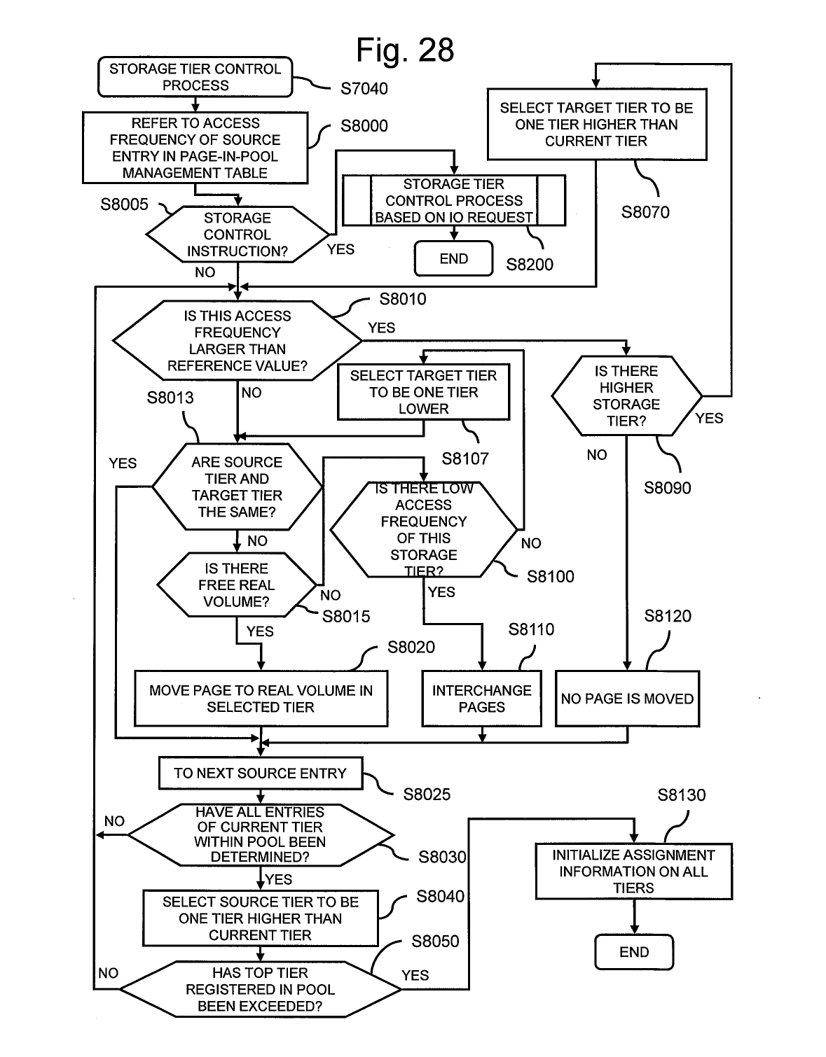

As a result, if the instruction content of this IO request 600 is the storage tier control instruction (Yes in S7020), the storage apparatus 300 executes a storage tier control process (see FIG. 28) (S7040), and ends the input/output process. In contrast, if the instruction content of this IO request 600 is not the storage tier control instruction (No in S7020), the storage apparatus 300 advances the process to step S7030.

In step S7030, the storage apparatus 300 determines whether or not the instruction content of this IO request 600 is data read-in reference. As a result, if the instruction content of this IO request 600 is the data read-in reference (Yes in S7030), the storage apparatus 300 advances the process to step S7050, while if the instruction content of this IO request 600 is not the data read-in reference (No in S7030), the storage apparatus 300 advances the process to step S7070.

In step S7050, the storage apparatus 300 determines whether or not there is an assigned page in this logical volume entry. Specifically, the storage apparatus 300 refers to the page ID in the page ID 311104, and determines whether or not the page ID represents “free” (meaning nonexistence of the assigned page). If the page ID 311104 represents “free”, the storage apparatus 300 executes a process in step S7060. In contrast, if the page ID 311104 does not represent “free”, the storage apparatus 300 executes a process in step S7090.

In step S7060, the storage apparatus 300 regards a result of the data reference by the IO request 600 as “0” (that is, assumes that data representing “0” has been read), returns the data “0” to the host computer 200, and ends the input/output process.

In contrast, in step S7070, the storage apparatus 300 performs a process similar to step S7050 to determine whether or not there is the assigned page in this logical volume entry. If there is no assigned page (No in S7070), the storage apparatus 300 advances the process to step S7080, while if there is the assigned page (Yes in S7070), the storage apparatus 300 advances the process to step S7090.

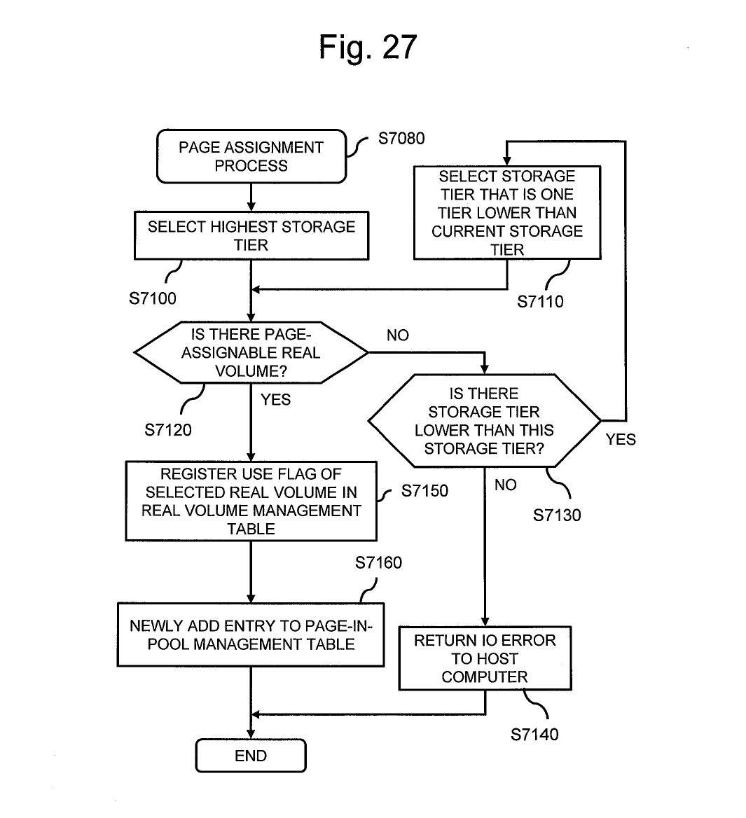

In step S7080, the storage apparatus 300 executes a page assignment process (see FIG. 27) to assign the page from the pool, and then advances the process to step S7090.

In step S7090, the storage apparatus 300 executes a data access process for the virtual address stored in the virtual address 311103 of this logical volume entry. Specifically, the storage apparatus 300 obtains an entry (page-in-pool management table entry) matching the page ID in the page ID 311104 of this logical volume entry, from the page-in-pool management table 3112. Next, the storage apparatus 300 adds 1 to the value of the access frequency 311203 of the obtained page-in-pool management table entry. Furthermore, the storage apparatus 300 obtains an entry (real volume management table entry) matching the real volume ID and the real address of the page-in-pool management table entry, from the real volume management table 3113. Furthermore, the storage apparatus 300 executes the data access process for the storage area of the storage device 360 identified by the storage ID in the storage device ID 311307 and the physical address in the physical address 31108 of the obtained real volume management table entry. The storage apparatus 300 then ends the input/output process.

FIG. 27 is a flowchart of the page assignment process according to the first embodiment.

The page assignment process corresponds to the process executed in step S7080 of the input/output process (FIG. 26). The storage apparatus 300 executes the page assignment process based on the page assignment control program 3101.

The storage apparatus 300 obtains one or more entries (real volume management table entries) matching the pool ID in the pool ID 311101 of the logical volume entry to be determined in step S7070 of the input/output process, from the real volume management table 3113, and selects the highest tier in the tier 311303 (the highest tier configured to include the highest performance and reliability), in the obtained real volume management table entries (S7100).

Next, the storage apparatus 300 determines whether or not there is an assignable real volume for a corresponding logical volume (S7120). Specifically, the storage apparatus 300 identifies real volume management table entries matching the selected tier, and with reference to the total free capacity of each of the identified real volume management table entries, determines whether or not there is an entry with the total free capacity equal to or larger than the page size (that is, the assignable real volume).

As a result, if there is the real volume management table entry with the total free capacity equal to or larger than the page size, that is, if the assignable real volume exists (Yes in S7120), the storage apparatus 300 advances the process to step S7150, while if there is no real volume management table entry with the total free capacity 311305 equal to or larger than the page size (No in S7120), the storage apparatus 300 advances the process to step S7130.

In step S7150, the storage apparatus 300 identifies a real volume management table entry with the use flag “unused” (indicating an unassigned area) in the use flag 311309, in the real volume management table entries identified in step S7120. Then, the storage apparatus 300 registers a flag “being used” indicating usage for page assignment, into the use flag 311309 of this entry.

Next, the storage apparatus 300 uses the real volume management table entry identified in step S7120 to add a new entry to the page-in-pool management table 3112. Specifically, the storage apparatus 300 adds the new entry, and for the added entry, stores the pool ID in the pool ID 311101 of this logical volume entry, into the pool ID 311201; stores an arbitrary value that is not stored in the page ID 311202 of the page-in-pool management table 3112 (for example, a value provided by adding 1 to a maximum value stored in the page ID 311202 of the page-in-pool management table 3112), into the page ID 311202, as the identifier that can uniquely identify the page; stores an initial value “0” into the access frequency 311203; stores the value of the real volume ID 311302 of the real volume management table entry identified in step S7120, into the real volume ID 311204; and stores the value of the real address 311306 of the real volume management table entry identified in step S7120, into the real address 311205. Then, the storage apparatus 300 ends the page assignment process.

In contrast, in step S7130, the storage apparatus 300 checks whether or not there is a real volume retaining a storage area in a tier that is one tier lower than a chosen tier. As a result, if there is the real volume retaining the tier that is one tier lower (Yes in S7130), the storage apparatus 300 advances the process to step S7110, while if there is no real volume retaining the storage area in the tier that is one tier lower (No in S7130), the storage apparatus 300 advances the process to step S7140.

In step S7110, the storage apparatus 300 selects the tier that is one tier lower than the current one, and executes the processes in step S7120 and subsequent steps, for this tier as a target.

In contrast, in step S7140, the storage apparatus 300 returns an IO error to the host computer 200 that has issued the IO request. It should be noted that the storage apparatus 300 may notify the user of the IO error via an email or the like, in addition to returning the IO error to the host computer 200.

FIG. 28 is a flowchart of the storage tier control process according to the first embodiment.

The storage tier control process is executed by the storage apparatus 300 based on the page assignment control program 3101. This storage tier control process is, for example, periodically executed, or executed according to the instruction from the management computer 100 or the host computer 200. The storage tier control process is, for example, executed in step S7040 of the input/output process (FIG. 26). It should be noted that the storage tier control process for each pool will be described below.

First, the storage apparatus 300 obtains an entry (page-in-pool management table entry) matching a specified pool ID, from the page-in-pool management table 3112, and refers to the access frequency in the access frequency 311203 of the obtained page-in-pool management table entry. Moreover, the storage apparatus 300 obtains an entry (real volume management table entry) matching the real volume ID 311204 of the obtained page-in-pool management table entry, from the real volume management table 3113, and refers to the tier in the tier 311303 of this entry. It should be noted that, in the present embodiment, the storage apparatus 300 refers to page-in-pool management table entries matching the real volume ID of the lowest tier, in descending order from the highest entry.

Hereinafter, for explanatory purposes, it is assumed that the storage apparatus 300 regards the tier of the page at this time (a tier to be replaced) as a source tier, and regards an entry matching the real volume ID of the source tier, in the page-in-pool management table 3112, as a source entry. Moreover, a tier to be referred to, as a page replacement destination, is regarded as a target tier, and an entry matching the real volume ID of the target tier, in the page-in-pool management table 3112, is regarded as a target entry.

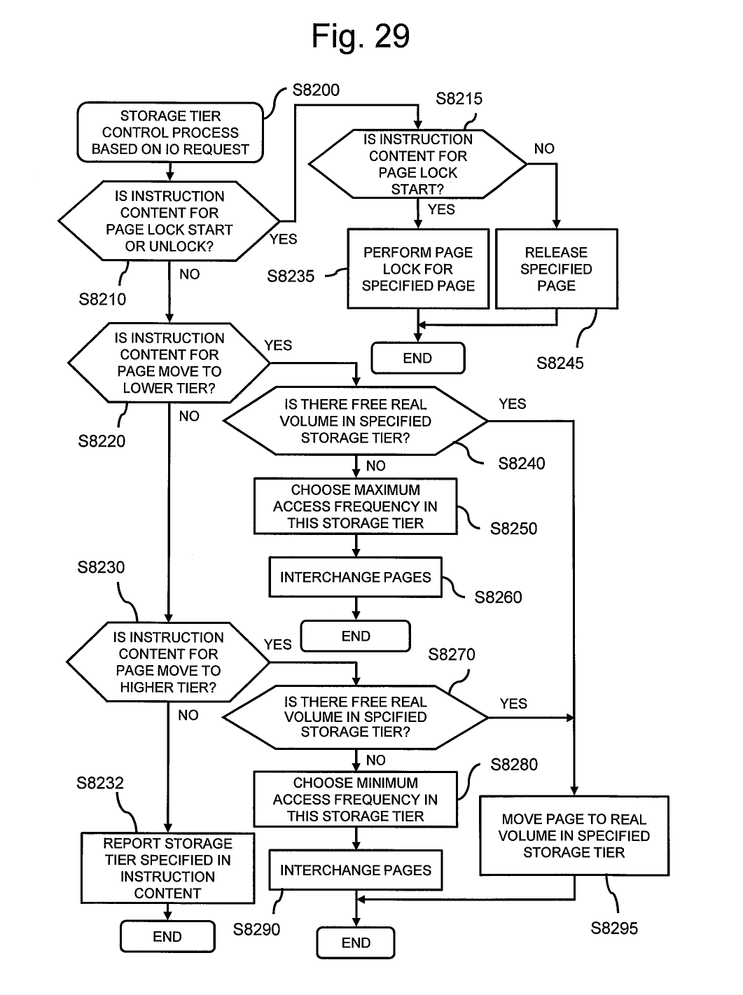

Next, the storage apparatus 300 determines whether or not the current tier control process has been caused by the storage tier control instruction (S8005). Here, if the storage tier control instruction has caused it (Yes in S8005), the storage apparatus 300 executes a hierarchical storage control process based on the IO request (see FIG. 29) (S8200), and ends the process. In contrast, if it is not the storage tier control instruction (No in S8005), the storage apparatus 300 advances the process to step S8010.

In step S8010, the storage apparatus 300 compares a reference access frequency (reference access frequency, reference value) provided for the target tier (an initial value is the same tier as the source tier), with the access frequency of this entry. It should be noted that the reference access frequency for each tier has been previously specified by the user or the like.

As a result, if the access frequency is larger than the reference access frequency (Yes in S8010), the storage apparatus 300 advances the process to step S8090 in order to attempt to execute the page move between the real volumes in different tiers. In contrast, if the access frequency is not larger than the reference access frequency (No in S8010), the storage apparatus 300 advances the process to step S8013.

In step S8090, the storage apparatus 300 determines whether or not there is a tier that is one tier higher than the source tier. As a result, if there is the tier that is one tier higher than the source tier (Yes in S8090), the storage apparatus 300 selects the target tier to be a tier that is one tier higher than a current tier (S8070), and advances the process to step S8010.

The storage apparatus 300 can identify the target tier in which the access frequency of the entry does not become larger than the reference value, by repeatedly performing the above processes (such as S8010, S8090 and S8070). It should be noted that if it is determined that there is no tier that is one tier higher than the source tier (No in S8090), the storage apparatus 300 does not perform the page move for the corresponding page (S8120), and advances the process to step S8025. Thus, if there is no tier higher than the source tier, that is, if the source tier is the highest tier, the storage apparatus 300 directly continues the process without moving the page of the source entry, in order to continue to use the highest tier.

In contrast, in step S8010, if the access frequency in the access frequency 311203 of the source entry is equal to or less than the reference value (No in S8010), the storage apparatus 300 determines whether or not the source tier and the target tier are the same (S8013). If it is determined that source tier and the target tier are the same (Yes in S8013), the storage apparatus 300 judges that the page indicated by the source entry satisfies the reference value of the storage tier to which the page is currently assigned, and that the page move of the source entry is not required, and advances the process to step S8025.

In contrast, if it is determined that the source tier and the target tier are not the same (No in S8013), the storage apparatus 300 judges that the page indicated by the source entry does not satisfy the reference value of the storage tier to which the page is currently assigned, and that the page move of the source entry is required, and checks whether or not the target tier includes a free capacity, that is, whether or not a page-assignable real volume exists in the target tier, with reference to the entire free capacity of the real volume of the target tier (S8015).

As a result, if the target tier includes no free capacity (No in S8015), the storage apparatus 300 determines whether or not an entry of the target tier with the access frequency lower than the access frequency in the access frequency 311203 of the source entry exists, and whether or not the lock flag of the corresponding page is other than “being locked” (S8100).

As a result, if no entry of the target tier with the access frequency lower than the value of the access frequency 311203 of the source entry exists, or even though the entry of the target tier with the access frequency lower than the access frequency 311203 of the source entry exists, if the lock flag 311106 of the entry indicated by the page ID of this entry, in the logical volume management table 3111, only shows being under the page lock control (being locked) (No in S8100), the storage apparatus 300 selects a tier that is one tier lower than the target tier, as the target tier (S8107), and advances the process to step S8013.

In contrast, if the entry of the target tier with the access frequency lower than the reference frequency in the access frequency 311203 of the source entry exists, and the lock flag 311106 of the entry indicated by the page ID of this entry, in the logical volume management table 3111, is not under the page lock control (unlocked) (Yes in S8100), the storage apparatus 300 performs page interchange between the page of the source entry and the page of the target entry, that is, stores data of the page of the source entry, into the real volume in which the page of the target entry has been stored, while storing data of the page of the target entry, into the real volume in which the page of the source entry has been stored (S8110).

In contrast, in step S8015, if there is the real volume including the free capacity available for the page move to the target tier (Yes in S8015), the storage apparatus 300 moves the page to the real volume including the free capacity in the target tier, that is, stores the data of the corresponding page, into the real volume (S8020).

After executing step S8020, step S8110 or step S8120, the storage apparatus 300 changes the source entry to be a next entry (S8025).

Next, the storage apparatus 300 checks whether or not the determination process has been executed for all the source entries of the source tier within the pool (S8030). If the determination process has not been executed for all the source entries and there is any unprocessed entry (No in S8030), the storage apparatus 300 advances the process to step S8010, and executes the determination process for another entry. In contrast, if there is no unprocessed entry of the source tier because the determination process has been executed for all the source entries (Yes in S8030), the storage apparatus 300 configures the tier that is one tier higher than the source tier, to be the source tier (S8040), and determines whether or not this source tier has exceeded a top tier registered in the pool (S8050).

As a result, if the source tier has not exceeded the highest tier, that is, if there is the tier that is one tier higher than the source tier (No in S8050), the storage apparatus 300 advances the process to step S8010. In contrast, if the configured tier has exceeded the highest tier, that is, if there is no tier that is one tier higher than the source tier (Yes in S8050), the storage apparatus 300 resets the access frequencies in the access frequency 311203 of all the tiers within the pool, to “0” in the page-in-pool management table 3112 (S8130), and ends the storage tier control process.

FIG. 29 is a flowchart of the storage tier control process based on the IO request according to the first embodiment.

The storage tier control process based on the IO request corresponds to the process executed in step S8200 of the hierarchical storage control process (FIG. 28). The storage tier control process based on the IO request is executed if the storage tier control process is executed in the storage apparatus 300 according to the instruction from the management computer 100 or the host computer 200.

The storage tier control process is the process that may be periodically executed, whereas the storage tier control process based on the IO request is the process executed according to the instruction from the management computer 100 or the host computer 200. While the storage tier control process based on the IO request will be described to be executed for each page, by way of example, if a plurality of pages are included in an address range specified in an option area of the IO request, the storage apparatus 300 may repeatedly execute this process the same number of times as the number of the pages. The storage tier control process based on the IO request in each pool will be described below.

First, the storage apparatus 300 determines whether or not the instruction content in the instruction content 60002 specified by the IO request 600 is the page lock start or the page unlock (S8210). Here, the IO request 600 with the instruction content for the page lock start, for example, is generated when the job is started, and the IO request 600 with the instruction content for the page lock end, for example, is generated when the job is ended. If the instruction content is the page lock start or unlock (Yes in S8210), the storage apparatus 300 determines whether or not the instruction content of the request 600 is the page lock start (S8215). If the instruction content is the page lock start (Yes in S8215), the storage apparatus 300 performs the page lock for the page specified by the destination 60001 of the IO request 600. Specifically, the storage apparatus 300 identifies an entry matching the virtual address of the logical volume specified by the destination 60001, in the logical volume management table 3111, and registers the flag (being locked) indicating being under the page lock control, into the lock flag 311106 of this entry. Thereby, this page is not moved to another tier in the storage tier control process based on the access frequency (the processes in step S8010 and the subsequent steps of FIG. 28). It should be noted that this state is maintained until the page unlock is performed. Then, the storage apparatus 300 ends the storage tier control process based on the IO request.

In contrast, if the instruction content 60002 is the page unlock (No in S8215), the storage apparatus 300 releases the page lock of the page specified in the destination 60001 of the IO request 600. Specifically, the storage apparatus 300 identifies the entry matching the virtual address of the logical volume specified by the destination 60001, in the logical volume management table 3111, and configures the flag indicating being under the page lock control, which is stored in the lock flag 311106 of this entry, to the flag (unlocked) indicating the page unlock. Thereby, this page may be moved to another tier in the storage tier control process based on the access frequency (the processes in step S8010 and the subsequent steps of FIG. 28). Then, the storage apparatus 300 ends the storage tier control process based on the IO request.

In contrast, as a result of the determination in step S8210, if the instruction content is neither the page lock start nor the page unlock (No in S8210), the storage apparatus 300 determines whether or not the instruction content is the page move, and the tier specified in the IO request 600 is lower than the tier to which the page specified in the IO request 600 is currently assigned (S8220). Here, in order to obtain the storage tier to which the page specified by the IO request 600 has been assigned, the storage apparatus 300 performs a process as follows. In other words, the storage apparatus 300 refers to the entry corresponding to the address specified by the TO request 600, in the logical volume management table 3111, and based on the page ID in the page ID 311104 of this entry, refers to the entry in the page-in-pool management table 3112. Furthermore, based on the real volume ID of this entry, the storage apparatus 300 refers to the entry in the real volume management table 3113, and obtains the tier of this entry.

As a result, in the case of the page move to the storage tier lower than the storage tier for the current assignment (Yes in S8220), the storage apparatus 300 determines whether or not there is a free real volume in the storage tier to which the page specified by the IO request 600 is assigned (S8240). Specifically, the storage apparatus 300 obtains the total free capacity in the total free capacity 311305 of the entry of the storage tier to which the page specified by the IO request 600 is assigned, in the real volume management table 3113. Then, the storage apparatus 300 determines whether or not the page can be assigned to the corresponding storage tier, based on the obtained total free capacity.

As a result, if it is determined that the page can be newly assigned to the corresponding storage tier (Yes in S8240), the storage apparatus 300 performs the page move for the data of the virtual address indicated by the page specified in the IO request 600, from the current storage tier to the specified storage tier (S8295).

In contrast, if it is determined that the page cannot be newly assigned to the corresponding storage tier (No in S80240), the storage apparatus 300 performs a process for performing interchange between the page specified in the IO request 600 and a page existing in the storage tier of the move destination of this page. Here, a page (chosen page) to be chosen from the storage tier of the move destination of the page is a page with the highest access frequency in this storage tier. Since a storage tier to which the chosen page moves due to the interchange becomes a storage tier higher than the storage tier to which the chosen page is currently assigned, this is for the purpose of making effective use of a high performance of the high storage tier of the move destination.

Specifically, the storage apparatus 300 identifies one or more entries in which the tier of the real volume indicated by the real volume ID matches the tier of the move destination of the page specified in the IO request 600, in the entries of the page-in-pool management table 3112. Next, the storage apparatus 300 refers to the access frequency of each identified entry, and chooses an entry, that is, a page, with a maximum access frequency (S8250). Next, the storage apparatus 300 interchanges the storage areas of the page specified in the IO request 600 and the page chosen in step S8250 (S8260). After the interchange is completed, the storage apparatus 300 ends the storage tier control process based on the IO request.

In contrast, in step S8220, if it is judged to be not the page move to the storage tier lower than the current storage tier (No in S8220), the storage apparatus 300 determines whether or not the instruction content in the instruction content 60002 of the TO request 600 is the page move, and the storage tier specified in the IO request 600 is higher than the storage tier to which the page specified in the IO request 600 is currently assigned (S8230). Also in this determination in step S8230, the storage apparatus 300 determines whether or not the page move is for the page specified in the IO request 600, to the high storage tier, according to a procedure similar to the determination performed in step S8220.

As a result, if it is determined to be the page move to the storage tier higher than the current storage tier (Yes in S8230), the storage apparatus 300 obtains the total free capacity of the storage tier to which the page specified by the IO request 600 is newly assigned, according to a procedure similar to step S8240, and based on the obtained total free capacity, determines whether or not a new page can be assigned to the corresponding storage tier, that is, whether or not there is the free real volume in the corresponding storage tier (S8270).

As a result, if it is determined that the new page can be assigned to the corresponding storage tier (Yes in S8270), the storage apparatus 300 performs the page move for the data of the virtual address indicated by the page specified in the IO request 600, from the current storage tier to the specified storage tier (S8295). Then, the storage apparatus 300 ends the storage tier control process based on the IO request.

In contrast, if it is determined that the new page cannot be assigned to the corresponding storage tier (No in S8270), the storage apparatus 300 executes a process for performing interchange between the page specified in the IO request 600 and a page (for example, page 1) in the move destination tier for this page. Here, a page (chosen page) to be chosen from the move destination tier for the page is a page with the lowest access frequency in this storage tier. Since a storage tier to which the chosen page is newly assigned due to the interchange becomes a storage tier lower than the storage tier in which the chosen page is currently placed, this intends to enable sufficient use of the low storage tier of the move destination even with a low performance of the storage tier.

Specifically, the storage apparatus 300 identifies one or more entries in which the tier of the real volume indicated by the real volume ID matches the move destination tier specified in the TO request 600, in the entries of the page-in-pool management table 3112. Next, the storage apparatus 300 refers to the access frequency 311203 of each entry, and chooses one with a minimum access frequency (S8280). Next, the storage apparatus 300 performs interchange between the storage areas of the page specified in the IO request 600 and the page chosen in step 8280 (S8290). Then, the storage apparatus 300 ends the storage tier control process based on the IO request.

In contrast, in step S8230, if it is determined to be not the page move to the storage tier higher than the current storage tier (No in S8230), the storage apparatus 300 regards the tier control instruction in the TO request 600, as obtaining volume tier information, obtains tier placement information of the logical volume specified by the IO request 600, and returns the information to a requestor of the IO request 600 (S8232). Specifically, the storage apparatus 300 refers to the entry indicated by the logical volume specified by the destination 60001 of the IO request 600, in the logical volume management table 3111, and obtains the virtual address. Next, the storage apparatus 300 refers to the entry identified by the pool ID and the page ID of this entry, in the page-in-pool management table 3112, and obtains the real volume ID. The storage apparatus 300 further refers to the entry identified by the pool ID and the real volume ID, in the real volume management table 3113, and obtains the tier. Then, the storage apparatus 300 returns the obtained virtual address and the obtained tier to the requestor of the IO request 600. Then, the storage apparatus 300 ends the storage tier control process based on the IO request.

As described above, the storage tier control process based on the IO request is performed in the storage apparatus 300, and thereby, the storage tiers on the storage apparatus 300 can be controlled for each page, based on the instruction from the management computer 100 or the host computer 200.

Processes performed in two phases of a preparation phase and an operation phase by the host computer 200 will be described next.

The process in the preparation phase in the host computer 200 will be described first.

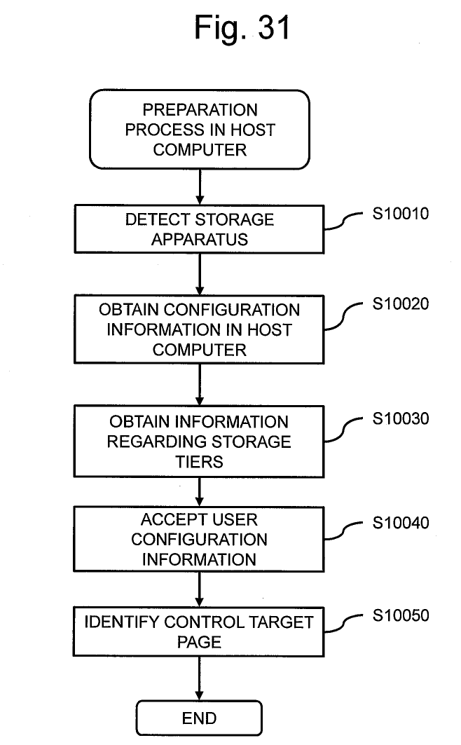

FIG. 31 is a flowchart of a preparation process in the preparation phase in the host computer according to the first embodiment.

The preparation process is executed by executing the user configuration information input program 2103, the job control information obtaining program 2104, the page control program 2105, and the page assignment state monitoring program 2106, by the processor 220 of the host computer 200.

The host computer 200 detects the storage apparatus 300 existing on the computer system 10, based on the user configuration information input program 2103 (S10010). The IP address of the storage apparatus 300 inputted through the input/output part 250 by the user of the host computer 200, for example, can be used as information for detecting the storage apparatus 300. As an IP address input method, for example, a range of the IP address, such as 192.168.1.1 to 192.168.1.50, may be inputted, or a specific IP address may be inputted.

The host computer 200 creates the IO request 600 for obtaining configuration information on the storage apparatus 300, and transmits the created IO request 600 for the inputted IP address. If the storage apparatus 300 receives the IO request 600 for obtaining the configuration information, the storage apparatus 300 refers to the logical volume management table 3111 and the storage basic information 3110 stored in the memory 310, and returns various pieces of information stored therein, together to the host computer 200. The host computer 200 determines the storage apparatus 300 that has provided the return, as the storage apparatus 300 that is the management target in the storage tier control.

Next, the host computer 200 obtains the information regarding the jobs, from the OS 2101, and creates the job information management table 2111, based on the job control information obtaining program 2104 (S10020). Specifically, the host computer 200 obtains the job name, the execution state, the priority level, and the data set name from the OS 2101, creates an entry with the obtained information stored in the job name 211101, the execution state 211102, the priority level 211103, and the data set name 211104, respectively, and stores the entry into the job information management table 2111. The host computer 200 further obtains information regarding the data sets, from the OS 2101, and creates the data configuration management table 2112. Specifically, the host computer 200 obtains the data set name, the storing device name, the virtual address, the storage ID, and the logical volume ID from the OS 2101, creates an entry with the obtained information stored in the data set name 211201, the storing device name 211202, the virtual address 211203, the storage ID 211204, and the logical volume ID 211205, respectively, and stores the entry into the data configuration management table 2112.

Next, the host computer 200 creates the IO request 600 for obtaining the information on the storage tiers, to the storage apparatus 300 identified in step S10010, based on the page assignment state monitoring program 2106, and transmits the IO request 600 to this storage apparatus 300. If the storage apparatus 300 receives the request 600 for obtaining the information on the storage tiers, the storage apparatus 300 refers to the logical volume management table 3111, the page-in-pool management table 3112, and the real volume management table 3113 stored in the memory 310, and returns the information regarding the pages and the usage statuses of the storage tiers to the host computer 200. The host computer 200 creates the page configuration management table 2113 and the tier usage status management table 2114, for the provided return from the storage apparatus 300, based on the information included in this return (S10030).

Specifically, the host computer 200 stores the storage ID specified by the destination 60001 of the IO request 600, into the storage ID 211301 of the page configuration management table 2113. Moreover, the host computer 200 stores the logical volume ID in the logical volume ID 311102 of the logical volume management table 3111 (actually, corresponding content in the information included in the return), into the logical volume ID 211302; stores the page ID in the page ID 311104 of the logical volume management table 3111, into the page ID 211303; and stores the virtual address in the virtual address 311103 of the logical volume management table 3111, into the virtual address 211304. Moreover, the host computer 200 stores the storage ID specified in the destination 60001 of the IO request 600, into the storage ID 211401 of the tier usage status management table 2114. Moreover, the host computer 200 stores the value existing in the tier 311303 of the real volume management table 3113, into the tier 211402; stores a total value of the total capacity 311304 of real volume management table entries matching the tier 211402, into the overall capacity 211403; and stores a total value of the locked page capacities in the capacities of the real volume management table entries, into the locked page capacity 211404.

Next, the host computer 200 accepts the input from the user via the input/output part 250, and creates the user configuration information management table 2110, based on the user configuration information input program 2103 (S10040). Specifically, the host computer 200 accepts the input of the job name, the data set name, and the performance requirement of the control target, from the user, adds a new entry to the user configuration information management table 2110, and stores each piece of the accepted information, into the job name 211001, the data set name 211002, the performance requirement class 211003, and the performance requirement 211004.

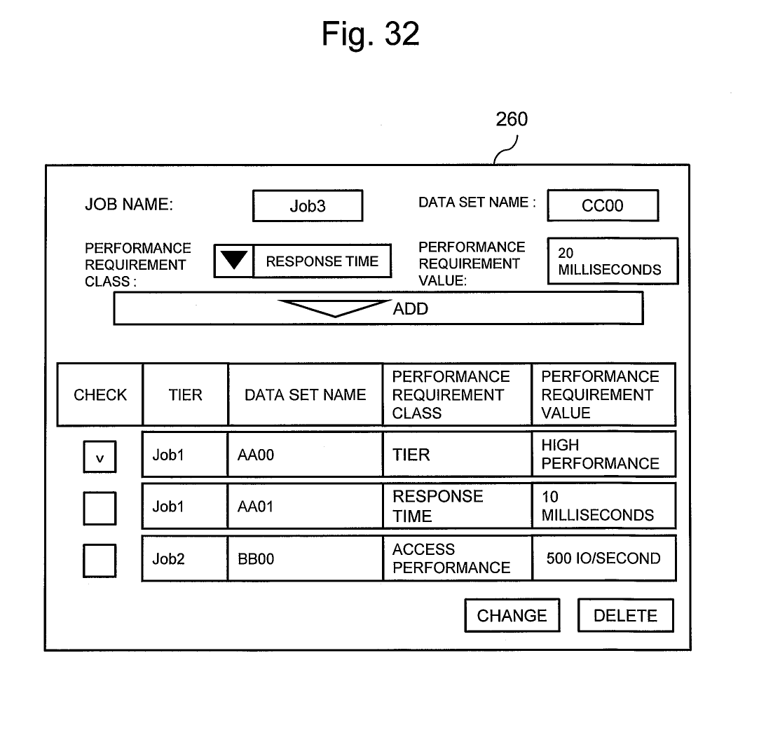

Here, the acceptance of the input from the user via the input/output part 250 is performed, for example, through a screen 260 shown in FIG. 32. Items that can be configured by the user on the screen 260 include the name of the job that executes the application, the name of the data set used by the application, the class of the performance requirement for this data set, and the performance requirement. The class of the performance requirement, for example, includes a storage tier that should store corresponding data, the data access response time, the number of times of access per unit time, or the like. It should be noted that, in addition, the performance requirement may be indirectly specified.

Next, the host computer 200 creates the control target page management table 2115 based on the page control program 2105 and the page assignment state monitoring program 2106 (S10050). Specifically, the host computer 200 identifies a set of the job and the data set, which becomes the control target, from the user configuration information management table 2110 and the job information management table 2111, based on the page control program 2105. Next, the host computer 200 identifies the page in which the data of this data set is stored, from the data configuration management table 2112 and the page configuration management table 2113. Then, the host computer 200 adds a new entry to the control target page management table 2115. Furthermore, the host computer 200 stores the storage ID in the storage ID 211301 of the page configuration management table 2113, into the storage ID 211501; stores the logical volume ID in the logical volume ID 211302, into the logical volume ID 211502; and stores the page ID in the page ID 211303, into the page ID 211503. Moreover, the host computer 200 stores the job name in the job name 211001 of the user configuration information management table 2110, into the job name 211505; and stores the data set name in the data set name 211002, into the data set name 211506. Then, the host computer 200 obtains the tier to which the page indicated by the page ID 211503 is assigned, from the storage apparatus 300, and stores the tier into the tier 211504, based on the page assignment state monitoring program 2106.

The operations of the host computer 200 in the operation phase will be described next.

In the operation phase, due to a change in a state of the job to be executed (for example, execution of the job, a change in the priority level of the job, the end of the job), the host computer 200 executes the storage tier control process based on the priority level of the job, based on the page control program 2105. Specifically, if the host computer 200 senses the change in the state of the OS 2101 or the job executing the application 2102, the host computer 200 updates the information in the job information management table 2111, based on the job control information obtaining program 2104. Next, based on the page control program 2105, the host computer 200 refers to information in various tables memorized in the memory 210, and determines the storage tier of the move destination of the page, in consideration of the priority level of the job and the performance requirement specified by the user. Then, the host computer 200 creates the IO request 600 indicating the page move to the determined storage tier of the move destination, and transmits the created IO request 600 to the storage apparatus 300. Meanwhile, the storage apparatus 300, which has received the IO request 600 indicating the page move, performs the storage tier control process based on the instruction content in the instruction content 60002 of the IO request 600.

The storage tier control process executed by the host computer 200 based on the page control program 2105 will be described next.

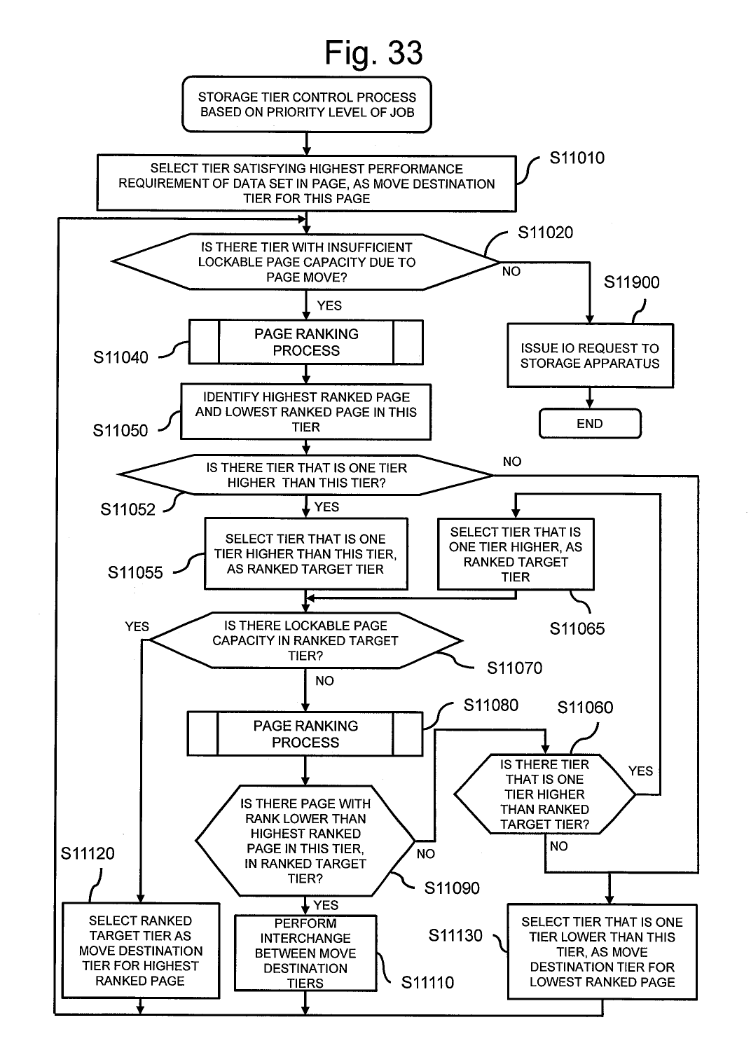

FIG. 33 is a flowchart of the storage tier control process based on the priority level of the job according to the first embodiment.

First, the host computer 200 refers to the control target page management table 2115, and for each control target page, identifies a storage tier satisfying the performance requirement of the job being executed and accessing the page, and selects the identified storage tier as the storage tier of the move destination of the page (move destination tier) (S11010). This intends to perform the page move for the page in which the data used by the job being executed exists, to a high storage tier, and to make efficient use of the high storage tier with a high performance, in consideration of the performance requirement of the job being executed. Specifically, the host computer 200 obtains entries (user configuration information entries) matching the job name and the data set name of the entry in the control target page management table 2115, from the user configuration information management table 2110. Next, the host computer 200 refers to the job ID 211101 and the execution state 211102 of the job information management table 2111, and identifies an entry in which the job indicated by the job name in the job name 211001 is being executed, from the user configuration information entries. The host computer 200 further identifies the tier satisfying the performance requirement, based on values of the performance requirement class 211003 and the performance requirement 211004 of the identified user configuration information entries. Then, the host computer 200 identifies the highest tier from the tiers satisfying the performance requirements of one or more jobs accessing the same page, and chooses the identified tier as the move destination tier for this page.

In the present embodiment, the host computer 200 selects the move destination tier for each control target page, based on the performance requirement of the job accessing the page. Thus, the number of pages that regard one tier as the move destination tier may exceed the number of pages that can be assigned from this tier. Specifically, a lockable page capacity of the move destination tier may be insufficient relative to a total page size of the pages corresponding to the move destination tier. Here, the lockable page capacity is a capacity of a storage area that can be assigned to the control target page. In such a case, the host computer 200 executes processes in step S11020 and subsequent steps, which will be shown below, and selects the page that moves to this tier, based on the priority level of the job accessing the page.

In other words, the host computer 200 determines whether or not there is a tier in which an amount of increase in the locked page capacity due to the page move exceeds the lockable page capacity, that is, whether or not there is a tier with an insufficient lockable page capacity (S11020). Specifically, the host computer 200 identifies, for each storage tier, the number of pages for which the page assignment is newly performed from the tier, and the number of pages for which the page assignment is released from the tier, due to the page move. Next, the host computer 200 identifies the amount of increase in the locked page capacity due to the page move, from a difference between these numbers of pages. Moreover, the host computer 200 identifies a remaining lockable page capacity, from a difference between the overall capacity and the locked page capacity of the corresponding tier in the tier usage status management table 2114. Then, the host computer 200 compares the identified amount of increase in the locked page capacity with the remaining lockable page capacity, and determines whether or not there is the tier with the insufficient lockable page capacity.

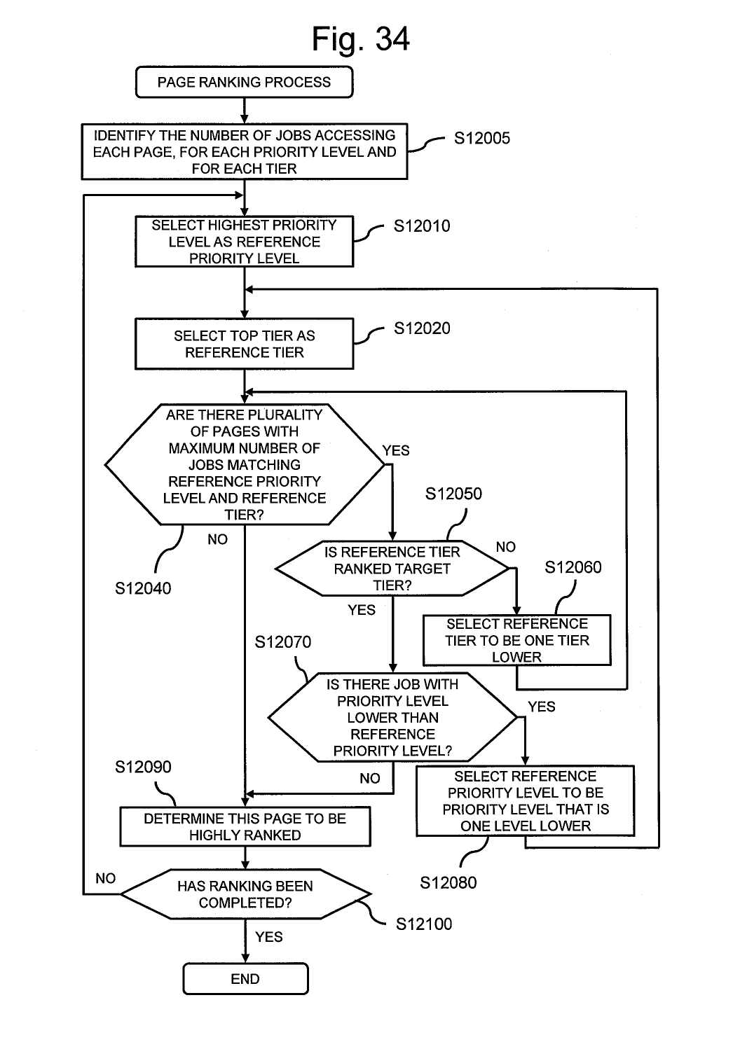

As a result, if there is the tier with the insufficient lockable page capacity (Yes in S11020), the host computer 200 executes a page ranking process (see FIG. 34) for ranking the pages that regard the tier as the move destination tier, for the tier with the insufficient lockable page capacity identified in step S11020 (S11040), and advances the process to step S11050. In contrast, if there is no tier with the insufficient lockable page capacity (No in S11020), the host computer 200 determines that each page can be moved to the selected move destination tier, and advances the process to step S11900.

In step S11050, the host computer 200 identifies the highest ranked page and the lowest ranked page from a plurality of pages ranked by the page ranking process. Next, the host computer 200 determines whether or not there is a tier that is one tier higher than the tier with the insufficient lockable page capacity identified in step S11020 (S11052).

As a result, if there is the tier that is one tier higher than the tier with the insufficient lockable page capacity (Yes in S11052), the host computer 200 selects this tier that is one tier higher, as a candidate for a new move destination tier for the highest ranked page identified in step S11050 (S11055), and advances the process to step S11070. Here, the tier selected as the candidate for the new move destination tier for the highest ranked page is referred to as “ranked target tier.”

In contrast, if there is no tier that is one tier higher than the tier with the insufficient lockable page capacity (No in S11052), in order to decrease the number of pages that move to the tier with the insufficient lockable page capacity, the host computer 200 selects the move destination tier for the lowest ranked page identified in step S11050, to be the tier that is one tier lower (S11130), and advances the process to step S11020.

In step S11070, the host computer 200 determines whether or not there is the lockable page capacity in the ranked target tier. Specifically, the host computer 200 refers to an entry corresponding to the ranked target tier, in the tier usage status management table 2114, and determines whether or not a new lockable page capacity exists in this ranked target tier, based on the overall capacity and the locked page capacity.

As a result, if there is the lockable page capacity (Yes in S11070), the host computer 200 selects the move destination tier for the highest ranked page identified in step S11050, to be the ranked target tier (S11120), and advances the process to step S11020. In contrast, if there is no lockable page capacity (No in S11070), the host computer 200 executes the page ranking process for ranking pages including pages that regard the ranked target tier as the move destination tier for the pages, and the highest ranked page identified in step S11050 (S11080), and advances the process to step S11090.

In step S11090, the host computer 200 determines whether or not there is a page that is ranked lower than the highest ranked page identified in step S11050, in the ranked target tier. Specifically, the host computer 200 determines whether or not the lowest ranked page in the ranked target tier identified in step S11080 is the highest ranked page identified in step S11050. If the lowest ranked page in the ranked target tier is not the highest ranked page identified in step S11050, the host computer 200 judges that there is a page that is ranked lower than the highest ranked page identified in step S11050, in the ranked target tier (Yes in S11090). At this time, the host computer 200 performs interchange between the page move destination tiers for the lowest ranked page in the ranked target tier and for the highest ranked page identified in step S11050 (S11110), and advances the process to step S11020.

In contrast, if the lowest ranked page in the ranked target tier is the highest ranked page identified in step S11050, the host computer 200 judges that there is no page that is ranked lower than the highest ranked page identified in step S11050, in the ranked target tier (No in S11090). At this time, in order to determine whether or not there is the lockable page capacity or the page with the lower rank, for a further higher storage tier, the host computer 200 determines whether or not there is a tier higher than the ranked target tier (S11060).

As a result, if there is the tier higher than the ranked target tier (Yes in S11060), the host computer 200 selects the ranked target tier to be one tier higher (S11065), and advances the process to step S11070. In contrast, if there is no tier higher than the ranked target tier (No in S11060), in order to decrease the number of pages that move to the tier with the insufficient lockable page capacity, the host computer 200 selects the move destination tier for the lowest ranked page identified in step S11050, to be the tier that is one tier lower (S11130), and advances the process to step S11020.

In step S11900, in order to move the page to the selected move destination tier, the host computer 200 creates the IO request 600 for the instruction for the storage tier control based on the IO request. Here, in the processes in steps S11010 to S11130, the host computer 200 selects the page move destination tier for each page. Thus, if a page including a plurality of data sets is moved, according to the storage tier control instruction for each page, the number of the IO requests 600 created by the host computer 200 can be reduced relative to instructions for individual data sets. Furthermore, for a plurality of pages with the same page move destination tier and continuous page IDs, the host computer 200 specifies the pages in the IO request 600 with a range of the continuous page IDs, instead of individually creating the IO requests 600, and thereby reduces the number of the IO requests 600 to be created. For example, a case of performing the page move of all Page 1, Page 2, Page 3, and Page 4 to the highest tier (high performance tier) is considered. Here, if the pages are individually specified, the host computer 200 creates four IO requests 600. In contrast, the host computer 200 may only need to create just one IO request 600 by specifying the pages as the range such as Pages 1 through 4. Next, the host computer 200 transmits the created IO request 600 to the storage apparatus 300.

Such a storage tier control process based on the priority level of the job can move the page to the tier satisfying the performance requirement specified by the user. Moreover, even if not all the pages can be moved to the tiers satisfying the performance requirements specified by the user due to the insufficient capacity of the move destination tiers, the move destination tiers for the pages are determined based on the priority levels of the jobs. Thereby, the page accessed by the job with high priority level can be preferentially moved to the tier satisfying the performance requirement specified by the user.

The page ranking process corresponding to step S11040 and step S11080 of the hierarchical storage control process based on the priority level of the job (FIG. 29) will be described next.

A summary of the page ranking process will be described first.

Here, the rank of the page is a reference value for judging which page is preferentially moved to the tier with the insufficient lockable page capacity if such a tier exists.

In the page ranking process, if a job accessing a page (in other words, a job whose data is stored in the page) corresponds to a higher priority level, the host computer 200 determines this page as a highly ranked page so that the job with the higher priority level can preferentially satisfy the performance requirement specified by the user. Specifically, first, the host computer 200 identifies high priority level jobs accessing the page, and classifies the identified jobs for each tier satisfying the performance requirement specified by the user. Next, the host computer 200 compares the numbers of the classified jobs in order from the highest tier to the ranked target tier, and determines a page with a larger number of jobs in a high tier, as the highly ranked page. Here, the comparison of the numbers of the jobs in the tiers equal to or higher than the ranked target tier intends to rank the pages according to at least the number of jobs requiring the performance indicated by the ranked target tier. The job requiring the performance indicated by the ranked target tier specifically refers to a job that cannot satisfy the performance requirement specified by the user, in the tier lower than the ranked target tier. It should be noted that, the host computer 200 judges a job, which can satisfy the performance requirement specified by the user even if the page moves to the tier lower than the ranked target tier, as a job that does not require the performance indicated by the ranked target tier, and does not consider this job in ranking the pages, that is, does not regard this job as a target for ranking the pages. Thus, a high performance of the high tier can be effectively utilized by considering only the jobs requiring the performance indicated by the ranked target tier, in ranking the pages. Moreover, in a case of the comparison of the numbers of jobs in the respective tiers, there may be a plurality of pages with the same number of jobs in all the tiers. In this case, the host computer 200 judges that these pages cannot be ranked by comparison of the numbers of the high priority level jobs, decreases the priority level of the jobs to be counted, by one level, and compares the numbers of jobs in the respective tiers again. This intends to initially compare the numbers of jobs, for the high priority level jobs, and thereby highly rank the pages accessed by the high priority level jobs. It should be noted that the host computer 200 repeats a process for decreasing the priority level of the jobs by one level and comparing the numbers of jobs, until all the pages are completely ranked.

It will be described how the ranks of the pages are determined and how the pages are moved according to this page ranking process, with specific examples.

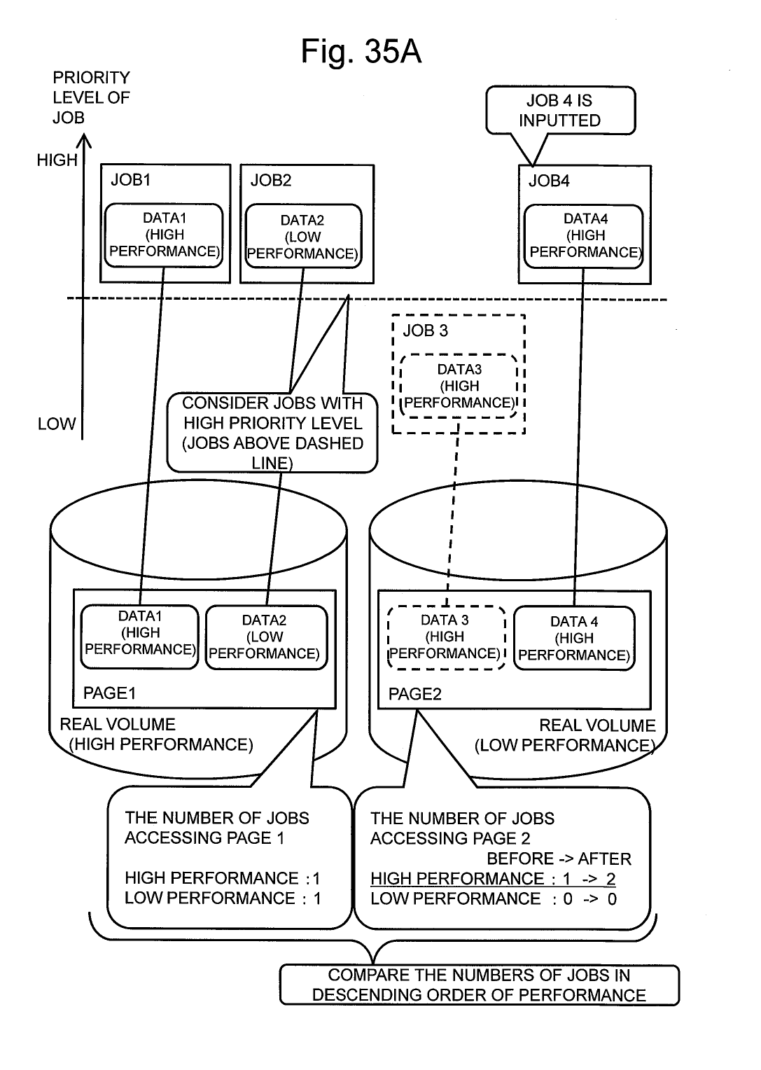

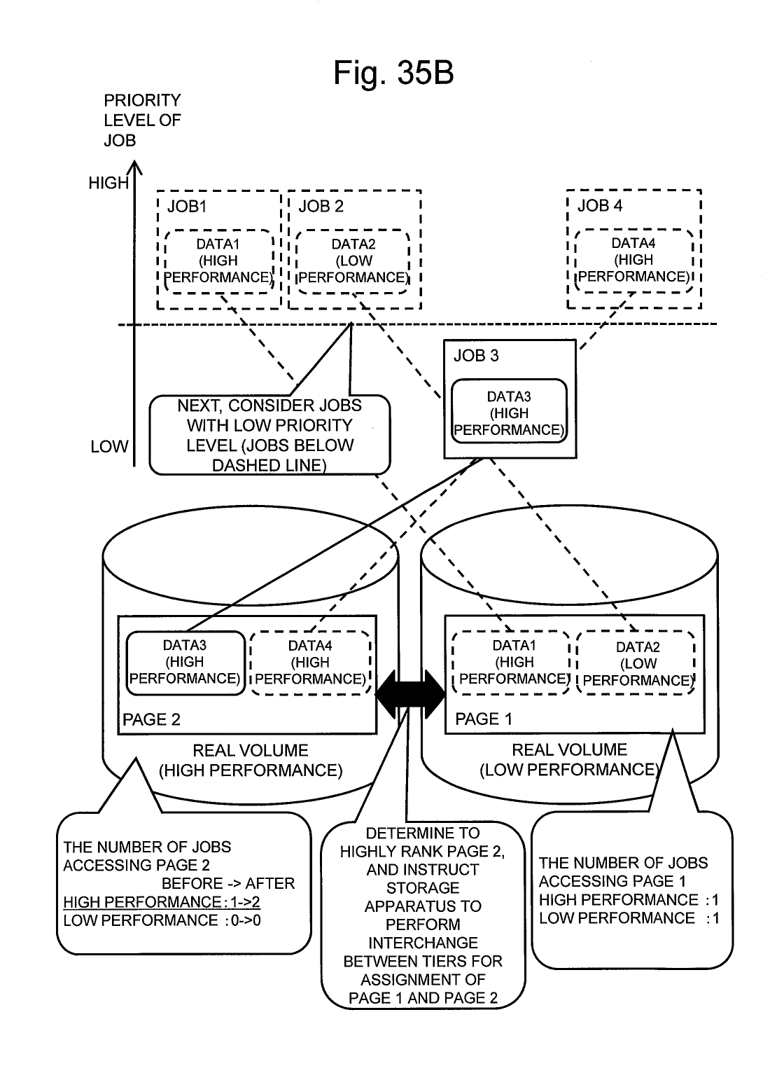

FIG. 35A is a first diagram describing the page ranking process according to the first embodiment. FIG. 35B is a second diagram describing the page ranking process according to the first embodiment.

FIG. 35A shows a situation of the page ranking process when Job 4 is submitted in the case where three jobs (Job 1, Job 2, and Job 3) are being executed, specifically, shows a situation where the numbers of jobs accessing the pages are compared for the high priority level jobs. Moreover, FIG. 35B shows a situation where the pages are moved based on a result of the page ranking process. Specifically, FIG. 35B shows a situation where the ranks of the pages are determined by comparison of the numbers of low priority level jobs, since the ranks of the pages cannot be determined by the comparison of the numbers of jobs, for the high priority level jobs, as shown in FIG. 35A. Moreover, FIG. 35B also shows a situation where the page move is performed based on the ranks of the pages. It is assumed herein that Data 1 and Data 2 exist in Page 1; Data 3 and Data 4 exist in Page 2; and a page-assignable area exists for only one page in each of a high performance real volume and a low performance real volume. It should be noted that, in FIGS. 35A and 35B, for explanatory purposes, it is assumed that there are two types of the priority levels of the jobs, that is, the high priority level and the low priority level, and that there are two types of tiers with the high performance and with the low performance.

As shown in FIG. 35A, it is assumed that Job 1, Job 2, and Job 3 are being executed, Page 1 has been assigned to the high performance real volume, and Page 2 has been assigned to the low performance real volume. Here, if Job 4 is submitted, the host computer 200 identifies a page (Page 2) that stores data accessed by Job 4. Next, the host computer 200 determines whether or not identified Page 2 needs to be page-moved to a real volume higher than the real volume (the low performance real volume) to which Page 2 is currently assigned. Specifically, the host computer 200 identifies the highest performance requirement from performance requirements of the data existing in the page, and determines whether or not the real volume for the currently assigned can satisfy this performance requirement. For example, in FIG. 35A, since the performance requirement of Data 4 accessed by Job 4 is “high performance,” the host computer 200 determines that Page 2 needs to be moved from the low performance real volume to the high performance real volume.

Next, the host computer 200 checks whether or not the area of the move destination tier can be newly assigned to the page, and if the assignment is not possible, the host computer 200 ranks the pages to identify a page to be moved from the move destination tier to another tier. For example, in FIG. 35A, while Page 2 is attempted to be moved to the high performance real volume due to the submit of Job 4, the area of the high performance real volume has been assigned to Page 1, and the area of this real volume cannot be newly assigned to the page. Thus, Page 1 and Page 2 are ranked to determine which page is moved to another real volume (in FIG. 35A, only the low performance real volume).

First, the host computer 200 compares the numbers of jobs accessing the pages, for the high priority level jobs. For example, in FIG. 35A, two high priority level jobs access Page 1, and one high priority level job accesses Page 2. Here, as described above, the page ranking process compares the numbers of jobs in descending order of the performance requirement specified to each job. For example, in FIG. 35A, the jobs with the high priority level and the high performance as the performance requirement, in the jobs accessing the pages, are Job 1 in Page 1 and Job 4 in Page 2, and the numbers of jobs are the same. Thus, the host computer 200 compares the numbers of jobs with the performance requirement that is one level lower, and ranks the pages to determine the page to be moved from the high performance real volume to the low performance real volume. At this time, a job (Job 2) that can satisfy the performance requirement even if being moved to the low performance real volume is not considered. As a result, even if the numbers of jobs with the high priority level are compared, Page 1 and Page 2 cannot be ranked. Thus, as shown in FIG. 35B, the numbers of jobs with the low priority level are compared.

Next, the host computer 200 compares the numbers of jobs, for the low priority level jobs, in descending order of the performance requirement specified to each job, similarly to the above description. In FIG. 35B, the low priority level job does not access Page 1, and Job 3 with the low priority level accesses Page 2. Here, since Job 3 accessing Page 2 includes the high performance as the performance requirement, the host computer 200 determines to rank Page 2 higher than Page 1. Then, the host computer 200 moves highly ranked Page 2 to the high performance real volume, and moves lowly ranked Page 1 to the low performance real volume, based on the ranks of the pages.

Thus, in the page ranking process, a page accessed by a larger number of high priority level jobs is determined as the highly ranked page. Moreover, for the jobs with the same priority level, a page accessed by a job to which a higher performance requirement is specified is determined as the highly ranked page.

FIG. 34 is a flowchart of the page ranking process according to the first embodiment.

First, for each page, the host computer 200 classifies the jobs accessing the page, for each priority level of the identified jobs and for each tier satisfying the performance requirement specified by the user (S12005). Specifically, the host computer 200 obtains entries matching the job name in the job name 211505 of the control target page management table 2115, from the job information management table 2111. Next, the host computer 200 identifies an entry with the job's execution state 211102 indicating “being executed” from the obtained entries, and thereby identifies the job accessing the page. Then, the host computer 200 refers to an entry of a corresponding job in the user configuration information management table 2110, obtains the performance requirement class and the performance requirement that are specified to this job by the user, and identifies the tier satisfying the performance requirement specified to this job by the user, based on such information. For example, if the performance requirement class 211003 indicates “tier,” the host computer 200 identifies the tier indicated by the performance requirement 211004, as the tier satisfying the performance requirement of this job. Moreover, if the performance requirement class 211003 indicates “response time,” the host computer 200 compares the requirement of the response time indicated by the performance requirement 211004, with the characteristic information (performance information) on each tier, and identifies the lowest tier that can complete the data access process within the requirement of the response time, as the tier satisfying the performance requirement of this job. Then, the host computer 200 classifies this job by the priority level and the identified tier, and identifies the number of jobs for each priority level and for each tier.

Next, the host computer 200 identifies the highest priority level from the priority levels of the jobs accessing the pages, and selects the highest priority level as a reference priority level for the comparison of the numbers of jobs (hereinafter, referred to as “reference priority level” in the description of the process in the same drawing) (S12010).

Next, the host computer 200 identifies the highest tier from the tiers satisfying the performance requirements of the jobs accessing the pages, and selects the highest tier as a reference tier for the comparison of the numbers of jobs (hereinafter, referred to as “reference tier” in the description of the process in the same drawing) (S12020).

Next, the host computer 200 compares the numbers of jobs matching the reference priority level and the reference tier, in the jobs accessing the pages, which have been identified in the process in step S12005, identifies a page with the maximum number of jobs, and determines whether or not there are a plurality of identified pages (S12040). If there are the plurality of pages (Yes in S12040), the host computer 200 advances the process to step S12050 to change a condition and compare the numbers of jobs for these pages, while if there are not the plurality of pages (No in S12040), the host computer 200 determines this page as the highest ranked page in pages that have not been ranked (S12090), and advances the process to step S12100.

In step S12050, the host computer 200 determines whether or not the reference tier is the ranked target tier. If the reference tier is the ranked target tier (Yes in S12050), the host computer 200 judges that the comparison of the numbers of jobs is completed for the jobs requiring the performance indicated by the ranked target tier, and advances the process to step S12070, while if the reference tier is not the ranked target tier (No in S12050), the host computer 200 selects the reference tier to be one tier lower (S12060), and advances the process to step S12040.

In step S12070, the host computer 200 identifies the lowest priority level from the priority levels of the jobs identified in S12005, and compares the identified priority level with the reference priority level. If the identified priority level is lower than the reference priority level (Yes in S12070), the host computer 200 selects the reference priority level to be the priority level that is one level lower (S12080), and advances the process to step S12020, while if the identified priority level is equal to or larger than the reference priority level (No in S12070), the host computer 200 judges that the ranking among these pages cannot be determined by the numbers of jobs classified by the priority level and the tier, and determines these pages to be in the same rank (S12090). It should be noted that even if the host computer 200 judges that the ranking among these pages cannot be determined by the priority levels of the jobs and the performance requirements specified by the user, the pages may be ranked according to indirect information regarding execution performances of the jobs (remaining execution times of the jobs, which are calculated from job end times specified in the OS 2101 by the user and a current time, and job execution speeds specified in the OS 2101 by the user).

Next, the host computer 200 determines whether or not the ranking has been completed for all the pages to be ranked (S12100). If the ranking is not completed (No in S12100), the host computer 200 advances the process to step S12010, while if the ranking has been completed (Yes in S12100), the host computer 200 ends the page ranking process.

As described above, in the page ranking process, if there are a larger number of high priority level jobs in jobs accessing a page, this page is determined to be highly ranked. Moreover, if there are the jobs with the same priority level, as the jobs accessing the pages, a page with a larger number of jobs to which a high performance requirement is specified is determined to be highly ranked. Thereby, the page accessed by the larger number of the high priority level jobs can be preferentially moved to the tier satisfying the performance requirements of the jobs.

The operations of the management computer 100 will be described next.

The management computer 100 performs processes in the two phases of the preparation phase and the operation phase, similarly to the host computer 200. Basically, in a case of issuing an instruction to the storage apparatus 300, the management computer 100 issues the instruction to various programs expanded in the memory 210 of the host computer 200. In contrast, the host computer 200 executes the above various processes based on this instruction, thereby creates the IO request 600 including the storage tier control instruction or the like, and transmits the IO request 600 to the storage apparatus 300. Moreover, if the host computer 200 senses the change in the state of the OS 2101 or the application, the host computer 200 notifies the management computer 100 of the sensed content via the communication network 550. The management computer 100, which has been notified of the sensed content by the host computer 200, issues an instruction to the host computer 200 or the storage apparatus 300 according to the sensed content, to control the apparatus. It should be noted that while the management computer 100 basically issues the storage tier control instruction to the storage apparatus 300 via the host computer 200, the management computer 100 may issue the storage tier control instruction directly to the storage apparatus 300.

Various programs and tables, which include roles similar to various programs and tables stored in the memory 210 of the host computer 200, are stored in the memory 110 of the management computer 100, as described above. While the programs and tables stored in the memory 210 of the host computer 200 have been referred to as “aaa program” and “aaa management table,” respectively, the programs and tables that include the roles similar to these various programs and tables and are stored in the memory 110 of the right computer 100 are referred to as “centralized aaa program” and “aaa-centralized management table,” respectively.

The operations of the management computer 100 in the preparation phase will be described first.

The management computer 100 detects the host computer 200 existing on the computer system 10, based on the centralized page control program 1103. The IP address of the host computer 200 inputted via the input/output part 150 by the user of the management computer 100, for example, can be used as information for detecting the host computer 200. As the IP address input method, for example, a range of the IP address, such as 192.168.1.1 to 192.168.1.50, may be inputted, or a specific IP address may be inputted.

Next, the management computer 100 creates an information obtaining request for the host computer 200, and transmits this information obtaining request for the inputted IP address via the communication network 550. The host computer 200 receives the information obtaining request, and returns information regarding the host computer 200 corresponding to this information obtaining request, to the management computer 100. The management computer 100 creates the host computer management table 1110 for the host computer 200 that has provided the return, based on the returned information. Next, the management computer 100 performs a process similar to the preparation process (FIG. 31) in the preparation phase in the host computer 200, and creates the various tables to be stored in the memory 110. It should be noted that the management computer 100 obtains various pieces of information from a plurality of the host computers 200 that have provided the return. For example, in step S10020, the management computer 100 obtains configuration information in the plurality of host computers 200 that have provided the return.

The operations of the management computer 100 in the operation phase will be described next.

In the operation phase, the host computer 200 senses the change in the state of the job to be executed, and notifies the management computer 100 of its content via the network 550. The management computer 100, which has received the notification, performs a process similar to the hierarchical storage control process based on the priority level of the job (FIG. 33) in the operation phase in the host computer 200, based on the centralized page control program 1103.

Here, if the storage tier control instruction is issued via the host computer 200, the management computer 100 transmits the page move destination tier to the host computer 200 via the network 550 in step S11900. In this case, the host computer 200 transmits the IO request 600 including the storage tier control instruction to the storage apparatus 300.

In contrast, if the storage tier control instruction is issued directly to the storage apparatus 300, the management computer 100 performs a process similar to the host computer 200 to transmit the IO request 600 to the storage apparatus 300 in step S11900.

It should be noted that the management computer 100 may determine the page move destination tier in consideration of the jobs among the plurality of host computers 200. Specifically, in step S11010, the management computer 100 refers to the storage ID instead of the host name when identifying the control target page from the control target page-centralized management table 1116. Thereby, the management computer 100 can perform the storage tier control in consideration of the pages of the plurality of host computers 200 using the same storage apparatus 300.

### (1-4-2) Example in the Case where Single Application is Assumed to Access Plurality of Pieces of Data

### Example A2

In Example A2, the operations of each apparatus in the case where a single application is assumed to access a plurality of pieces of data will be described. Here, in Example A2, a case is assumed where a single job (a job that executes the application) accesses a plurality of data sets. The job that accesses the data sets, however, is assumed to be single, and each time the job is executed, the job may access a plurality of data sets different from those at a previous execution time.

The processes in the storage apparatus 300 in Example A2 are similar to the processes in the storage apparatus 300 in Example A1 (FIGS. 26, 27, and 28). Thus, detailed descriptions of the processes in the storage apparatus 300 in Example A2 will be omitted.

The processes performed in the two phases of the preparation phase and the operation phase by the host computer 200 will be described next.

First, the host computer 200 performs a process similar to the preparation process (FIG. 31) in the preparation phase of Example A1 to create the tables that are stored in the memory 210 and that are required for the storage tier control.

The processes in the operation phase in the host computer 200 will be described next.

The host computer 200 is triggered to execute the storage tier control process when the job has changed the data to be accessed, in addition to when the execution state of the job changes, which is a trigger in Example A1. This is because, in Example A2, the job may change the data to be accessed during execution, and then the job accessing the page may be changed.

When the execution state of the job changes, or if it is sensed that the job has changed the data to be accessed, the host computer 200 performs processes similar to the processes in the host computer 200 in Example A1 (the processes based on the job control information obtaining program 2104 and the page assignment state monitoring program 2106, in the host computer 200), and thereby updates the information in the various tables stored in the memory 210. Furthermore, the host computer 200 obtains information indicating which data is accessed by the job, from the OS 2101, and updates the data set name 211104 in the job control information management table 2111, based on the job control information obtaining program 2104.

Next, the host computer 200 performs a process similar to the storage tier control process (FIG. 33) in the host computer 200 in Example A1 to determine the move destination tier for the control target page. In the process for identifying the number of jobs accessing the page (S12005 of FIG. 34), if a plurality of pieces of data accessed by one job exist in the same page, the host computer 200 in Example A2, however, does not repeatedly count this job. This is because the number of jobs affected by the page move (for example, jobs with the input/output performance that is reduced by the page move to a low tier) is regarded as a criterion for evaluation for ranking the pages. Specifically, in step S12005, the host computer 200 in Example A2 determines whether or not there are duplicated job names accessing the page, after identifying the number of jobs accessing the page. If there are duplicated jobs, the host computer 200 performs a process for subtracting the number of duplicated jobs from the identified number of jobs. Then, a page with a large number of the jobs affected by the page move destination tier is determined as the highly ranked page.

Then, in order to move the control target page to the determined page move destination tier, the host computer 200 performs a process similar to the process in the host computer 200 in Example A1 (step S11900 of FIG. 33) to create the IO request 600 and transmit this IO request 600 to the storage apparatus 300.

Moreover, the management computer 100 executes the storage tier control by performing processes similar to the processes in the management computer 100 in Example A1, and the processes in the host computer 200 in Example A2. Detailed descriptions of the processes by the management computer 100 will be omitted herein.

### (1-4-3) Example in the Case where Plurality of Applications are Assumed to Access Single Piece of Data

### Example A3

In Example A3, the operations of each apparatus in the case where a plurality of applications are assumed to access a single piece of data will be described. Here, in Example A3, a case is assumed where a plurality of jobs access a single data set. Each time the jobs are executed, the jobs, however, may access a plurality of data sets different from those at the previous execution time.

The processes in the storage apparatus 300 in Example A3 are similar to the processes in the storage apparatus 300 in Example A1 (FIGS. 26, 27, and 28). Thus, the detailed descriptions of the processes in the storage apparatus 300 will be omitted.

The processes performed in the two phases of the preparation phase and the operation phase by the host computer 200 will be described next.

First, the host computer 200 performs a process similar to the preparation process (FIG. 31) in the preparation phase in Example A1, to create the tables that are stored in the memory 210 and that are required for the storage tier control.

The processes in the operation phase in the host computer 200 will be described next.

The host computer 200 is triggered to execute the storage tier control process when the execution state of the job changes, or when the job has changed the data to be accessed, similarly to Example A2.

If it is sensed that the execution state of the job has changed or that the job has changed the data to be accessed, the host computer 200 performs the processes similar to the processes in the host computer 200 in Example A1 (the processes based on the job control information obtaining program 2104 and the page assignment state monitoring program 2106, in the host computer 200), and thereby updates the information in the various tables stored in the memory 210.

Next, the host computer 200 performs the process similar to the storage tier control process (FIG. 33) in the host computer 200 in Example A1 to determine the move destination tier for the control target page. The host computer 200 in Example A3, however, considers waiting for the end of the data access process among the jobs accessing the same data, in the processes for identifying the tier satisfying the performance requirement specified by the user (S11010 of FIG. 33 and S12005 of FIG. 34). Here, while one of the jobs is executing the data access process, if another job accesses this data, another job is put into a waiting state until the data access process by the one job ends. The response time for the data access process is extended by a time in this waiting state for another job. Accordingly, the tier that can satisfy the performance requirement specified by the user is enabled to be identified even if the response time is extended. Specifically, in steps S11010 and S12005, the host computer 200 identifies the tier satisfying the performance requirement, in consideration of the response time extended by waiting for the end of the data access process among the jobs, after identifying the performance requirement of the job. For example, if the performance requirement of the job is “response time,” the host computer 200 calculates a sum of the response time indicated by the performance requirement and the time of the extension, and identifies the tier for the sum of the times for the response. Specifically, for example, the storage device sequentially processes the IO requests. Accordingly, if n jobs access the same storage device, a time by which a certain job is extended is calculated by (n−1)×(a time for processing an IO request by the storage device). In this example, the storage device is replaced with “hierarchical storage (for example, an apparatus including a plurality of storage devices like a storage apparatus 300A)” to calculate the time of the extension. Since the hierarchical storage includes the plurality of storage devices, an actual time of the extension is considered to be a time shorter than that calculated by the above calculation formula. The time of the extension, however, is calculated by the above calculation formula (where the storage device is replaced with the hierarchical storage) in order to ensure the input/output performance.

Then, in order to move the control target page to the determined page move destination tier, the host computer 200 performs the process similar to the process in the host computer 200 in Example A1 (step S11900 of FIG. 33) to create the IO request 600 and transmit this IO request 600 to the storage apparatus 300.

Moreover, the management computer 100 executes the storage tier control by performing the processes similar to the processes in the management computer 100 in Example A1, and the processes in the host computer 200 in Example A3. Detailed descriptions of the processes by the management computer 100 will be omitted herein.

### (1-5) Advantageous Effects of First Embodiment

As described above, according to the first embodiment, the host computer 200 executes the storage tier control for the page, in consideration of the page, which is a unit of the storage tier control in the storage apparatus 300, the data existing in the page, and the application using the data. Thereby, the host computer 200 can appropriately prevent the assignment of the data used by the application with the high importance level, to the storage tier indicating the low input/output performance, in the case where the plurality of pieces of data used by the applications with the different importance levels exist in the page.

Moreover, since the host computer 200 recognizes a status of the data assignment to the storage tiers, if one host computer 200 uses the plurality of storage apparatuses 300, the storage tier control instruction can be issued in consideration of the status of the data assignment to the storage tiers in each storage apparatus 300.

Moreover, the storage tier control instruction for the page including the plurality of data sets is issued for each page, and the storage tier control instruction for the plurality of pages with the continuous page IDs and the same move destination tier is issued for each page range of the plurality of pages. Thereby, the number of the IO requests 600 created by the management computer 100 or the host computer 200 can be reduced. The number of the IO requests 600 to be created can be further reduced by storing a plurality of sets of the page range and the move destination tier, into one IO request 600.

Moreover, since the management computer 100 and the host computer 200 recognize the control target page in the logical volume, the storage tier control instruction can be issued for each logical volume. This is likely to cause a status where the pages ID are continuous in the pages specified by the host computer 200 for the storage apparatus 300 to move the tiers, and the number of the IO requests 600 may be highly likely to be reduced.

### (2) Second Embodiment

### (2-1) Summary of Second Embodiment

The computer system according to a second embodiment will be described next.

In the second embodiment, the storage apparatus 300A executes the hierarchical storage control process based on the priority level of the job (FIG. 33) in the first embodiment, instead of the host computer 200. Specifically, in the second embodiment, a management computer 100A or a host computer 200A transmits the information regarding the application, the data accessed by the application, and the performance requirement of the data, to the storage apparatus 300A. Next, the storage apparatus 300A determines the page move destination tier, based on the priority level of the job from the received information. Then, the storage apparatus 300A executes the storage tier control process based on the determined the page move destination tier.

According to the present embodiment, since the storage apparatus 300A retains the information regarding the jobs accessing the logical volume in the pool, even if the jobs of a plurality of the host computers 200A use the logical volume in the same pool managed by the storage apparatus 300A, the storage tier control in consideration of the jobs among the host computers 200A is enabled.

### (2-2) Hardware Configuration of Computer System

The configuration of the computer system in the second embodiment is similar to the configuration of the computer system in the first embodiment (FIG. 1).

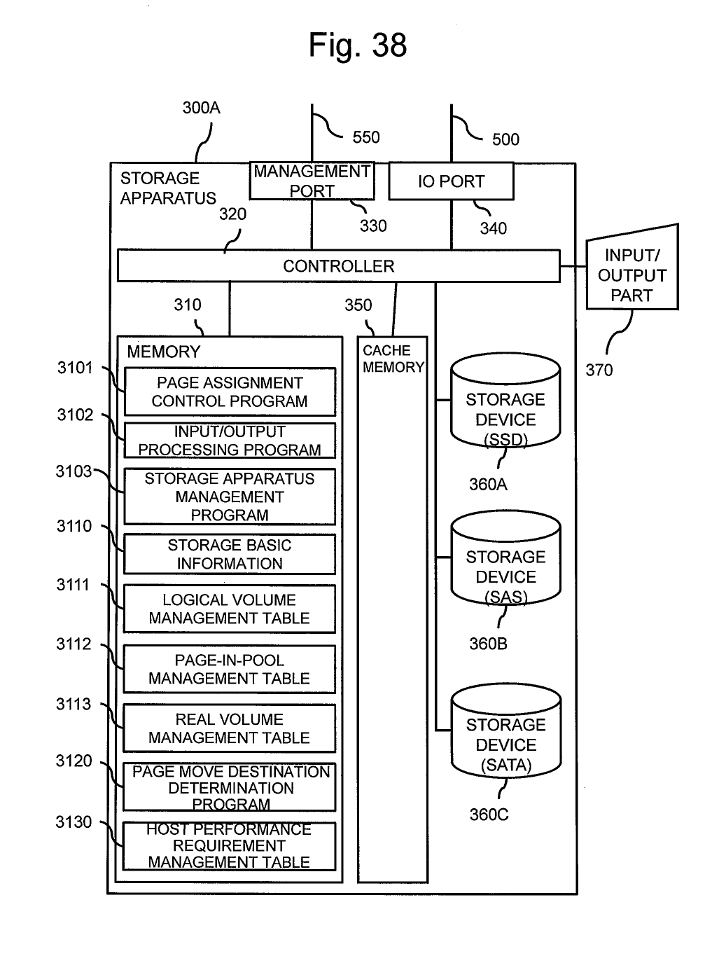

FIG. 38 is a configuration diagram of the storage apparatus according to the second embodiment.

The memory 310 of the storage apparatus 300A further stores a page move destination determination program 3120 and a host performance requirement management table 3130, in addition to the various programs and tables expanded into the memory 310 of the storage apparatus 300 (FIG. 4) in the first embodiment.

The page move destination determination program 3120 is a program for determining the page move destination tier based on the priority level of the job. The host performance requirement management table 3130 is a table that stores the information regarding the jobs of one or more host computers 200A, which is required for the storage apparatus 300A to perform the storage tier control process based on the priority level of the job.

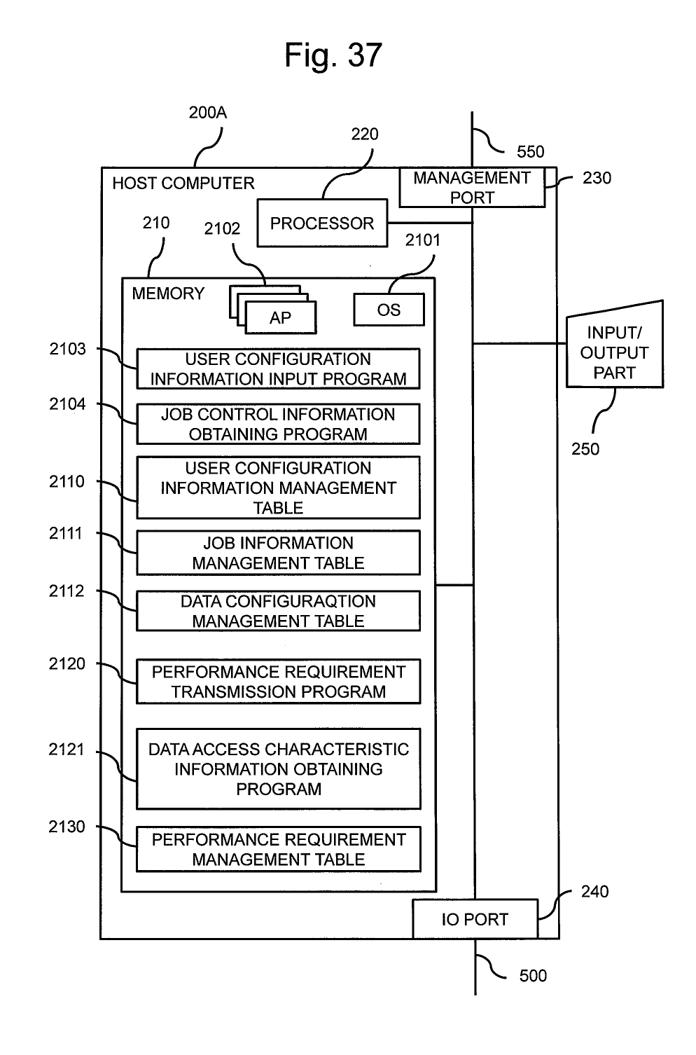

FIG. 37 is a configuration diagram of the host computer according to the second embodiment.

The memory 210 of the host computer 200A stores programs and tables, which are the various programs and tables expanded into the memory 210 of the host computer 200 (FIG. 3) in the first embodiment, except the page control program 2105, the page assignment state monitoring program 2106, the page configuration management table 2113, the tier usage status management table 2114 and the control target page management table 2115, and further stores a performance requirement transmission program 2120, a data access characteristic information obtaining program 2121, and a performance requirement management table 2130.

The performance requirement transmission program 2120 is a program for transmitting the information required for the storage tier control process based on the priority level of the job, to the storage apparatus 300A. The data access characteristic information obtaining program 2121 is a program for obtaining the data access characteristic information from the storage apparatus 300A. The performance requirement management table 2130 is a table that stores the information regarding the jobs of the host computer 200A, which is required for the storage apparatus 300A to perform the storage tier control process based on the priority level of the job.

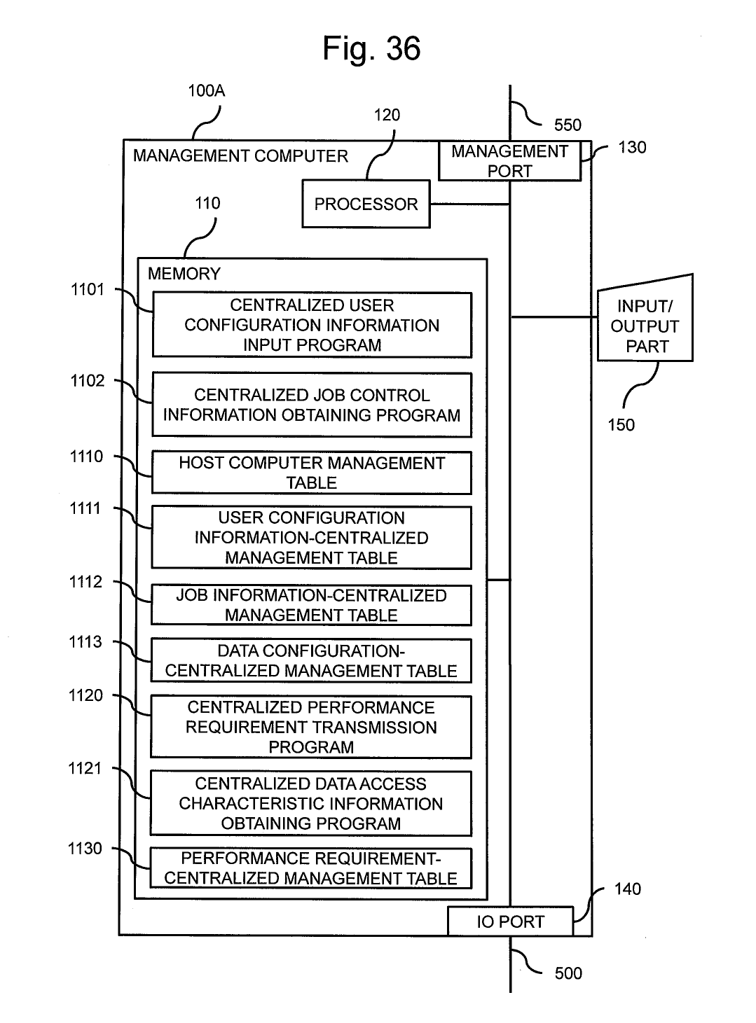

FIG. 36 is a configuration diagram of the management computer according to the second embodiment.

The memory 110 of the management computer 100A stores programs and tables, which are the various programs and tables expanded into the memory 110 of the management computer 100 (FIG. 2) in the first embodiment, except the centralized page control program 1103, the centralized page assignment state monitoring program 1104, the page configuration-centralized management table 1114, the tier usage status-centralized management table 1115, and the control target page-centralized management table 1116, and further stores a centralized performance requirement transmission program 1120, a centralized data access characteristic information obtaining program 1121, and a performance requirement-centralized management table 1130.

The centralized performance requirement transmission program 1120 is a program for transmitting the information required for the storage tier control process based on the priority level of the job, to the storage apparatus 300A. The centralized data access characteristic information obtaining program 1121 is a program for obtaining the data access characteristic information from the storage apparatus 300A. The performance requirement-centralized management table 1130 is a table that stores the information regarding the jobs of one or more host computers 200A, which is required for the storage apparatus 300A to perform the storage tier control process based on the priority level of the job.

### (2-3) Summary of Processes in Computer System

A summary of the processes in the computer system according to the second embodiment will be described next.

Here, in the following description, the processes will be described simply with the storage apparatus 300A as the subject, which indicates that the controller 320 of the storage apparatus 300A is executing these processes. Similarly, if the processes are described simply with the host computer 200A as the subject, it indicates that the processor 220 of the host computer 200A is executing the processes. If the processes are described with the management computer 100A as the subject, it indicates that the processor 120 of the management computer 100A is executing the processes.

Also in the second embodiment, similarly to the first embodiment, the storage apparatus 300A executes the storage tier control process based on the information in the IO request 600 transmitted by the host computer 200A. In the first embodiment, the host computer 200, however, specifies a move target page and the move destination tier and issues the storage tier control instruction to the storage apparatus 300. In contrast, in the second embodiment, the host computer 200A transmits information regarding the performance requirement specified by the user, to the storage apparatus 300A. The storage apparatus 300A determines the page move destination tier from the performance requirement transmitted from the host computer 200A, and executes the storage tier control. Specifically, the host computer 200A obtains the information required for the storage tier control process based on the priority level of the job, from the user's inputs via the OS 2101, the APs 2102, and the input/output part 250. The information to be obtained includes, for example, the job name, the name of the data set accessed by the job, the virtual address of the data set, the priority level of the job, the performance requirement of the job for the data access process, which is specified by the user, and the like.

Next, the host computer 200A converts the obtained information into a format used by the storage apparatus 300A to manage components in this storage apparatus 300A. For example, the host computer 200A converts information for identifying the data used by the job, from the data set name that is a management unit in the host computer 200A, into the virtual address that is a unit of the storage area of the logical volume in the storage apparatus 300A.

Then, the host computer 200A creates the IO request 600 for transmitting the information in the converted format, and transmits the IO request 600 to the storage apparatus 300A via the communication network 500.

The storage apparatus 300A, which has received this IO request 600, determines the page move destination tier based on the information transmitted from the host computer 200A, and performs the storage tier control.

Moreover, in order to display the data access characteristic information to the user via the input/output part 250, the host computer 200A creates the request 600 for obtaining the virtual address and the characteristic information on the storage area indicated by the virtual address, and transmits the IO request 600 to the storage apparatus 300A via the communication network 500. The storage apparatus 300A, which has received this IO request 600, returns the characteristic information on the virtual address to the host computer 200A via the communication network 500.

The host computer 200A displays information regarding characteristics of corresponding data, to the user through the input/output part 250, based on the characteristic information on the virtual address returned from the storage apparatus 300A.

It should be noted that, also in the second embodiment, similarly to the first embodiment, the user can manage the plurality of host computers 200A and a plurality of the storage apparatuses 300A in a centralized manner from the management computer 100A, if necessary. Thereby, similarly to the management computer 100 in the first embodiment, if the plurality of host computers 200 exist, the input/output parts operated by the user can be aggregated.

### (2-4) Content of Various Tables

FIG. 41 is a diagram showing an example of the host performance requirement management table according to the second embodiment.

The host performance requirement management table 3130 is the table that manages the information regarding the jobs of one or more host computers 200A, which is required for the storage apparatus 300A to perform the storage tier control based on the priority level of the job. Fields of a logical volume ID 313001, a virtual address 313002, a tier requirement 313003, a host name 313004, a job name 313005, and a priority level 313006 are included in each entry of the host performance requirement management table 3130. It should be noted that one entry corresponds to one data set.

An identifier (logical volume ID) for uniquely identifying a logical volume in which a storage area indicated by the virtual address 313002 exists is stored in the logical volume ID 313001. The address indicating the storage area of the logical volume with the performance requirement specified by the user is stored in the virtual address 313002. The storage tier satisfying the performance requirement specified by the user is stored in the tier requirement 313003. An identifier for uniquely identifying the host computer 200A in which the job with the corresponding job name is executed is stored in the host name 313004. An identifier (job name) for uniquely identifying the job specified by the user is stored in the job name 313005. The priority level of the job indicated by the corresponding job name is stored in the priority level 313006.

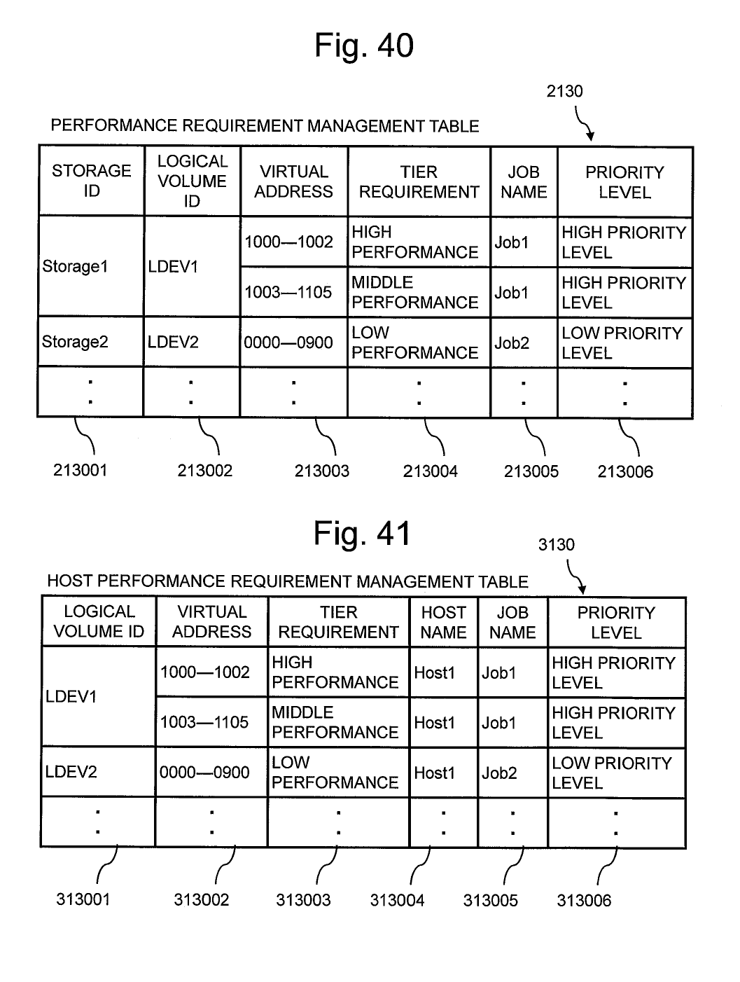

FIG. 40 is a diagram showing an example of the performance requirement management table according to the second embodiment.

The performance requirement management table 2130 is a table that manages information regarding the host computer 200A, which is required for the storage apparatus 300A to perform the storage tier control. Fields of a storage ID 213001, a logical volume ID 213002, a virtual address 213003, a tier requirement 213004, a job name 213005, and a priority level 213006 are included in each entry of the performance requirement management table 2130. It should be noted that one entry corresponds to one data set.

An identifier for uniquely identifying the storage apparatus 300A providing the logical volume indicated by the corresponding logical volume ID is stored in the storage ID 213001. The identifier (logical volume ID) for uniquely identifying the logical volume in which the storage area indicated by the corresponding virtual address exists is stored in the logical volume ID 213002. The address (virtual address) indicating the storage area of the logical volume with the performance requirement specified by the user is stored in the virtual address 213003. The storage tier satisfying the performance requirement specified by the user is stored in the tier requirement 213004. The identifier (job name) for uniquely identifying the job specified by the user is stored in the job name 213005. The priority level of the job indicated by the corresponding job name is stored in the priority level 213006.

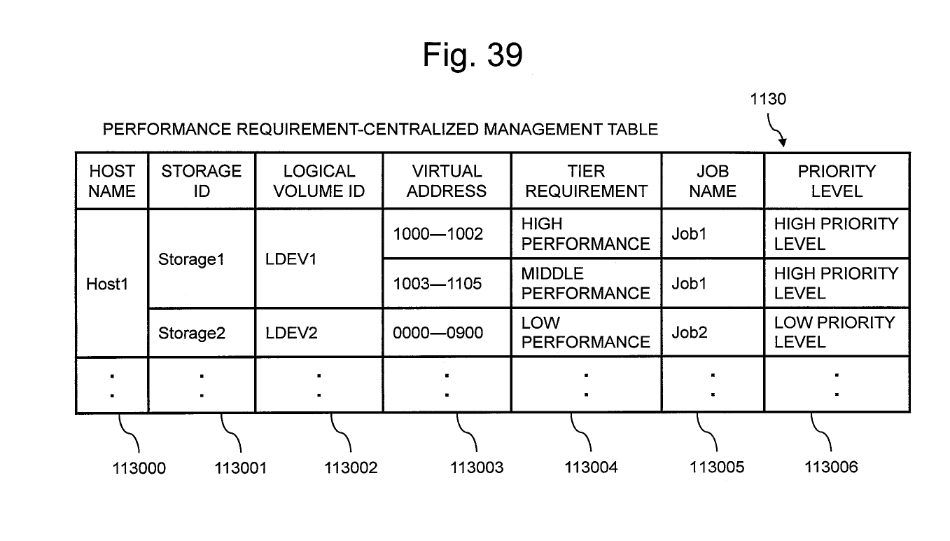

FIG. 39 is a diagram showing an example of the performance requirement-centralized management table according to the second embodiment.

The performance requirement-centralized management table 1130 is a table that manages information regarding one or more host computers 200A, which is required for the storage apparatus 300A to perform the storage tier control. Fields of a host name 113000, a storage ID 113001, a logical volume ID 113002, a virtual address 113003, a tier requirement 113004, a job name 113005, and a priority level 113006 are included in each entry of the performance requirement-centralized management table 1130. It should be noted that one entry corresponds to one data set.

The identifier (host name) for uniquely identifying the host computer 200A regarded as the management target by the management computer 100A is stored in the host name 113000. The identifier (storage ID) for uniquely identifying the storage apparatus 300A providing the logical volume indicated by the corresponding logical volume ID is stored in the storage ID 113001. The identifier (logical volume ID) for uniquely identifying the logical volume in which the storage area indicated by the corresponding virtual address exists is stored in the logical volume ID 113002. The address (virtual address) indicating the storage area of the logical volume with the performance requirement specified by the user is stored in the virtual address 113003. The storage tier satisfying the performance requirement specified by the user is stored in the tier requirement 113004. The identifier (job name) for uniquely identifying the job specified by the user is stored in the job name 113005. The priority level of the job indicated by the corresponding job name is stored in the priority level 113006.

### (2-5) Detailed Operations of Each Apparatus

### (2-5-1) Example in the Case where Application is Assumed to Always Access the Same Single Piece of Data

### Example B1

In Example B1, operations of each apparatus in a case of a one-to-one correspondence relationship between an application of the host computer 200A and data accessed by this application will be described. Here, in Example B1, the case of the one-to-one relationship between the job and the data set accessed by the job is assumed where the job is assumed to always access the same data set.

The processes of the storage apparatus 300A will be described first.

The storage apparatus 300A performs processes similar to the input/output process (FIG. 26) and the page assignment process (FIG. 27) in the storage apparatus 300 in the first embodiment.

Moreover, the storage apparatus 300A performs a process similar to the hierarchical storage control process (FIG. 28) in the storage apparatus 300 in the first embodiment.

The storage apparatus 300A further performs the storage tier control process by performing processes corresponding to the processes (FIGS. 29, 33, and 34) regarding the storage tier control process in the storage apparatus 300 and the host computer 200 in the first embodiment, based on the page move destination determination program 3120 and the page assignment control program 3101. In the second embodiment, the storage apparatus 300A executes the hierarchical storage control process based on the priority level of the job, which is executed by the host computer 200 in the first embodiment. In other words, in the processes shown in FIGS. 29, 33, and 34, the storage apparatus 300 performs the processes except the process for transmitting the IO request from the host computer 200 to the storage apparatus 300 and the process for returning the response to the IO request, from the storage apparatus 300 to the host computer. Specifically, the storage apparatus 300A determines the page move destination tier, with reference to the logical volume management table 3111, the page-in-pool management table 3112, the real volume management table 3113, and the host performance requirement management table 3130, based on the page move destination determination program 3120 (steps S11010 to S11130 of FIG. 33). It should be noted that the storage apparatus 300A identifies the control target page with reference to the host performance requirement management table 3130 (step S11010 of FIG. 33). Thus, the storage apparatus 300A can determine the page move destination tier in consideration of the jobs of the plurality of host computers 200A. Next, the storage apparatus 300A moves the page to the determined move destination tier and causes this page to be page-locked, based on the page assignment control program 3101 (a process that is the process of FIG. 29 except step S8232).

Processes performed in the two phases of the preparation phase and the operation phase by the host computer 200A will be described next.

The process in the preparation phase in the host computer 200A will be described first.

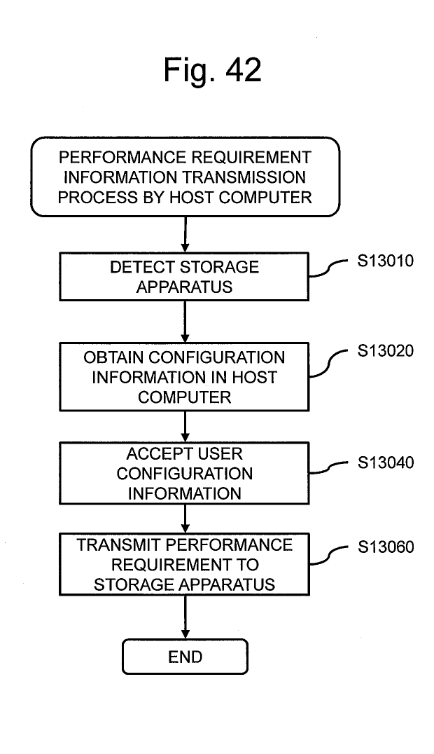

FIG. 42 is a flowchart of a transmission process in the preparation phase in the host computer according to the second embodiment.

The preparation process is realized by executing the process by the processor 220 of the host computer 200A based on the user configuration information input program 2103, the job control information obtaining program 2104, and the performance requirement transmission program 2120.

First, the host computer 200A performs a process similar to step S10010 of FIG. 31 to detect the storage apparatus 300A that is the management target in the storage tier control, based on the user configuration information input program 2103 (step S13010).

Next, the host computer 200A performs an operation similar to step S10020 of FIG. 31 to create the job information management table 2111 and the data configuration management table 2112, based on the job control information obtaining program 2104 (step S13020).

Next, the host computer 200A performs an operation similar to step S10040 of FIG. 31 to create the user configuration information management table 2110, based on the user configuration information input program 2103 (S13040).

Next, the host computer 200A creates the performance requirement management table 2130, with reference to the user configuration information management table 2110, the job information management table 2111, and the data configuration management table 2112, based on the performance requirement transmission program 2120.

Specifically, the host computer 200A refers to the user configuration information management table 2110 and the job information management table 2111, and identifies an entry that matches the job name of the entry in the user configuration information management table 2110 and includes the execution state indicating “being executed,” in the job information management table 2111. Next, the host computer 200A adds a new entry to the performance requirement management table 2130; stores the value of the job name of the identified entry, into the job name 213005 of the entry in the performance requirement management table 2130; and stores the value of the priority level 211103, into the priority level 213006. Then, for the performance requirement indicated by the performance requirement class 211003 and the performance requirement 211004 of the entry in the user configuration information management table 2110, the host computer 200A identifies the storage tier satisfying this performance requirement, and stores this storage tier into the tier requirement 213004 of the entry in the performance requirement management table 2130. Furthermore, the host computer 200A refers to the data configuration management table 2112, and identifies an entry matching the data set name of the entry in the user configuration information management table 2110, in the data configuration management table 2112. Then, the host computer 200A stores the value of the storage ID 211204 of the entry in the data configuration management table 2112, into the storage ID 213001 of the entry in the performance requirement management table 2130; stores the value of the logical volume ID 211205, into the logical volume ID 213002; and stores the value of the virtual address 211203, into the virtual address 213003. Then, the host computer 200A transmits the IO request 600 for transmitting content of the performance requirement management table 2130, to the storage apparatus 300A (S13060). The storage apparatus 300A, which has received this IO request 600, performs the storage tier control process based on received information. For example, the storage apparatus 300A performs a process for adding an entry corresponding to the content included in the IO request, to the host performance requirement management table 3130.

The processes in the operation phase in the host computer 200A will be described next.

In the operation phase, when sensing the change in the state of the job to be executed, or when accepting the input of the information regarding the performance requirement from the user, the host computer 200A updates the performance requirement management table 2130 and transmits content of the update to the storage apparatus 300A, if necessary, based on the job control information obtaining program 2104 and the user configuration information input program 2103.

Specifically, when the host computer 200A senses the change in the state of the job to be executed, the host computer 200A performs an operation similar to step S13020 to update content of the job information management table 2111 and the data configuration management table 2112. Moreover, when accepting the input of the information regarding the performance requirement from the user via the input/output part 250, the host computer 200A performs a process similar to step S13040 to update the user configuration information management table 2110. Next, the host computer 200A performs a process similar to step S13060 to update the performance requirement management table 2130. Then, the host computer 200A identifies an updated entry in the performance requirement management table 2130, creates the IO request 600 for transmitting information on this entry, and transmits this IO request 600 to the storage apparatus 300A. The storage apparatus 300A, which has received this IO request 600, performs the storage tier control process based on the information in the received IO request 600. For example, the storage apparatus 300A performs the process for adding the entry corresponding to the content included in the IO request, to the host performance requirement management table 3130.

The operations of the management computer 100A will be described next.

The management computer 100A performs processes similar to the host computer 200A in Example B1 to update the performance requirement-centralized management table 1130. Next, the management computer 100A transmits content of the update to the storage apparatus 300A by performing processes similar to the management computer 100 in the first embodiment. Detailed descriptions of the operations of the management computer 100A in Example B1 will be omitted.

### (2-5-2) Example in the Case where Single Application is Assumed to Access Plurality of Pieces of Data

### Example B2

In Example B2, the operations of each apparatus in the case where a single application is assumed to access a plurality of pieces of data will be described. Here, in Example B2, the case is assumed where a single job (a job that executes the application) accesses a plurality of data sets. The job that accesses the data sets, however, is assumed to be single, and each time the job is executed, the job may access a plurality of data sets different from those at the previous execution time.

The operations of the storage apparatus 300A will be described first.

The storage apparatus 300A in Example B2 performs processes similar to the storage apparatus 300A in Example B1, and performs the input/output process and the storage tier control process based on the access frequency. It should be noted that detailed descriptions of these processes will be omitted.

The storage tier control process based on the priority level of the job, which is performed by the storage apparatus 300A in Example B2, will be described next.

The storage apparatus 300A performs the processes similar to the storage apparatus 300A in Example B1 to determine the page move destination tier. In the process for identifying the number of jobs accessing the page (S12005 of FIG. 34), if a plurality of pieces of data accessed by one job exist in the same page, the storage apparatus 300A in Example B2, however, does not repeatedly count this job. This is because the number of the jobs affected by the page move (for example, the jobs with the input/output performance that is reduced by the page move to the low tier) is regarded as the criterion for the evaluation for ranking the pages, similarly to Example A2. Since specific processes are similar to the processes in the host computer 200 in Example A2, detailed descriptions will be omitted.

Moreover, the processes in the management computer 100A and the host computer 200A in Example B2 are similar to the processes in the management computer 100A and the host computer 200A in Example B1. Thus, detailed descriptions of the operations of the management computer 100A and the host computer 200A will be omitted. The management computer 100A and the host computer 200A, however, are triggered to update the performance requirement-centralized management table 1130 and the performance requirement management table 2130 and to transmit the content of the update to the storage apparatus 300A, when the job has changed the data to be accessed, in addition to when the state of the job to be executed has changed, which is a trigger in Example B1. This is because the storage apparatus 300A performs the storage tier control process when sensing that the job accessing the page has changed, similarly to the processes in the host computer 200 in Example A2 in the first embodiment.

### (2-5-3) Example in the Case Where Plurality of Applications are Assumed to Access Single Piece of Data

### Example B3

In Example B3, the operations of each apparatus in the case where a plurality of applications are assumed to access a single piece of data will be described. Here, in Example B3, the case is assumed where a plurality of jobs access a single data set. Each time the jobs are executed, the jobs, however, may access a plurality of data sets different from those at the previous execution time.

The operations of the storage apparatus 300A will be described first.

The storage apparatus 300A in Example B3 performs the processes similar to the storage apparatus 300A in Example B1, and thereby performs the input/output process and the storage tier control process based on the access frequency. Thus, detailed descriptions of these processes will be omitted.

The storage apparatus 300A performs the processes similar to the storage apparatus 300A in Example B1 to determine the page move destination tier. The storage apparatus 300A in Example B3, however, considers waiting for the end of the input/output process among the jobs accessing the same data, in the processes for identifying the tier satisfying the performance requirement specified by the user (S11010 of FIG. 33 and S12005 of FIG. 34). Similarly to the processes in the host computer 200 in Example A3, this is in order to enable the identification of the tier that can satisfy the performance requirement specified by the user, even if the response time is extended due to occurrence of the waiting for the end of the input/output process among the jobs. Since specific processes are similar to the processes in the host computer 200 in Example A3, detailed descriptions will be omitted.

Moreover, since the processes in the management computer 100A and the host computer 200A in Example B3 are similar to the processes in the management computer 100A and the host computer 200A in Example B2, detailed descriptions will be omitted.

### (2-6) Advantageous Effects of Second Embodiment

As described above, according to the second embodiment, the storage apparatus 300A retains the information regarding the plurality of host computers 200A, and thereby can appropriately prevent the assignment of the data used by the application with the high importance level, to the storage tier indicating the low input/output performance, among the host computers 200A.

### (3) Third Embodiment

### (3-1) Summary of Third Embodiment

The computer system according to a third embodiment will be described next.

In the third embodiment, a storage apparatus 300B executes the process for identifying the control target page from the information regarding the jobs and the data sets included in the OS 2101, as well as the user input information, in the second embodiment, instead of the host computer 200A. Moreover, in the third embodiment, the storage apparatus 300B executes the process for identifying the control target page, and the hierarchical storage control process based on the priority level of the job, in the first embodiment, instead of the host computer 200.

Specifically, in the third embodiment, a management computer 100B or a host computer 200B transmits the information obtained from the OS 2101 and the user's input via the input/output part, to the storage apparatus 300B. Next, the storage apparatus 300B identifies a relationship between the job and the page accessed by the job, from the received information. Next, the storage apparatus 300B identifies the tier that can satisfy the performance requirement specified by the user, for each job. Then, the storage apparatus 300B determines the page move destination tier based on the identified tier satisfying the performance requirement, and the priority level of the job, and executes the storage tier control process.

As described above, according to the third embodiment, the storage apparatus 300B retains the information regarding the performance requirement specified by the user. Hence, even if the characteristic information on the real volume is changed (for example, the characteristic information is changed due to introduction of the storage device 360 of a different type), the storage apparatus 300B can identify the tier satisfying the performance requirement specified by the user, and appropriately perform the storage tier control.

### (3-2) Hardware Configuration of Computer System

The configuration of the computer system in the third embodiment is similar to the configuration of the computer system in the first embodiment (FIG. 1).

FIG. 45 is a configuration diagram of the storage apparatus according to the third embodiment.

The memory 310 of the storage apparatus 300B further stores a performance requirement calculation program 3140, the user configuration information-centralized management table 1111, the job information-centralized management table 1112 and the data configuration-centralized management table 1113, in addition to the various programs and tables expanded into the memory 310 of the storage apparatus 300A (FIG. 38) in the second embodiment.

The performance requirement calculation program 3140 is a program for identifying the page accessed by the job, and the performance requirement of the page, from the information regarding the job and the performance requirement, which has been transmitted from the management computer 100B or the host computer 200B.

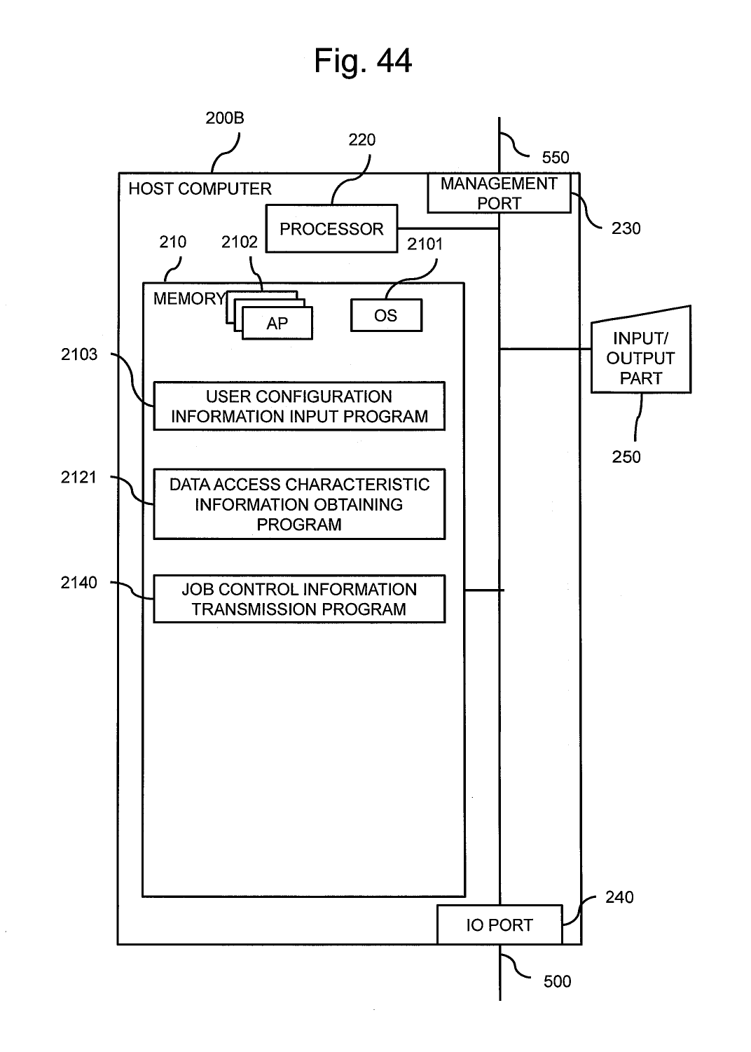

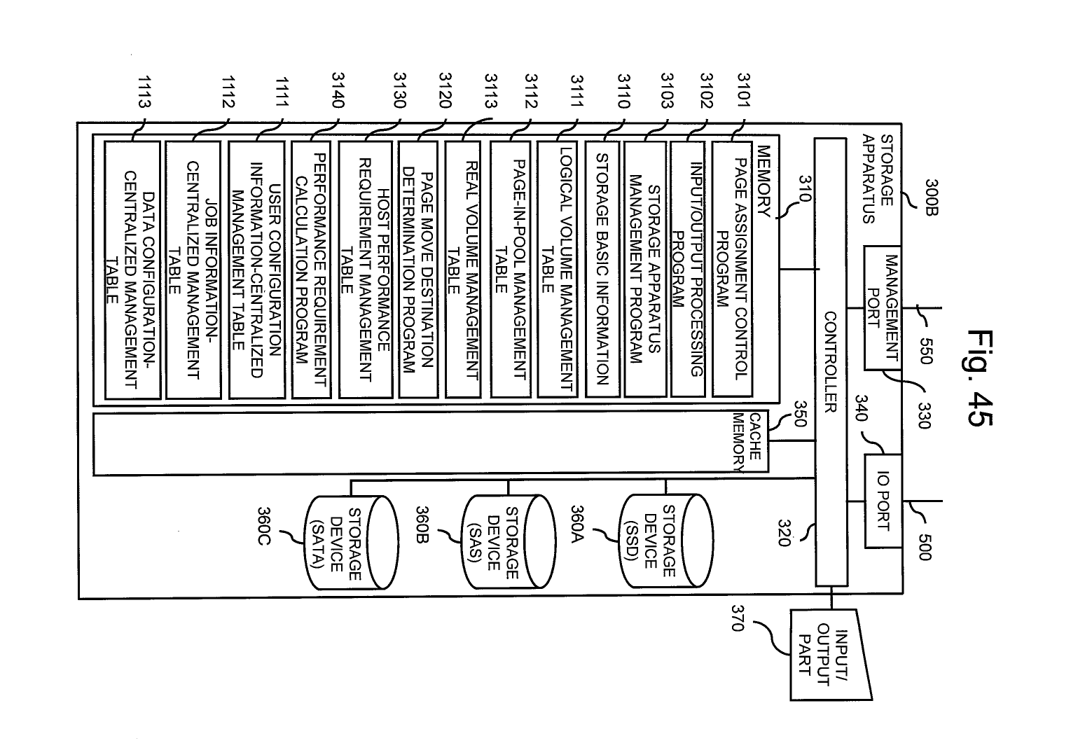

FIG. 44 is a configuration diagram of the host computer according to the third embodiment.

The memory 210 of the host computer 200B stores programs and tables, which are the various programs and tables expanded into the memory 210 of the host computer 200A (FIG. 37) in the second embodiment, except the job control information obtaining program 2104, the user configuration information management table 2110, the job information management table 2111, the data configuration management table 2112, the performance requirement transmission program 2120 and the performance requirement-centralized management table 2130. Moreover, the memory 210 of the host computer 200B further stores a job control information transmission program 2140.

The job control information transmission program 2140 is a program for obtaining the information regarding the jobs included in the OS 2101 of the host computer 200B, and transmitting the information to the storage apparatus 300B.

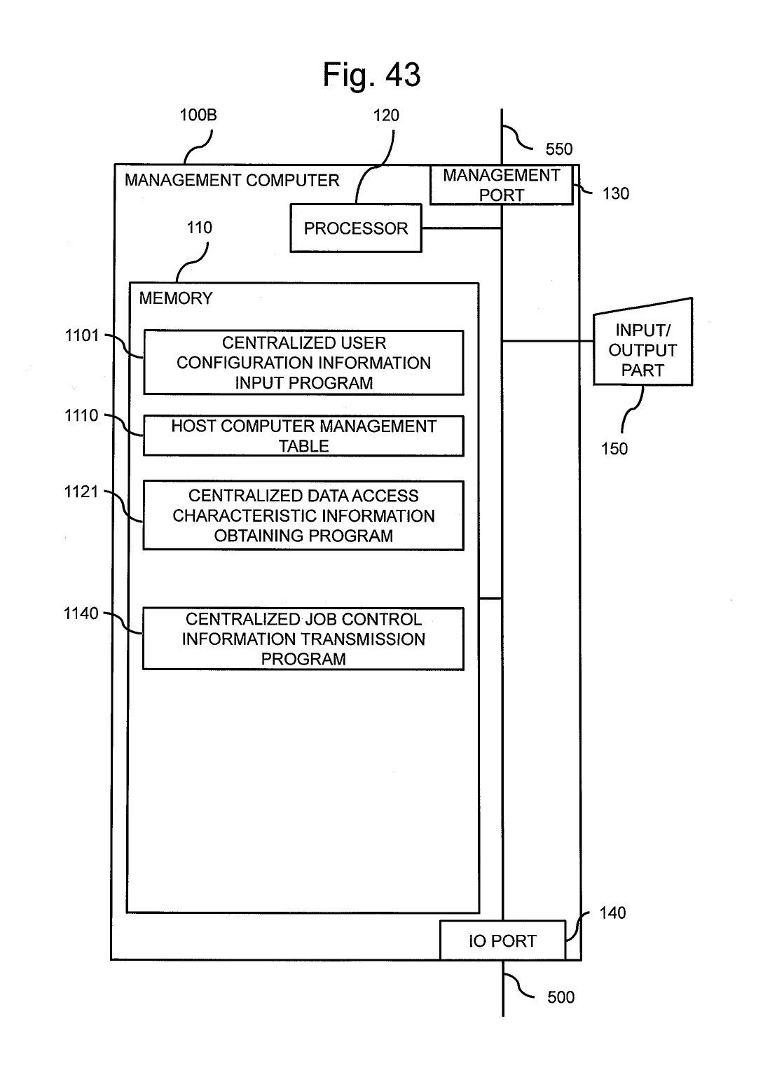

FIG. 43 is a configuration diagram of the management computer according to the third embodiment.

The memory 110 of the management computer 100B stores programs and tables, which are the various programs and tables expanded into the memory 110 of the management computer 100A (FIG. 36) in the second embodiment, except the centralized job control information obtaining program 1102, the user configuration information-centralized management table 1111, the job information-centralized management table 1112, the data configuration-centralized management table 1113, the centralized performance requirement transmission program 1120, and the performance requirement-centralized management table 1130. Moreover, the memory 110 of the management computer 100B further stores a centralized job control information transmission program 1140.

The centralized job control information transmission program 1140 is a program for obtaining the information regarding the jobs included in the OS 2101 of one or more host computers 200B, and transmitting the information to the storage apparatus 300B.

### (3-3) Summary of Processes in Computer System

A summary of the processes in the computer system according to the third embodiment will be described next.

Here, in the following description, the processes will be described simply with the storage apparatus 300B as the subject, which indicates that the controller 320 of the storage apparatus 300B is executing these processes. Similarly, if the processes are described simply with the host computer 200B as the subject, it indicates that the processor 220 of the host computer 200B is executing the processes. If the processes are described with the management computer 100B as the subject, it indicates that the processor 120 of the management computer 100B is executing the processes.

Also in the third embodiment, similarly to the first embodiment, the storage apparatus 300B executes the storage tier control process based on the information in the IO request 600 transmitted by the host computer 200B. In the first embodiment, the host computer 200, however, specifies the control target page and the move destination tier, and issues the storage tier control instruction to the storage apparatus 300. In contrast, in the third embodiment, the host computer 200B transmits the information included in the OS 2101 and the APs 2102, as well as the user input information, to the storage apparatus 300B. The information to be transmitted includes, for example, the job name, the name of the data set accessed by the job, the virtual address of the data set, the priority level of the job, the performance requirement of the job for the data access process, which is specified by the user, and the like.

Next, the storage apparatus 300B identifies the control target page from the information transmitted from the host computer 200B. Next, the storage apparatus 300B determines the move destination tier for the identified page, and executes the storage tier control process.

Moreover, in order to display the data access characteristic information to the user via the input/output part 250, the host computer 200B creates the request 600 for obtaining the virtual address and the characteristic information on the storage area indicated by the virtual address, and transmits the IO request 600 to the storage apparatus 300B via the communication network 500. The storage apparatus 300B, which has received this IO request 600, returns the characteristic information on the virtual address to the host computer 200B via the communication network 500.

Next, the host computer 200B displays information based on the characteristic information on the virtual address returned from the storage apparatus 300B, to the user through the input/output part 250.

It should be noted that, also in the third embodiment, similarly to the first embodiment, the user can manage a plurality of the host computers 200B and a plurality of the storage apparatuses 300B in a centralized manner from the management computer 100B, if necessary. Thereby, similarly to the management computer 100 in the first embodiment, if the plurality of host computers 200 exist, the input/output parts operated by the user can be aggregated.

### (3-4) Content of Various Tables

The content of the various tables in the third embodiment is similar to the various tables in the first embodiment or the second embodiment. Thus, a detailed description of the content of the various tables in the present embodiment will be omitted.

### (3-5) Detailed Operations of Each Apparatus

### (3-5-1) Example in the Case where Application is Assumed to Always Access the Same Single Piece of Data

### Example C1

In Example C1, operations of each apparatus in the case of a one-to-one correspondence relationship between an application of the host computer 200A and data accessed by this application will be described. Here, in Example C1, the case of the one-to-one relationship between the job and the data set accessed by the job is assumed where the job is assumed to always access the same data set.

The processes of the storage apparatus 300B will be described first.

If the storage apparatus 300B receives the information included in the OS 2101 and the APs 2102, as well as the user input information, which have been transmitted from the management computer 100B or the host computer 200B, the storage apparatus 300B creates or updates the user configuration information-centralized management table 1111, the job information-centralized management table 1112, and the data configuration-centralized management table 1113, from the received information, based on the performance requirement calculation program 3140. Values to be stored into the fields of the entries in each table are determined by the storage apparatus 300B performing processes similar to the management computer 100 in the first embodiment, and thus detailed descriptions will be omitted.

Next, the storage apparatus 300B creates or updates the host performance requirement management table 3130, with reference to the user configuration information-centralized management table 1111, the job information-centralized management table 1112, and the data configuration-centralized management table 1113. Values to be stored into the fields of the entries in the host performance requirement management table 3130, except the host name 313004, are determined by the storage apparatus 300B performing processes similar to the host computer 200A in the second embodiment, and thus detailed descriptions will be omitted. It should be noted that the host name of the host computer 200B that is the transmitter of the IO request is stored in the host name 313004.

Moreover, the storage apparatus 300B performs processes similar to the storage apparatus 300A in the second embodiment, and thereby performs the input/output process, the storage tier control process based on the access frequency, and the storage tier control process based on the priority level of the job. Detailed descriptions of these processes will be omitted.

Processes performed in the two phases of the preparation phase and the operation phase by the host computer 200B will be described next.

The process in the preparation phase in the host computer 200B will be described first.

First, the host computer 200B performs a process similar to the process (S10010 of FIG. 31) in the host computer 200 in the first embodiment to detects the storage apparatus 300B existing on the computer system 10.

Next, the host computer 200B performs processes similar to the processes (S10020 and S10040 of FIG. 31) in the host computer 200 in the first embodiment, and obtains the OS 2101 and the APs 2012, as well as the user input information.

Then, the host computer 200B generates the IO request 600 for transmitting the obtained information, and transmits this IO request 600 to the storage apparatus 300B. The storage apparatus 300B, which has received this IO request 600, performs the storage tier control process based on the received information.

Moreover, in the operation phase, when sensing the change in the state of the job to be executed, or when accepting the information regarding the performance requirement from the user, the host computer 200B creates the IO request 600 for transmitting the sensed or accepted information, and transmits this IO request 600 to the storage apparatus 300B, based on the user configuration information input program 2103 and the job control information transmission program 2140.

The operations of the management computer 100B will be described next.

The management computer 100B performs processes similar to the management computer 100A in the second embodiment to thereby transmit the information required for the storage tier control process to the storage apparatus 300B. If the management computer 100B obtains the information from the host computer 200B or the user's input, the management computer 100B, however, transmits the obtained information to the storage apparatus 300B without creating or updating the tables.

### (3-5-2) Example in the Case where Single Application is Assumed to Accesses Plurality of Pieces of Data

### Example C2

In Example C2, the operations of each apparatus in the case where a single application is assumed to access a plurality of pieces of data will be described. Here, in Example C2, the case is assumed where a single job (a job that executes the application) accesses a plurality of data sets. The job that accesses the data sets, however, is assumed to be single, and each time the job is executed, the job may access a plurality of data sets different from those at the previous execution time.

The processes of the storage apparatus 300B will be described first.

The storage apparatus 300B in Example C2 performs processes similar to the storage apparatus 300B in Example C1, and thereby performs the data access process and the storage tier control process based on the access frequency. Thus, detailed descriptions of these processes will be omitted.

The storage tier control process based on the priority level of the job, which is performed by the storage apparatus 300B in Example C2, will be described next.

The storage apparatus 300B performs the processes similar to the storage apparatus 300B in Example C1 to determine the page move destination tier. In the process for identifying the number of jobs accessing the page (S12005 of FIG. 34), if a plurality of pieces of data accessed by one job exist in the same page, the host computer 200 in Example C2, however, does not repeatedly count this job. This is because the number of the jobs affected by the page move (for example, the jobs with the input/output performance that is reduced by the page move to the low tier) is regarded as the criterion for the evaluation for ranking the pages. Since specific processes are similar to the processes in the host computer 200 in Example A2 of the first embodiment, detailed descriptions will be omitted.

Moreover, the processes in the management computer 100B and the host computer 200B in Example C2 are similar to the processes in the management computer 100B and the host computer 200B in Example C1. Thus, detailed descriptions of the operations of the management computer 100B and the host computer 200B in Example C2 will be omitted. The management computer 100B and the host computer 200B, however, are triggered to transmit content required for updating the host performance requirement management table 3130, to the storage apparatus 300B, when the job has changed the data to be accessed, in addition to when the state of the job to be executed has changed, which is a trigger in Example C1. This is because the storage apparatus 300B performs the storage tier control when sensing that the job accessing the page has changed, similarly to the processes in the host computer 200 in Example A2 in the first embodiment.

### (3-5-3) Example in the Case where Plurality of Applications are Assumed to Access Single Piece of Data

### Example C3

In Example C3, the operations of each apparatus in the case where a plurality of applications are assumed to access a single piece of data will be described. Here, in Example C3, the case is assumed where a plurality of jobs access a single data set. Each time the jobs are executed, the jobs, however, may access a plurality of data sets different from those at the previous execution time.

The processes of the storage apparatus 300B will be described first.

The storage apparatus 300B in Example C3 performs the processes similar to the storage apparatus 300B in Example C1, and thereby performs the data access process and the storage tier control process based on the access frequency. Thus, detailed descriptions of these processes will be omitted.

The storage tier control process based on the priority level of the job, which is performed by the storage apparatus 300B in Example C3, will be described next.

The storage apparatus 300B performs the processes similar to the storage apparatus 300B in Example C1 to determine the page move destination tier. The storage apparatus 300B in Example C3, however, considers the waiting for the end of the data access process among the jobs accessing the same data, in the processes for identifying the tier satisfying the performance requirement specified by the user (S11010 of FIG. 33 and S12005 of FIG. 34). Similarly to the processes in the host computer 200 in Example A3, this is in order to enable the identification of the tier that can satisfy the performance requirement specified by the user, even if the response time is extended due to occurrence of the waiting for the end of the data access process among the jobs. Since specific processes are similar to the processes in the host computer 200 in Example A3, detailed descriptions will be omitted.

Moreover, the processes in the management computer 100B and the host computer 200B in Example C3 are the processes similar to the management computer 100A and the host computer 200B in Example C1. Thus, detailed descriptions of the operations of the management computer 100B and the host computer 200B in Example C3 will be omitted.

### (3-6) Advantageous Effects of Third Embodiment

As described above, according to the third embodiment, the storage apparatus 300B retains the information regarding the performance requirement specified by the user. Hence, even if the characteristic information on the real volume is changed, the storage apparatus 300B can identify the tier satisfying the performance requirement specified by the user, and move the page to an appropriate tier.

The three embodiments have been described above. In this way, since the host computer 200 determines the page move destination tier in consideration of the applications that access data existing on the same page, the data used by the application with the high importance level can be appropriately prevented from being assigned to the storage tier indicating the low input/output performance.

Moreover, according to the first embodiment, since the host computer 200 recognizes the status of the data assignment to the storage tiers, the storage tier control instruction can be issued in consideration of the status of the data assignment among the storage apparatuses 300, also for the applications that access data stored in the plurality of storage apparatuses 300.

Moreover, according to the second embodiment, since the storage apparatus 300A retains the information regarding the plurality of host computers 200A, the data used by the application with the high importance level can be appropriately prevented from being assigned to the storage tier indicating the low input/output performance, among the host computers 200A.

Moreover, according to the third embodiment, in addition to the advantageous effects of the second embodiment, the storage apparatus 300B retains the information regarding the performance requirement specified by the user. Hence, if the characteristic information on the real volume has been changed, the storage apparatus 300B can identify the tier satisfying the performance requirement specified by the user, again, and move the page to a tier indicating an appropriate performance.

It should be noted that the following descriptions can be provided based on the above descriptions.

Based on an access frequency (or another access status, such as last access date and time) of a virtual area in a logical volume (a virtual logical volume conforming to Thin Provisioning), a storage system can move data in a page assigned to the virtual area, to a page in another tier other than a tier including that page. In other words, the storage system can perform the page move based on the access status of the virtual area.

If the host computer is a mainframe computer, a certain IO performance (for example, an expected IO performance) for the logical volume is desirably ensured for the mainframe computer.

Hence, for example, a management program for a mainframe may be executed in the management computer. Moreover, the storage system may include an interface (function) for interpreting a command issued from the management program.

Moreover, the command may be issued with words (a unit) known to a mainframe administrator. For example, the mainframe administrator may understand data as a data set, and the management program may receive an instruction with an ID (for example, a name) of the data set, from the mainframe administrator, and issue a command with an ID of a page corresponding to the data set in the instruction, to the storage system. In other words, the management program may include a function of converting the data set ID into the page ID.

One page can include two or more data sets (or files). For example, for the mainframe administrator, there may be a case where a certain data set in two or more data sets included in one page should be placed in a page with a high performance, while another data set may be placed in a page with a low performance.

However, the storage system moves the data between the pages.

Accordingly, the computer system may perform a plurality of processes as follows. The computer system, for example, includes the storage system, and a management system coupled to the storage system, and the following plurality of processes may be performed by any one apparatus in apparatuses of the management system and the storage system, or may be divided into the computer and the storage system. Hereinafter, for convenience, a subject of the processes is assumed to be the computer system. The management system may be at least one of the host computer and the management computer.

(A) The computer system identifies how many data sets exist in one page.

(B) Next, the computer system determines to move data in the page, to a page in a tier satisfying the highest IO performance in two or more IO performances requested for two or more data sets included in the data, respectively.

(C) According to the above (B), the data can be centralized in the tier with the highest IO performance. Hence, it is important to determine from which page in the tier the data is moved to a page in a lower tier. The computer system determines (a) a tier into which the user hopes to place the data, and/or (b) based on the priority level of the job, to which tier's page data in a page in a tier (for example, a tier whose free pages are exhausted) is moved. In the above (a) and (b), it is understood how many important data sets are stored in the page, and the computer system can move the data in the page based on the understanding. The data in the page may be moved after the above (A) to (C) are performed.

It should be noted that, in the above processes in (A) through (C), for example, the computer system may move data used by a job to a page in a higher tier while the job is operating, and may move the data used by the job to a page in a lower tier while the job does not operate. A move of the job, an end of the job, a change of the priority level of the job, or the like may trigger the above processes in (A) through (C) to perform the page move.

Moreover, if the computer system has received a data move instruction including information that can identify the move destination tier of the data set, and has moved the data including the data set to the page in the move destination tier according to data move instruction, the computer system may restrain the move of the data from the move destination tier. This is because the certain IO performance is required for data that is a target of the data move instruction from the host computer. From this viewpoint, for example, the data may be moved to a tier higher than the move destination tier.

### REFERENCE SIGNS LIST

100 . . . management computer, 200 . . . host computer, 300 . . . storage system

1. A data management system, comprising:
a storage resource; and
a control device coupled to the storage resource,
wherein the storage resource is configured to store performance requirement information that is information indicating a performance requirement of a real area that should store one or more pieces of data for a virtual volume,
wherein the virtual volume is a virtual logical volume that is provided by a storage system and comprises a plurality of virtual areas,
wherein the storage system includes a pool comprising a plurality of real areas based on a plurality of types of storage devices with different characteristics, the plurality of real areas being configured to be managed as a plurality of tiers depending on the characteristics of the storage devices, and the storage system is configured to, if no real area has been assigned to a virtual area of a storage destination of the data, assign an unassigned real area from the pool to the virtual area of the write destination, and store the data into the assigned real area,
wherein the storage system is configured to move the data from one tier to another tier in the pool, for each real area, and
wherein the control device is configured to:
(A) if a predetermined trigger for which a change of a real area storing a certain piece of data should be considered is detected, identify the performance requirement of the real area for each of one or more pieces of data including the certain piece of data within a first real area in which the certain piece of data is stored, based on the performance requirement information; and
(B) identify the tier satisfying a highest performance requirement in the identified performance requirements, in the plurality of tiers, and determine the identified tier as a tier of a storage destination of the one or more pieces of data including the certain piece of data.

2. A data management system according to claim 1,
wherein the storage device is configured to store a priority level of a program that uses the data, and free capacity information indicating a free capacity of each tier in the pool, and
wherein, in the (B), the control device is configured to:
(b1) determine whether or not a real area in the identified tier is assignable to a virtual area to which the first real area has been assigned, based on the free capacity information;
(b2) if a result of the determination in the (b1) is negative, determine a priority rank for each of a plurality of assigned real areas in the identified tier, based on the priority level of the program that uses the data stored in the real area; and
(b3) for each of the assigned real areas, determine a tier that becomes a move destination of the data in the assigned real area, from the tiers other than the tier including the assigned real area, based on a plurality of the priority ranks corresponding to the plurality of assigned real areas, respectively.

3. A data management system according to claim 2,
wherein, in the (b3), the control device is configured to determine the move destination of data in a real area corresponding to a highest rank in the plurality of priority ranks, to be a tier higher than the tier including the real area.

4. A data management system according to claim 2,
wherein, in the (b3), the control device is configured to determine the move destination of data in a real area corresponding to a lowest rank in the plurality of priority ranks, to be a tier lower than the tier including the real area.

5. A data management system according to claim 2,
wherein, in the (b2), the control device is configured to determine a real area storing a larger number of pieces of data for which the priority level of the program is high, to be high in the priority rank.

6. A data management system according to claim 5,
wherein, in the (b2), the control device is configured to, for two or more real areas storing data accessed by programs with the same priority level, determine a real area with a higher performance requirement specified for the accessing program, to be high in the priority rank.

7. A data management system according to claim 1,
wherein the trigger is at least one of a start of use of the data, an end of the use of the data, and a change of a program that uses the data.

8. A data management system according to claim 1,
wherein the storage resource and the control device exist in a management system that is coupled to the storage system and configured to manage the storage system,
wherein the control device is configured to transmit a tier control request including information identifying the tier determined in the (B), to the storage system, and
wherein the storage system is configured to receive the tier control request, and to move the one or more pieces of data to a real area in the tier identified by the information included in the tier control request.

9. A data management system according to claim 1,
wherein the storage resource and the control device exist in a host computer configured to input and output data to and from the storage system,
wherein the storage resource is configured to store a program for executing a process with input and output of the data to and from the virtual volume, and
wherein the control device is configured to execute the program to thereby input and output the data to and from the virtual volume.

10. A data management system according to claim 1,
wherein the control device includes first and second control devices,
wherein the first control device and the storage resource exist in a management system that is coupled to the storage system and configured to manage the storage system,
wherein the second control device exists in the storage system,
wherein the first control device is configured to, if the predetermined trigger is detected, transmit the performance requirement information on the certain piece of data to the storage system, and
wherein the second control device is configured to receive the performance requirement information, and to execute the (A) and the (B).

11. A data management system according to claim 1,
wherein the storage resource and the control device exist in the storage system.

12. A data management system according to claim 1,
wherein the control device exists in a mainframe computer, and is configured to transmit a data move instruction specifying move target data and a move destination of the move target data, to the storage system, and
wherein the storage system is configured to move the move target data to the move destination according to the data move instruction, and then control a position of the move target data so as not to be changed until an instruction to permit a change of a tier into which the move target data is placed is accepted.

13. A computer system, comprising:
a storage system; and
a data management system coupled to the storage system,
wherein the storage system is configured to provide a virtual volume that is a virtual logical volume comprising a plurality of virtual areas,
wherein the storage system includes a pool comprising a plurality of real areas based on a plurality of types of storage devices with different characteristics, the plurality of real areas being configured to be managed as a plurality of tiers depending on the characteristics of the storage devices, and the storage system is configured to, if no real area has been assigned to a virtual area of a storage destination of data, assign an unassigned real area from the pool to the virtual area of the write destination, and store the data into the assigned real area,
wherein the storage system is configured to move the data from one tier to another tier in the pool, for each real area, and
wherein the data management system is configured to:
(A) if a predetermined trigger for which a change of a real area storing a certain piece of data should be considered is detected, based on performance requirement information that is information indicating a performance requirement of a real area that should store one or more pieces of data for the virtual volume, identify the performance requirement of the real area for each of one or more pieces of data including the certain piece of data within the real area in which the certain piece of data is stored; and
(B) identify the tier satisfying a highest performance requirement in the identified performance requirements, in the plurality of tiers, and determine the identified tier as a tier of a storage destination of the one or more pieces of data including the certain piece of data.

14. A data management method for managing data that is stored in a pool, the pool including real areas that are assigned to a virtual volume that is a virtual logical volume comprising a plurality of virtual areas, the pool comprising a plurality of real areas based on a plurality of types of storage devices with different characteristics, the plurality of real areas being configured to be managed as a plurality of tiers depending on the characteristics of the storage devices, the data being configured to be moved from a tier to another tier for each real area, the method comprising:
(A) if a predetermined trigger for which a change of a real area storing a certain piece of data should be considered is detected, based on performance requirement information that is information indicating a performance requirement of a real area that should store one or more pieces of data for the virtual volume, identifying the performance requirement of the real area for each of one or more pieces of data including the certain piece of data within the real area in which the certain piece of data is stored; and
(B) identifying the tier satisfying a highest performance requirement in the identified performance requirements, in the plurality of tiers, and determining the identified tier as a tier of a storage destination of the one or more pieces of data including the certain piece of data.
